(19) United States
(12) Patent Application Publication
(10) Pub. No.: US 2007/0258329 A1
(43) Pub. Date: Nov. 8, 2007

(54) Method and apparatus for the exploitation of piezoelectric and other effects in carbon-based life forms

(76) Inventor: Timothy Winey, Visalia, CA (US)

Correspondence Address: BROWN & MICHAELS, PC;400 M & T BANK BUILDING, 118 NORTH TIOGA ST, ITHACA, NY, 14850, US

(21) Appl. No.: 11/518,614

(22) Filed: Jul. 13, 2006

Related U.S. Application Data
(63) Continuation-in-part of application No. 11/044,961, filed on Jan. 27, 2005, now abandoned.

(51) Int. Cl. B06B 1/06

(52) U.S. Cl. 367/140

(57) ABSTRACT

The invention promotes piezoelectric effects in carbon-based life forms using specific geometries, ratios, frequencies and combinations therein using associated vibrational states functioning in part, as bi-directional holographic transducers between the acoustic and electromagnetic domains.

### REFERENCE TO RELATED APPLICATIONS

This is a continuation-in-part of parent patent application 11/044,961, filed Jan. 26, 2006, now abandoned. The aforementioned application is hereby incorporated herein by reference.

### BACKGROUND OF THE INVENTION

Piezoelectricity is the ability of certain crystals to produce a voltage when subjected to mechanical stress. The word is derived from the Greek piezein, which means to squeeze or press. The effect is reversible; piezoelectric crystals, subject to an externally applied voltage, can change shape by a small amount. The effect is of the order of nanometres, but nevertheless finds useful applications such as the production and detection of sound, generation of high voltages, electronic frequency generation, and ultrafine focusing of optical assemblies.

In a piezoelectric crystal, the positive and negative electrical charges are separated, but symmetrically distributed, so that the crystal overall is electrically neutral. When a stress is applied, this symmetry is disturbed, and the charge asymmetry generates a voltage. A 1 cm cube of quartz with 500 lb (2 kN) of correctly applied pressure upon it, can produce 12,500 V of electricity. Piezoelectric materials also show the opposite effect, called converse piezoelectricity, where application of an electrical field creates mechanical stress (distortion) in the crystal. Because the charges inside the crystal are separated, the applied voltage affects different points within the crystal differently, resulting in the distortion. The bending forces generated by converse piezoelectricity are extremely high, of the order of tens of millions of pounds (tens of meganewtons), and usually cannot be constrained. The only reason the force is usually not noticed is because it causes a displacement of the order of one billionth of an inch (a few nanometres).

A related property known as pyroelectricity, the ability of certain mineral crystals to generate electrical charge when heated, was known of as early as the 18th century, and was named by David Brewster in 1824. In 1880, the brothers Pierre Curie and Jacques Curie predicted and demonstrated piezoelectricity using tinfoil, glue, wire, magnets, and a jeweler's saw. They showed that crystals of tourmaline, quartz, topaz, cane sugar, and Rochelle salt (sodium potassium tartrate tetrahydrate) generate electrical polarization from mechanical stress. Quartz and Rochelle salt exhibited the most piezoelectricity. Twenty natural crystal classes exhibit direct piezoelectricity. Converse piezoelectricity was mathematically deduced from fundamental thermodynamic principles by Lippmann in 1881. The Curies immediately confirmed the existence of the “converse effect,” and went on to obtain quantitative proof of the complete reversibility of electro-elasto-mechanical deformations in piezoelectric crystals.

The polymer polyvinylidene fluoride, (—CH2-CF2-)n, exhibits piezoelectricity several times larger than quartz. Bone exhibits some piezoelectric properties: it has been hypothesized that this is part of the mechanism of bone remodelling in response to stress.

Piezoelectric crystals are used in numerous ways:

Direct piezoelectricity of some substances like quartz, as mentioned above, can generate thousands of volts (known as high-voltage differentials).

A piezoelectric transformer is a type of AC voltage multiplier. Unlike a conventional transformer, which uses magnetic coupling between input and output, the piezoelectric transformer uses acoustic coupling. An input voltage is applied across a short length of a bar of piezoceramic material such as PZT, creating an alternating stress in the bar by the inverse piezoelectric effect and causing the whole bar to vibrate. The vibration frequency is chosen to be the resonant frequency of the block, typically in the 100 kilohertz to 1 megahertz range. A higher output voltage is then generated across another section of the bar by the piezoelectric effect. Step-up ratios of more than 1000:1 have been demonstrated. An extra feature of this transformer is that, by operating it above its resonant frequency, it can be made to appear as an inductive load, which is useful in circuits that require a controlled soft start.

In this application, the use of the terms clubhead or head, unless stipulated as being part of a particular club type, herein are used to refer generically to the striking portion of any golf club whereas the term putterhead refers to a special case of clubhead used for putting. Similarly, the terms shaft or club shaft, are used generically to refer to the elongated tubular sections of all golf clubs to which the heads attach whereas putter shaft refers specifically to shafts used for putters only. In addition, the term “golf shot” refers generically to any striking of a golf ball with any club whereas putts are to be construed as a special kind of golf shot executed by special clubs known by those skilled in the art as putters.

Also, the term graphic will refer to images within the main body of this application whereas the term figure will refer to the drawings section of this application except when referring specifically to the mathematical category of geometric figures. To eliminate any possible confusion, the inventor has truncated the word figure to “Fig.” When referring to any patent drawings.

Harmonics are often also referred to as overtones, but the precise definition of ‘overtone’ for the purpose of this application, refers to a particular partial in the timbre. For example, an instrument could contain 3 overtones—say . . . harmonics 1, 2, 5 and 8. Harmonic 1 is the fundamental so this doesn't count. Harmonic 2 is overtone 1, harmonic 5 is overtone 2, and 8 is the third overtone.

Harmonic one=the fundamental. Harmonic 2=overtone 1. Harmonic 3=overtone 2. Harmonic4 =overtone 3 and so on.

In order to demonstrate how the inventor exploits the use of phi ratios and related recursive or self-similar phenomena that may not, in and of themselves, result in exact mathematical phi, but rather, represent the minimum entropy of a fractal system, striking the balance between maximum order and flexible variation, that may contribute to an improved putting technique via enhanced feedback associated with improved learning, memory, mental states and how they, in turn, feed back onto improved putting technique based partially on holographic theory, he directs the examiner's attention to an overview of quantum physical and fractal phenomena as they relate to, and connect with, the ideas of self-organizing structures, learning theory, piezoelectric signaling and resultant biological phenomena to the extent they inform this invention.

Examples of devices that exploit the ability of the body to entrain, induce and promote brainwave coherence include:

1. Patrick Flanagan's Neurophone (U.S. Pat. No. 3,393,279). Flanagan also conducted experiments involving phi geometries and their effects on muscle strength. He played Pink Noise using various geometric shapes as resonators; a model of the Great Pyramid, models of the King's Chamber; Dodecahedrons and the like, to modify the Pink Noise. He then had experts in applied kinesiology test the muscles strength of people listening to the same sounds resonated through said shapes. The results were unanimous, the Pyramid shapes based on the Golden Ratio made people very strong. Cubes made people very weak.

European patent (number 0351357) filed in 1989 by the chemical giant Ciba-Geigy for a way to cultivate original forms of plants and animals using simple electrostatic fields termed The Ciba-Geigy Effect. The patent is simply called “Improved Cultivation Technique”, described as “A novel method is described, which, on the basis of the short-term application of electrostatic fields, results in lasting beneficial and desirable properties in fish, which are otherwise achievable only with a substantial additional effort, if at all. As a result of the simplicity of the measures constituting the method according to the invention and the significant results, the culture of fish, particularly of edible fish but also of ornamental fish, is genuinely revolutionized.”

The Austrian physicist Viktor Schauberger's work will be essential in shedding light on subtle energy phenomena and their reflection in self-organizing structures and related phenomena.

Similar to the Flanagan Neurophone, which uses electrical current, in 1975, Robert Monroe was issued an original patent (number not known) in the field of altering brain states through sound. His compelling research became the foundation for a noninvasive and easy-to-use “audio-guidance” technology known as Hemi-Sync, which has been proven to produce identifiable, beneficial effects, including enhancing alertness, inducing sleep, and evoking expanded states of consciousness.

The HeartTuner is a multi-purpose measurement and biofeedback system for therapists, health professionals, researchers, and individual use. In addition to harmonic analysis (power spectra) of Heart (ECG/HRV), Brain (EEG), the HeartTuner directly measures Internal Cardiac Coherence (“ICC”). These so-called coherences are based on phi geometry and as any cardiologist will tell you, are strongly predictive of mortality in addition to reflecting mental and physical states.

In nature, we find geometric patterns, designs and structures from the most minuscule particles, to expressions of life discernible by human eyes, to the greater cosmos. These inevitably follow geometrical archetypes, which reveal to us the nature of each form and its vibrational resonances. They are also symbolic of the underlying metaphysical principle of the inseparable relationship of the part to the whole. It is this principle of oneness underlying all geometry that permeates the architecture of all form in its myriad diversity.

Life itself as we know it is inextricably interwoven with geometric forms, from the angles of atomic bonds in the molecules of the amino acids, to the helical spirals of DNA, to the spherical prototype of the cell, to the first few cells of an organism which assume vesical, tetrahedral, and star (double) tetrahedral forms prior to the diversification of tissues for different physiological functions. Our human bodies on this planet all developed with a common geometric progression from one to two to four to eight primal cells and beyond.

Almost everywhere we look, the mineral intelligence embodied within crystalline structures follows a geometry unfaltering in its exactitude. The lattice patterns of crystals all express the principles of mathematical perfection and repetition of a fundamental essence, each with a characteristic spectrum of resonances defined by the angles, lengths and relational orientations of its atomic components.

Golden ratio of segments in 5-pointed star (pentagram) were considered sacred to Plato & Pythagoras in their mystery schools. Note that each larger (or smaller) section is related by the phi ratio, so that a power series of the golden ratio raised to successively higher (or lower) powers is automatically generated: phi, phiˆ2, phiˆ3, phiˆ4, phiˆ5, etc.

phi=apothem to bisected base ratio in the Great Pyramid of Giza

phi=ratio of adjacent terms of the famous Fibonacci Series evaluated at infinity; the Fibonacci Series is a rather ubiquitous set of numbers that begins with one and one and each term thereafter is the sum of the prior two terms, thus: 1,1,2,3,5,8,13,21,34,55,89,144.

Fibonacci ratios appear in the ratio of the number of spiral arms in daisies, in the chronology of rabbit populations, in the sequence of leaf patterns as they twist around a branch, and a myriad of places in nature where self-generating patterns are in effect. The sequence is the rational progression towards the irrational number embodied in the quintessential golden ratio.

This spiral generated by a recursive nest of Golden Triangles (triangles with relative side lengths of 1, phi and phi) is the classic shape of the Chambered Nautilus shell. The creature building this shell uses the same proportions for each expanded chamber that is added; growth follows a law, which is everywhere, the same.

Toroids result when rotating a circle about a line tangent to it creates a torus, which is similar to a donut shape where the center exactly touches all the “rotated circles.” The surface of the torus can be covered with 7 distinct areas, all of which touch each other; an example of the classic “map problem” where one tries to find a map where the least number of unique colors are needed. In this 3-dimensional case, 7 colors are needed, meaning that the torus has a high degree of “communication” across its surface. The image shown is a “birds-eye” view.

The progression from point (0-dimensional) to line (1-dimensional) to plane (2-dimensional) to space (3-dimensional) and beyond leads us to the question—if mapping from higher order dimensions to lower ones loses vital information (as we can readily observe with optical illusions resulting from third to second dimensional mapping), then perhaps our “fixation” with a 3-dimensional space introduce crucial distortions in our view of reality that a higher-dimensional perspective would not lead us to.

The 3/4/5, 5/12/13 and 7/24/25 triangles are examples of right triangles whose sides are whole numbers. The 3/4/5 triangle is contained within the so-called “King's Chamber” of the Great Pyramid, along with the 2/3/root5 and 5/root5/2root5 triangles, utilizing the various diagonals and sides.

The 5 Platonic solids (Tetrahedron, Cube or (Hexahedron), Octahedron, Dodecahedron & Icosahedron) are ideal, primal models of crystal patterns that occur throughout the world of minerals in countless variations. These are the only five regular polyhedra, that is, the only five solids made from the same equilateral, equiangular polygons. To the Greeks, these solids symbolized fire, earth, air, spirit (or ether) and water respectively. The cube and octahedron are duals, meaning that one can be created by connecting the midpoints of the faces of the other. The icosahedron and dodecahedron are also duals of each other, and three mutually perpendicular, mutually bisecting golden rectangles can be drawn connecting their vertices and midpoints, respectively. The tetrahedron is a dual to itself.

Phyllotaxis is the study of symmetrical patterns or arrangements. This is a naturally occurring phenomenon. Usually the patterns have arcs, spirals or whorls. Some phyllotactic patterns have multiple spirals or arcs on the surface of an object called parastichies. The spirals have their origin at the center C of the surface and travel outward, other spirals originate to fill in the gaps left by the inner spirals. Frequently, the spiral-patterned arrangements can be viewed as radiating outward in both the clockwise and counterclockwise directions. These types of patterns have visibly opposed parastichy pairs where the number of spirals or arcs at a distance from the center of the object radiating in the clockwise direction and the number of spirals or arcs radiating in the counterclockwise direction. Further, the angle between two consecutive spirals or arcs at their center is called the divergence angle.

The Fibonnaci-type of integer sequences, where every term is a sum of the previous two terms, appear in several phyllotactic patterns that occur in nature. The parastichy pairs, both m and n, of a pattern increase in number from the center outward by a Fibonnaci-type series. Also, the divergence angle d of the pattern can be calculated from the series.

Indelibly etched on the walls of temple of the Osirion at Abydos, Egypt, the Flower of Life contains a vast Akashic system of information, including templates for the five Platonic Solids.

The inventor wishes to exploit the fractal geometries of so-called “fullerenes” to include both “simple” and “perfect” fullerene shapes insofar as they also have been shown to exhibit unique vibrational and stiffening properties. The inventor will exploit fullerene geometries at the molecular or nano-scale and at the macro scale to be employed in golf clubs, golf shafts, and other items. The determination of what constitutes a fullerene mathematically as well as differentiates general from perfect fullerenes, is given below.

Among all elements, C is the basis of entire life. The whole branch of chemistry—the organic chemistry—is devoted to the study of C—C bonds and different molecules originating from them. Carbon is the only 4-valent element able to produce long homoatomic stable chains or different 4-regular nets. The other 4-valent candidate for this could be only Si, with its reach chemistry beginning to develop. After diamond and graphite—the hexagonal plane hollow shell, in 1985 was first synthesized by H. W. Kroto, R. F. Curl and R. E. Smalley the spherical closed pentagonal/hexagonal homoatomic shell: the fullerene C60. Except from this, it possesses some another remarkable properties: the rotational symmetry of order 5, from the geometrical reasons (according to Barlow “crystallographic restriction theorem”) forbidden in crystallographic space or plane symmetry groups, and highest possible icosahedral point-group symmetry. After C60, different fullerenes (e.g. C70. C76.fC78. C82. C84 etc.) are synthesized, opening also a new field for research of different potentially possible fullerene structures from the geometry, graph theory or topology point of view.

From the tetravalence of C result four possible vertex situations, that could be denoted as 31, 22, 211 and 1111 (Graphic 1a). The situation 31 could be obtained by adding two C atoms between any two others connected by a single bond, and situation 22 by adding a C atom between any two others connected by a double bond Graphic 1b. Therefore, we could restrict our consideration to the remaining two non-trivial cases: 211 and 1111. Working in opposite sense, we could always delete 31 or 22 vertices, and obtain a reduced 4-regular graph, where in each vertex occurs at most one double bond (digon), that could be denoted by colored (bold) edge (Graphic 1a). First, we could consider all 4-regular graphs on a sphere, from which non-trivial in the sense of derivation are only reduced ones. In the knot theory, 4-regular graphs on a sphere with all vertices of the type 1111 are known as “basic polyhedra” [1,2, 3,4], and that with at least one vertex with a digon as “generating knots or links” [4]. From the chemical reasons, the vertices of the type 1111 are only theoretically acceptable. If all the vertices of such 4-regular graph are of the type 211, such graph we will be called a general fullerene. Every general fullerene could be derived from a basic polyhedron by “vertex bifurcation”, this means, by replacing its vertices by digons, where for their position we have always two possibilities (Graphic 1c). To every general fullerene corresponds (up to isomorphism) an edge-colored 3-regular graph (with bold edges denoting digons).

This way, we have two complementary ways for the derivation of general fullerenes: vertex bifurcation method applied to basic polyhedra, or edge-coloring method applied to 3-regular graphs, where in each vertex there is exactly one colored edge. For every general fullerene we could define its geometrical structure (i.e. the positions of C atoms) described by a non-colored 3-regular graph, and its chemical structure (i.e. positions of C atoms and their double bonds) described by the corresponding edge-colored 3-regular graph. In the same sense, for every general fullerene we could distinguish two possible symmetry groups: a symmetry group G corresponding to the geometrical structure and its subgroup G′ corresponding to the chemical structure. In the same sense, we will distinguish geometrical and chemical isomers.

For example, for C60, G=G′=[3,5]=Ih=S5 of order 120[5], but for C80 with the same G, G′ is always a proper subgroup of G, and its chemical symmetry is lower than the geometrical. Hence, after C60, the first fullerene with G=G′=[3,5]=Ih=S5 will be C180, then C240, etc.

[image]

Working with general fullerenes without any restriction for the number of edges of their faces, the first basic polyhedron from which we could derive them (after the trivial 1*) will be the regular octahedron {3,4} or 6*, from which we obtain 7 general fullerenes. From the basic polyhedron 8* with v=8 we derive 30, and from the basic polyhedron 9* we obtain 4 general fullerenes. All the basic polyhedra with v<13 and their Schlegel diagrams are given by Graphic. 2.

[image]

Among general fullerenes we could distinguish the class consisting of 5/6 fullerenes with pentagonal or hexagonal faces. If n5 is the number of pentagons, and n6 the number of hexagons, from the relationship 3v=2e and Euler theorem directly follows that n5=12, so the first 5/6 fullerene will be C20 with n6=0—the regular dodecahedron {5,3 }, giving possibility for two non-isomorphic edge-colorings, resulting in two chemically different isomers of the same geometrical dodecahedral form (Graphic 3). The first basic polyhedra generating 5/6 fullerenes will be that with v=10 vertices. For v=10, there are three basic polyhedrons, but only 10* and 10** could generate 5/6 fullerenes, each only one of them (Graphic 4a). On the other hand, they generate, respectively, 78 and 288 general fullerenes. This way, we have two mutually dual methods for the derivation of fullerenes: (a) edge-coloring of a 3-regular graph, with one colored edge in each vertex; (b) introduction of a digon in every vertex of 4-regular graph, giving possibility for a double check of the results obtained. Their duality is illustrated by the example of two C20 chemical isomers derived, both of the same geometrical dodecahedral form with G=[3,5]=Ih =S5 of the order 120, but the first with G′=D5d=[2+,10]=D5×C2 of the order 20, and the other with G′=[2,2]+=D2 of the order 4 (Graphic 3, 4a). In this case, the symmetry of chemical isomers derived by the vertex bifurcation is preserved from their generating basic polyhedra (Graphic 4a)

[image]

[image]

For the enumeration of general fullerenes we used Polya enumeration theorem [6], applied to basic polyhedra knowing their automorphism groups, but with the restriction to 5/6 fullerenes its application is not possible. With the same restriction, the other derivation method: edge-coloring of 3-regular graphs is also not suitable for the application of Polya enumeration theorem, because of the condition that in every vertex only one edge must be colored. The basic polyhedra with n<13 vertices are derived by T. P. Kirkman [1], and used in the works by J. Conway (only for n<12) [2], A. Caudron [3] and S. V. Jablan (for n<13) (Graphic 2) [4]. The 3-connected 4-regular planar graphs (corresponding to basic polyhedra) are enumerated by H. J. Broersma, A. J. W. Duijvestijn and F. Göbel (n<16) [7] and by B. M. Dillencourt (n<13) [8], but given only as numerical results without any data about individual graphs. The 3-regular graphs with n<13 vertices and their edge-colorings producing 4-regular graphs are discussed by A. Yu. Vesnin [9].

Proceeding in the same way, it is possible to prove that 5/6 fullerenes with 22 atoms not exist at all, and that they are seven 5/6 fullerenes C24 of the same geometrical form with G=D6d =[2+,12]=D12 (Graphic 5). To distinguish different chemical isomers, sometimes even knowing their chemical symmetry group G′ will be not sufficient. For their exact recognition we could use some results from the knot theory [10]: the polynomial invariant of knot and link projections, [11]. Every 4-regular graph could be transformed into the projection of an alternating knot or link (and vice versa), and the correspondence between such alternating knot or link diagrams and 4-regular graphs is 1-1 (up to enantiomorphism) (Graphic 4b).

[image]

Using the mentioned connection between alternating knot or link diagrams and 4-regular (chemical) Schlegel diagrams of fullerenes, it is interesting to consider all of them after such conversion. For example, two chemical isomers of C20 will result in knots, and from 7 isomers of C24 we obtain four knots, one 3-component, one 4-component and one 5-component link. Among the links obtained, two of them (3-component and 5-component one) contain a minimal possible component: hexagonal carbon ring (or simply, a circle). It is interesting that C60 consists only of such regularly arranged carbon rings, so maybe this could be another additional reason for its stability (Graphic 7). Therefore, it will be interesting to consider the infinite class of 5/6 fullerenes with that property, that will be called “perfect”. Some of “perfect” fullerenes are modeled with hexastrips by P. Gerdes [13], and similar structures: buckling patterns of shells and spherical honeycomb structures are considered by different authors (e.g. T. Tarnai [14]).

[image]

To obtain them, we will start from some 5/6 fullerene given in geometrical form (i.e. by a 3-regular graph). Than we could use “mid-edge-truncation” and vertex bifurcation in all vertices of the triangular faces obtained that way, transforming them into hexagons with alternating digonal edges. Let is given some fullerene (e.g. C20) in its geometrical form (i.e. as 3-regular graph). By connecting the midpoints of all adjacent edges we obtain from it the 3/5 fullerene covered by connected triangular net and pentagonal faces preserved from C20. After that, in all the vertices of the truncated polyhedron we introduce digons, to transform all triangles into hexagonal faces. This way, from C20 we derived C60 (in its chemical form) (Graphic 7).

The mid-edge-truncation we could apply to any 5/6 (geometrical) fullerene, to obtain new “perfect” (chemical) fullerene, formed by carbon rings. This way, from a 5/6 fullerene with v vertices we always may derive new “perfect” 5/6 fullerene with 3v vertices (Graphic 8). Moreover, the symmetry of new fullerene is preserved from its generating fullerene. According to the theorem by Grünbaum & Motzkin [15], for every non-negative n6 unequal to 1, there exists 3-valent convex polyhedron having n6 hexagonal faces. Hence, from the infinite class of 3-regular 5/6 polyhedra with v=20+n6 vertices, we obtain the infinite class of “perfect” fullerenes with v=60+3n6 vertices. The “perfect” fullerenes satisfy two important chemical conditions: (a) the isolated pentagon rule (IPR); (b) hollow pentagon rule (HPR). The IPR rule means that there are no adjacent pentagons, and HPR means that all the pentagons are “holes”, i.e. that every pentagon could have only external double bonds. The first 5/6 fullerene satisfying IPR is C60, and it also satisfies HPR. The IPR is well known as the stability criterion: all fullerenes of lower order (less than 60) are unstable, because they don't satisfy IPR. On the other hand, C70 satisfies IPR, but cannot satisfy HPR (Graphic 1a).

[image]

[image]

Graphic 9. The same situation is with C80, possessing the same icosahedral geometrical symmetry as C60, but not able to preserve it after edge-coloring, because HPR cannot be satisfied (Graphic. 9). This is the reason that only “perfect” fullerenes, with T=G′=[3,5]==Ih=S5, satisfying both IPR and HPR will be C60, C180, C240, etc. We need also to notice that for n6=0,2,3 we have always one 3-regular 5/6 polyhedron (i.e. geometrical form of C20, C24, C26), but for some larger values (e.g. n6=4,5,7,9) there are serveral geometrical isomers of the generating fullerene, and consequently, the same number of “perfect” fullerenes derived from them (Graphic 10). Hence, considering the fullerene isomers, we could distinguish “geometrical isomers”, this means, different geometrical forms of some fullerene treated as 3-regular 5/6 polyhedron, and “chemical isomers” —different arrangements of double bonds, obtained from the same 3-regular graph by its edge-coloring.

[image]

For denoting different categories of symmetry groups, we will use Bohm symbols [16]. In a symbol Gnst . . . , the first subscript n represents the maximal dimension of space in which the transformations of the symmetry group act, while the following subscripts st . . . represent the maximal dimensions of subspaces remaining invariant under the action of transformations of the symmetry group, that are properly included in each other.

With regard to their symmetry, general fullerenes belong to the category of point groups G30. The category G30 consists of seven polyhedral symmetry groups without invariant planes or lines: [3,3] or Td, [3,3]+or T, [3,4] or Oh, [3,4]+or O, [3,+4] or Th, [3,5] or Ih, [3,5]+or I, and from seven infinite classes of point symmetry groups with the invariant plane (and the line perpendicular to it in the invariant point): [q] or Cqv, [q]+ or Cq, [2+,2q+] or S2q, [2,q+] or Cqh, [2,q]+ or Dq, [2+,2q] or Dqd, [2,q] or Dqh, belonging to the subcategory G320[5]. For the groups of the subcategory G320, in the case of rotations of order q>2, the invariant line (i.e. the rotation axis) may contain 0,1 or 2 vertices of a general fullerene. According to this, among all general fullerenes with a geometrical symmetry group G belonging to G320, from the topological point of view we could distinguish, respectively, cylindrical fullerenes (nanotubes), conical and biconical ones

We could simply conclude that for polyhedral 5/6 fullerenes G could be only [3,3] (Td ), [3,3]+(T), [3,5] (Ih), [3,5]+(I), because of their topological structure (n5=12), incompatible with the octahedral symmetry group [3,4] (Oh) or its polyhedral subgroups. In the case of nanotubes (or cylindrical fullerenes) we have infinite classes of 5/6 fullerenes with the geometrical symmetry group [2,q] (Dqh) and [2+,2q] (Dqd), and the same chemical symmetry. The first infinite first class of cylindrical nanotubes with G=G′=D5h we obtain from a cylindrical 3/4/5 4-regular graph with two pentagonal bases, 10 triangular and 5(2k+1) quadrilateral faces (k=0,1,2, . . . ) and with the same symmetry group (Graphic 11). By the vertex bifurcation preserving its symmetry, we obtain the infinite class of nanotubes C30, C50, C70, . . . , with C70 as the first of them satisfying IPR. Certainly, the geometrical structure of C70 admits different edge colorings (i.e. chemical isomers). Starting from any two of them (Graphic 12) by “collapsing” (the inverse of “vertex bifurcation”, i.e. by deleting digons) we could obtain different generating 4-regular graphs. This example of two different C70 isomers, with the same geometrical structure, and with the same G and G′, shows that for the exact recognition of fullerene isomers we need to know more than their geometrical and chemical symmetry (see Part 3).

In the same way, from 4-regular graphs with two hexagonal bases, 12 triangular and 6(2k+1) quadrilateral faces (k=0,1,2, . . . ) we obtain the infinite class of fullerenes C36, C60 C84, . . . with the symmetry group G=G′=D6h (Graphic 13).

[image]

[image]

[image]

The next symmetry groups [2+,2q] (Dqd) with q=5,6 we obtain in the same way, from 4-regular graphs with q-gonal bases, 2q triangular and 2kq quadrilateral faces (k=1,2, . . . for q=5; k=0,1,2, . . . for q=6) (Graphic 14). As the limiting case, for q=5 and k=0, we obtain C20 with the icosahedral symmetry group G, but with G′=D5d, that could be used as the “brick” for the complete class of nanotubes C40, C60,C80, . . . with G=D5d, where all of them could be obtained from C20 by “gluing” the pentagonal bases (Graphic 15). In the same way, fullerene C24 obtained for q=6 and k=0 could be used as the building block for the nanotubes C48, C72,C96, . . . The geometrical structure of nanotube class with G=Dqd (q=5,6) permits the edge coloring preserving the symmetry, so there always exist their isomers with G=G′.

[image]

If the 3-rotation axis contains the opposite vertices of a fullerene, we have biconical fullerenes (e.g. C26, C56) with G=D3h, G=D3d, respectively (Graphic 16). Certainly, after the edge coloring, their symmetry must be disturbed, and for them G′ is always a proper subgroup of G. For example, for C26 (Graphic 16), G=D3h, G′=C2v.

[image]

Proceeding in the same way, it is possible to find or construct fullerene representatives of other symmetry groups from the category G320: biconical C32 with G=D3, biconical C38 or conical C34 with G=C3v, conical C46 with G=C3[17], or the infinite class of cylindrical fullerenes C42, C48, C54 . . . with G=D3 (Graphic 17). In general, after edge coloring of their 3-regular graphs, symmetry could not be preserved in all conical or biconical fullerenes mentioned, so their geometrical symmetry is always higher than the chemical.

[image]

The inventor's shaft modification also attempts to exploit subtle field energies by exploiting phi, Lucas, Fibonacci, philotaxic and related geometries and or ratios and their resultant fractal vibrational coherence through coherent shaft, head or club vibration or combinations therein.

Cellular metabolism and all related physiology can be influenced by direct electrical stimulation as shown in Robert Becker's seminal work “Body Electric,” and has been famously demonstrated to influence everything from arthritis to cancer by such luminaries as Royal Raymond Rife, Freeman Cope, Gilbert Ling (of the Ling induction hypothesis) and many others.

The inventor would like to emphasize the general point that he has used phi ratios to specifically modify subtle energy fields for improved putting and in the case of full shafts, for dramatically increasing hitting power (driving distances increased from 300 to 400 yards [extremely anomalous gains to those skilled in the art]). They are nonetheless real, documented, physiological and kinematic effects, and constitute, as far as the inventor knows, the first direct application in golf clubs. The inventor, while not wanting to overwhelm, wishes to direct the examiner's attention to a condensation of the key factors influencing such energetics so as to better characterize his effect, bringing it from the slightly obscure into the realm of practicality.

Most of the molecules in the body are electrical dipoles (Beal, 1996). These dipoles electronically function like transducers in that they are able to turn acoustic waves into electrical waves and electrical waves into acoustic waves (Beal, 1996). The natural properties of biomolecular structures enables cell components and whole cells to oscillate and interact resonantly with other cells (Smith and Best, 1989). According to Smith and Best, the cells of the body and cellular components possess the ability to function as electrical resonators (Smith and Best, 1989). Professor H. Frohlich has predicted that the fundamental oscillation in cell membranes occurs at frequencies of the order of 100 GHz and that biological systems possess the ability to create and utilize coherent oscillations and respond to external oscillations (Frohlich, 1988). Lakhovsky predicted that cells possessed this capability in the 1920's (Lakhovsky, 1939).

Because cell membranes are composed of dielectric materials a cell will behave as dielectric resonator and will produce an evanescent electromagnetic field in the space around itself (Smith and Best, 1989). “This field does not radiate energy but is capable of interacting with similar systems. Here is the mechanism for the electromagnetic control of biological function (Smith and Best, 1989).”

In the inventor's opinion this means that the applications of certain frequencies by frequency generating devices can enhance or interfere with cellular resonance and cellular metabolic and electrical functions. The changes in the degree that water is structured in a cell or in the ECM will affect the configurations and liquid crystal properties of proteins, cell membranes, organelle membranes and DNA. Healthy tissues have more structured water than unhealthy tissues. Clinicians who recognize this fact have found that certain types of music, toning, chanting, tuning forks, singing bowls, magnetic waters, certain types of frequency generators, phototherapy treatments and homeopathic preparations can improve water structuring in the tissues and health when they are correctly utilized. Electricity, charge carriers and electrical properties of cells.

The cells of the body are composed of matter. Matter itself is composed of atoms, which are mixtures of negatively charged electrons, positively charged protons and electrically neutral neutrons. Electric charges—When an electron is forced out of its orbit around the nucleus of an atom the electron's action is known as electricity. An electron, an atom, or a material with an excess of electrons has a negative charge.

An atom or a substance with a deficiency of electrons has a positive charge. Like charges repel unlike charges attract. Electrical potentials—are created in biological structures when charges are separated. A material with an electrical potential possess the capacity to do work. Electric field—“An electric field forms around any electric charge (Becker, 1985).” The potential difference between two points produces an electric field represented by electric lines of flux. The negative pole always has more electrons than the positive pole. Electricity is the flow of mobile charge carriers in a conductor or a semiconductor from areas of high charge to areas of low charge driven by the electrical force. Any machinery whether it is mechanical or biological that possesses the ability to harness this electrical force has the ability to do work.

Voltage also called the potential difference or electromotive force—A current will not flow unless it gets a push. When two areas of unequal charge are connected a current will flow in an attempt to equalize the charge difference. The difference in potential between two points gives rise to a voltage, which causes charge carriers to move and current to flow when the points are connected. This force cause motion and causes work to be done. Current—is the rate of flow of charge carriers in a substance past a point. The unit of measure is the ampere. In inorganic materials electrons carry the current.

In biological tissues both mobile ions and electrons carry currents. In order to make electrical currents flow a potential difference must exist and the excess electrons on the negatively charged material will be pulled toward the positively charged material. A flowing electric current always produces an expanding magnetic field with lines of force at a 90-degree angle to the direction of current flow. When a current increases or decreases the magnetic field strength increases or decreases the same way.

Conductor—in electrical terms a conductor is a material in which the electrons are mobile. Insulator—is a material that has very few free electrons. Semiconductor—is a material that has properties of both insulators and conductors. In general semiconductors conduct electricity in one direction better than they will in the other direction. Semiconductors can functions as conductors or an insulators depending on the direction the current is flowing. Resistance—No materials whether they are non-biological or biological will perfectly conduct electricity. All materials will resist the flow of an electric charge through it, causing a dissipation of energy as heat. Resistance is measured in ohms, according to Ohm's law. In simple DC circuits resistance equals impedance.

Impedance—denotes the relation between the voltage and the current in a component or system. Impedance is usually described “as the opposition to the flow of an alternating electric current through a conductor. However, impedance is a broader concept that includes the phase shift between the voltage and the current (Ivorra, 2002).” Inductance—The expansion or contraction of a magnetic field varies as the current varies and causes an electromotive force of self-induction, which opposes any further change in the current. Coils have greater inductance than straight conductors so in electronic terms coils are called inductors. When a conductor is coiled the magnetic field produced by current flow expands across adjacent coil turns. When the current changes the induced magnetic field that is created also changes and creates a force called the counter emf that opposes changes in the current.

This effect does not occur in static conditions in DC circuits when the current is steady. The effect only arises in a DC circuit when the current experiences a change in value. When current flow in a DC circuit rapidly falls the magnetic field also rapidly collapses and has the capability of generating a high induced emf that at times can be many times the original source voltage. Higher induced voltages may be created in an inductive circuit by increasing the speed of current changes and increasing the number of coils. In alternating current (AC) circuits the current is continuously changing so that the induced emf will affect current flow at all times. The inventor would like to interject at this point that a number of membrane proteins as well as DNA consist of helical coils, which may allow them to electronically function as inductor coils. Some research indicates that biological tissues may possess superconducting properties.

If certain membrane proteins and the DNA actually function as electrical inductors they may enable the cell to transiently produce very high electrical voltages. Capacitance—is the ability to accumulate and store charge from a circuit and later give it back to a circuit. In DC circuits capacitance opposes any change in circuit voltage. In a simple DC circuit current flow stops when a capacitor becomes charged. Capacitance is defined by the measure of the quantity of charge that has to be moved across the membrane to produce a unit change in membrane potential. Capacitors—in electrical equipment are composed of two plates of conducting metals that sandwich an insulating material. Energy is taken from a circuit to supply and store charge on the plates. Energy is returned to the circuit when the charge is removed.

The area of the plates, the amount of plate separation and the type of dielectric material used all affect the capacitance. The dielectric characteristics of a material include both conductive and capacitive properties (Reilly, 1998). In cells the cell membrane is a leaky dielectric. This means that any condition, illness or change in dietary intake that affects the composition of the cell membranes and their associated minerals can affect and alter cellular capacitance. Inductors in electronic equipment exist in series and in parallel with other inductors as well as with resistors and capacitors. Resistors slow down the rate of conductance by brute force. Inductors impede the flow of electrical charges by temporarily storing energy as a magnetic field that gives back the energy later. Capacitors impede the flow of electric current by storing the energy as an electric field. Capacitance becomes an important electrical property in AC circuits and pulsating DC circuits. The tissues of the body contain pulsating DC circuits (Becker and Selden, 1985) and AC electric fields (Liboff, 1997). Cellular electrical properties and electromagnetic fields (EMF) EMF effects on cells include Ligand receptor interactions of hormones, growth factors, cytokines and neurotransmitters leading to alteration/initiation of membrane regulation of internal cellular processes. Alteration of mineral entry through the cell membrane. Activation or inhibition of cytoplasmic enzyme reactions. Increasing the electrical potential and capacitance of the cell membrane. Changes in dipole orientation.

Activation of the DNA helix possibly by untwisting of the helix leading to increase reading and transcription of codons and increase in protein synthesis Activation of cell membrane receptors that act as antennas for certain windows of frequency and amplitude leading to the concepts of electromagnetic reception, transduction and attunement.

Attunement: In the inventor's opinion there are multiple structures in cells that act as electronic components. If biological tissues and components of biological tissues can receive, transduce and transmit electric, acoustic, magnetic, mechanical and thermal vibrations then this may help explain such phenomena as:

1. Biological reactions to atmospheric electromagnetic and ionic disturbance (sunspots, thunder storms and earthquakes).

2. Biological reactions to the earth's geomagnetic and Schumann fields.

3. Biological reactions to hands on healing.

4. Biological responses to machines that produce electric, magnetic, photonic and acoustical vibrations (frequency generators).

5. Medical devices that detect, analyze and alter biological electromagnetic fields (the biofield).

6. How techniques such as acupuncture, moxibustion, and laser (photonic) acupuncture can result in healing effects and movement of Chi?

7. How body work such as deep tissue massage, rolfing, physical therapy, chiropractics can promote healing?

8. Holographic communication.

9. How neural therapy works?

10. How electrodermal screening works?

11. How some individuals have the capability of feeling, interpreting and correcting alterations in another individual's biofield?

12. How weak EMFs have biological importance? In order to understand how weak EMFs have biological effects it is important to understand certain concepts that:

Many scientists still believe that weak EMFs have little to no biological effects.

a. Like all beliefs this belief is open to question and is built on certain scientific assumptions. b. These assumptions are based on the thermal paradigm and the ionizing paradigm. These paradigms are based on the scientific beliefs that an EMF's effect on biological tissue is primarily thermal or ionizing.

Electric fields need to be measured not just as strong or weak, but also as low carriers or high carriers of information.

Because electric fields conventionally defined as strong thermally may be low in biological information content and electric fields conventionally considered as thermally weak or non-ionizing may be high in biological information content if the proper receiving equipment exists in biological tissues. Weak electromagnetic fields are: bioenergetic, bioinformational, non-ionizing and non-thermal and exert measurable biological effects. Weak electromagnetic fields have effects on biological organisms, tissues and cells that are highly frequency specific and the dose response curve is non linear. Because the effects of weak electromagnetic fields are non-linear, fields in the proper frequency and amplitude windows may produce large effects, which may be beneficial or harmful.

Homeopathy is an example of use weak field with a beneficial electromagnetic effect. Examples of a thermally weak, but high informational content fields of the right frequency range are visible light and healing touch. Biological tissues have electronic components that can receive, transduce, transmit weak electronic signals that are actually below thermal noise.

Biological organisms use weak electromagnetic fields (electric and photonic) to communicate with all parts of themselves An electric field can carry information through frequency and amplitude fluctuations.

Biological organisms are holograms.

Those healthy biological organisms have coherent biofields and unhealthy organisms have field disruptions and unintegrated signals.

Corrective measures to correct field disruptions and improve field integration such as acupuncture; neural therapy and resonant repatterning therapy promote health. Independent research by Dr. Robert Becker and Dr. John Zimmerman during the 1980's investigated what happens whilst people practice therapies like Reiki. They found that not only do the brain wave patterns of practitioner and receiver become synchronized in the alpha state, characteristic of deep relaxation and meditation, but they pulse in unison with the earth's magnetic field, known as the Schuman Resonance. During these moments, the biomagnetic field of the practitioners' hands is at least 1000 times greater than normal, and not as a result of internal body current Toni Bunnell (1997) suggests that the linking of energy fields between practitioner and earth allows the practitioner to draw on the ‘infinite energy source’ or ‘universal energy field’ via the Schuman Resonance. Prof. Paul Davies and Dr. John Gribben in The Matter Myth (1991), discuss the quantum physics view of a ‘living universe’ in which everything is connected in a ‘living web of interdependence’. All of this supports the subjective experience of ‘oneness’ and ‘expanded consciousness’ related by those who regularly receive or self-treat with Reiki.

Zimmerman (1990) in the USA and Seto (1992) in Japan further investigated the large pulsating biomagnetic field that is emitted from the hands of energy practitioners whilst they work. They discovered that the pulses are in the same frequencies as brain waves, and sweep up and down from 0.3-30 Hz, focusing mostly in 7-8 Hz, alpha state. Independent medical research has shown that this range of frequencies will stimulate healing in the body, with specific frequencies being suitable for different tissues. For example, 2 Hz encourages nerve regeneration, 7Hz bone growth, 10 Hz ligament mending, and 15 Hz capillary formation. Physiotherapy equipment based on these principles has been designed to aid soft tissue regeneration, and ultra sound technology is commonly used to clear clogged arteries and disintegrate kidney stones. Also, it has been known for many years that placing an electrical coil around a fracture that refuses to mend will stimulate bone growth and repair.

Becker explains that ‘brain waves’ are not confined to the brain but travel throughout the body via the perineural system, the sheaths of connective tissue surrounding all nerves. During treatment, these waves begin as relatively weak pulses in the thalamus of the practitioner's brain, and gather cumulative strength as they flow to the peripheral nerves of the body including the hands. The same effect is mirrored in the person receiving treatment, and Becker suggests that it is this system more than any other, that regulates injury repair and system rebalance. This highlights one of the special features of Reiki (and similar therapies)—that both practitioner and client receive the benefits of a treatment, which makes it very efficient.

It is interesting to note that Dr. Becker carried out his study on world-wide array of cross-cultural subjects, and no matter what their belief systems or customs, or how opposed to each other their customs were, all tested the same. Part of Reiki's growing popularity is that it does not impose a set of beliefs, and can therefore be used by people of any background and faith, or none at all. This neutrality makes it particularly appropriate to a medical or prison setting.

Phi and related geometries and ratios, and the fractal vibrational coherence that they promote, such as in the Flanagan experiments, is exploited in the invention.

The characteristics of centripetal motion are generative and regenerative. The effects are contraction, cooling, alkalinity, absorbing, charging, high electrical potential, amorphic structures and a sub-pressure or vacuum, to name just a few.

The characteristics of centrifugal motion are de-generating, decomposing and expanding, with just the opposite effects of heating, acidity, emanation, discharging, lowered electrical potential, crystalline formation and excessive pressure.

The blood is highly affected by excessive heat and pressure. Red corpuscles change their shape, swell up, become eccentric and even rupture their envelope under pressure. When blood is removed from the body and exposed to light, heat or atmospheric pressures, it crystallizes. The red corpuscles normally have no problem with movement, staying in a continuous flow through the vessels, with no tendency to adhere to each other or to the wall of the vessel. But, when the blood is drawn out, examined on a slide, exposed to oxygen, heat or reagents the corpuscles collect into heaps. It is suggested that this is due to an alteration in surface tension. Also exposure to heat causes blood to acidify. Healthiest blood is slightly alkaline. Blood has a certain range of requirements it must function within to stay healthy.

The vortex movement of blood is vital to its health. It keeps the ionic components of the blood suspended in an amorphic state, ready for assimilation. The vortex movement assures the osmotic suction condition in preponderance over a pressure condition. Increased pressure in a blood vessel leads to crystalline sclerotic deposits on the vascular walls. This may end in strokes through bursting of encrusted vessels.

The “toward the inside” roll of a vortex movement reduces friction on the walls of blood vessels and this motion helps cool the blood to protect it from excessive heat. It does this by perpetually changing the surface layer, thus preventing any portion of the fluid to be exposed for any length of time to the warmer outside walls. The centripetal contraction of a vortex also regulates the necessary specific density of the blood plasma.

We know our blood is made up mostly of water. As a matter of fact, all biological systems consist mostly of water. It is obvious that water is one of the primary and most essential elements for all living processes. In the second month of gestation a human being still consists almost entirely of water and even as an old man about 60 percent of his substance is water.

Oddly enough, water has the same basic needs to maintain maximum health and rejuvenate itself that blood requires. Viktor Schauberger, an Austrian Forester called the “Water Magician” during the 1930's-1950's realized that water is the blood of the earth. The rivers, streams and underground veins of water he called the arteries and network of capillaries of our living organism earth. He taught that water is not just the chemical formula H20, but instead is the ‘first born’ organic, living substance of our Universe! Since water is a living organism it has certain metabolic needs to maintain its health. Schauberger discovered that metabolism and defined water's needs as:

1. The freedom to flow in a vortexian, spiralic movement

2. Protection from excessive pressure, light and heat

3. Exposure to oxygen and atmospheric gases through a diffusion

4. Contact with certain elements for ionization and catalytic influence.

Meeting these needs allows water to approach an optimally cool temperature, regulate its own ph and freezing and boiling points, maintain a healthy firm surface tension, and collect and carry nutrients and an electrical potential.

Vortexian Mechanics is the study of “paths of motion”, their characteristics and the result of that motion in our Universe. Back in the early 1920's George Lakhovsky developed an instrument he called a Radio-cellular oscillator, which he used to experiment on geraniums that had been inoculated with cancer (Lakhovsky, 1939). From these experiments he decided that he could obtain better results if he constructed an apparatus capable of generating an electrostatic field, which would generate a range of frequencies from 3 meters to infrared (Lakhovsky, 1934). Lakhovsky believed that living organisms are capable of interrelating by receiving and giving off electromagnetic radiations. Note: If Lakhovsky's theory is correct then the potential exists for direct energetic communication between living organisms. Lakhovsky theorized that each cell of the body is characterized by its own unique oscillation. He also believed that one of the essential causes of cancer formation was that cancerous cells were in oscillatory disequilibrium. He believed the way to bring cells that were in disequilibrium back to their normal oscillations was to provide an oscillatory shock (Lakhovsky, 1939). Royal Rife on the other hand believed that oscillatory shock could be used to kill infectious organisms and cancer cells. Either way changing the oscillation of cancer cells has been thought to be beneficial. Lakhovsky theorized that an instrument that provided a multitude of frequencies would allow every cell to find and vibrate in resonance with its own frequency. In 1931 he invented an instrument called the Multiple Wave Oscillator. Until his death in 1942 he treated and cured a number of cancer patients (Lakhovsky,1939). Other individuals who have used his MWO have also reported similar results. Individuals such as Royal Rife in the 1930's and Antoine Priore in the 1960's also invented electronic equipment that was reported to benefit patients with cancer (Bearden, 1988).

If Lakhovsky, Rife and Priore were right, then equipment that addresses and attempts to correct the electrical derangements of cancer cells can be beneficial in some cases. Polychromatic states and health: a unifying theory? Prigonine's 1967 description of dissipative structures gave a model and an understanding of how open systems like biological organisms that have an uninterrupted flow of energy can self-organize. Biological systems are designed to take in and utilize energy from chemical sources (food), but they can also utilize energy and information from resonant interactions with electromagnetic fields and acoustical waves to maintain their dynamic organization.

According to Ho, “Energy flow is of no consequence unless the energy is trapped and stored within the system where it circulates before being dissipated (Ho, 1996).” In the inventor's opinion this means that cellular structures that tranduce, store, conduct and couple energy are critical features of any living organism. Living systems are characterized by a complex spectrum of coordinated action and rapid intercommunication between all parts (Ho, 1996). The ideal complex activity spectrum of a healthy state is polychromatic where all frequencies of stored energy in the spectral range are equally represented and utilized (Ho, 1996).

In an unhealthy state some frequencies may be present in excess and other frequencies may be missing. For example it has been reported that a healthy forest emits a polychromatic spectrum of acoustical frequencies and an unhealthy forest will have holes in its frequency spectrum. Yet when the forest regains its health it again emits a polychromatic spectrum of frequencies. The frequency holes got filled in. When an area of the body is not properly communicating it will fall back on its own mode of frequency production, which according to Mae-Wan Ho leads to an impoverishment of its frequency spectrum.

In looking at the example of cardiac frequency analyzers it has been discovered that sick individuals have less heart rate variability than healthy individuals. The concept of polychromatism makes sense when you consider phenomena such as the healing effects of: sunlight, full spectrum lights, music, tuning forks, chanting, toning, drumming, crystal bowls, sound therapy, prayer, love, the sound of a loved one's voice, essential oils, flower essences, healing touch, multiwave oscillators, and homeopathics. Something or things (frequency or frequencies) that were missing are provided by these treatments.

From the consideration of applied frequency technologies it can be theorized that one aspect of why these consonant technologies work is because they supply frequencies that are missing in the electromagnetic and acoustical spectral emissions of living organisms. When missing frequencies are supplied they in a sense fill gaps in the frequency spectrum of a living organism.

Dissonant technologies would identify frequency excesses and pathogenic frequencies and would provide frequency neutralization by phase reversal. Electromagnetic technologies such as Rife and radionics may act by phase reversal and neutralization of pathogenic frequencies. Royal Rife also theorized that his equipment used resonant transmission of energy that caused pathogenic organisms to oscillate to the point of destruction. If we consider polychromatism to be the model of the healthy state then it makes sense that technologies such as electrodermal screening and voice analysis that detect frequency imbalances (excesses and deficiencies) can play beneficial roles in health care. The inventor believes that in the future doctors will more widely utilize equipment such as electrodermal screening, acoustical spectrum analyzers, electromagnetic spectral emission analyzers and their software for diagnostic purposes. This type of equipment can be used to identify and treat frequency imbalances.

This discussion ties in such concepts as acupuncture and neural therapy. Acupuncture may help address and remove impedances or blocks to energy mobilization by helping to reconnect disconnected energy pathways back into a coherent and harmonic flow. Neural therapy may act by neutralizing aberrant local signal generators in traumatized and scarred tissue. In a sense removing disharmonious music from a particular location. The application of neural therapy is not too unlike a band conductor correcting a student who is playing out of key.

There is also evidence that certain brain states associated with efficient learning, storage, retrieval and meaningfully interrelating information, is regulated by the golden ratio or Phi. There certainly is much research supporting Phi ratio vibrations (musical fifths) in everything from seed germination, water structuring, to muscle strength and cognition. In some potentially paradigm-shifting research by Volkmar Weiss supports a relationship between short-term memory capacity and EEG power spectral density conforming to Phi ratios.

Volkmar Weiss posits that the crucial question to answer is: Why is the clock cycle of the brain 2 Phi and not 1 Phi? What is the advantage of the fundamental harmonic to be 2 Phi? Half of the wavelength of 2 Phi, that means 1 Phi and its multiples are exactly the points of resonance, corresponding to the eigen values and zero-crossings of the wave packet (wavelet). With this property the brain can use simultaneously the powers of the golden mean and the Fibonacci word for coding and classifying. A binomial graph of a memory span n has n distinct eigen values and these are powers of the golden mean. The number of closed walks of length k in the binomial graph is equal to the nth power oft the (k+1)-st Fibonacci number. The total number of closed walks of length k within memory is the nth power of the kth Lucas number.

An extended publication, summarizing the arguments in favor of this new interpretation of the data—i.e. 2 Phi instead of Pi. Phi (the golden mean, synonymously called the golden section, the golden ratio, or the divine proportion), the integer powers of Phi, the golden rectangle, and the infinite Fibonacci word 10110101101101 . . . (FW, synonymously also called the golden string, the golden sequence, or the rabbit sequence) are at the root of the information processing capabilities of our brains.

Period Doubling Route to Chaos: It turns out when R=2 Phi=2 times 1,1618=3,236 one gets a super-stable period with two orbits. What this means is that Phi enters into non-linear process as the rate parameter which produces the first island of stability.

The same holds for the Feigenbaum constants, the length w1 is positioned at a=2 Phi. Where the Phi line crosses a horizontal grid line (y=1, y=2, etc) we write 1 by it on the line and where the Phi line crosses a vertical grid line (x=l, x=2, etc) we record a 0. Now as we travel along the Phi line from the origin, we meet a sequence of 1s and 0s—the Fibonacci sequence again.
1 0 1 1 0 1 0 1 1 0 1 1 0 1 0 1 1 0 1 0 1 1 0 1 1 0 1 0 1 1 0 1 . . .

The frequency of occurrence of either 1 or 0 is called the sampling frequency by engineers. Of fundamental importance: The Fibonacci word and the spectrum of Phi. Let's look at the multiples of Phi, concentrating on the whole number part of the multiples of Phi. We will find another extraordinary relationship. The “whole number part” of x is written as floor(x) so we are looking at floor(i Phi) for i=1,2,3, . . . In this section on the Fibonacci word will only be interested in positive numbers, so the floor function is the same as the trunc function. The sequence of truncated multiples of a real number R is called the spectrum of R.

Here are the first few numbers of the spectrum of Phi, that is the values of the Beatty sequence floor(Phi), floor(2 Phi), floor(3 Phi), floor(4 Phi), . . .

1

2

3

4

5

6

7

8 . . .

i Phi

1.618

3.236

4.854

6.472

8.090

9.708

11.326

12.944 . . .

trunc(i*Phi)

1

3

4

6

8

9

11

12 . . .

So the spectrum of Phi is the infinite series of numbers beginning 1, 3, 4, 6, 8, 9, 11, 12, . . . Now look at the Fibonacci sequence and in particular at where the Is occur:

I

1

2

3

4

5

6

7

8

9

10

11

12

13

Fibonacci word

1

0

1

1

0

1

0

1

1

0

1

1

0 . . .

This pattern is true in general and provides another way of defining the Fibonacci word: The 1s in the Fibonacci word occur at positions given by the spectrum of Phi and only at those positions. There is also a remarkable relationship between the spectrum of a number and those numbers missing from the spectrum.

Our brain uses for computing inherent and inborn properties of the physical world. We have or learn into the neural network of our brains the relationships between external stimuli, the integer powers of the golden mean, the Fibonacci word and Lucas numbers, the Beatty sequences of e, Pi, Phi and use hundreds of similar relationships (many of them maybe still undiscovered by contemporary mathematics) between numbers for encoding and decoding simultaneously and unconsciously by wavelets. Only a genius like Ramanajun had some access to this underlying world of numbers. For example, he gave us: Phi (2)=2 ln2, Phi (3)=ln3, Phi(4)= 3/2ln2, Phi(5)=⅕root of 5 lnPhi+½ln5, Phi(6)=½ln3+⅔ln2. A sub-word of the FW is any fragment such as “abab” (or written 1010 as above) or “baa” (or 011). Certain patterns occur as observable sub-words of the FW “a,” “b,” “aa,” “ab,” “ba,” etc., and certain conceivable patterns do not. At length one, two fragments are theoretically possible, “a,” and “b.” Both of them actually occur. At length two, the theoretically possibilities are “aa,” “ab,” “ba”, and “bb.” Here, the last one is never present, as we have seen. At length three, only four of the eight possible patterns occur. They are “aab,” “aba,” “baa,” and “bab.” At length four, only five of the sixteen possible patterns actually occur. At length five, only six out of the thirty-two theoretically possible patterns are seen. In fact, whatever the length of sub-word that is examined, it is always found that the number of distinct sub-words actually occurring of that length in the FW is always one more than the length itself. The probability of finding a subword (and its parent or progeny, see the following) of a wave packet with a maximum of up to nine harmonics can be calculated by hidden Markov chains.

One pattern over another is the simple act of one pattern generating another, as “abaab” generates “abaab” or even as sub-word “bab” generates “aaba.” At length 1, two legal sub-words are found, “a” and “b.” At length 2, three legal sub-words are found, “aa,” “ab,” and “ba.” Here is where the new notion of descent comes in. One can think of “aa” and “ab” as children of parent “a” because both “aa” and “ab” can be created by appending a letter after the pattern, “a”. By the same logic, pattern “ba” has parent pattern, “b.” Continuing, one sees that “aa” is parent of “aab,” that “ab” is parent of “aba,” and that “ba” is parent of both “baa” and “bab.” Simple arithmetic suggests that all but one of the sub-words of any given length will act as parent for a single sub-word of length one letter larger, while one sub-word alone will give birth to two progeny. No other pattern is possible, for all sub-words must have at least one child.

Moving from length three to length four, we note that “aab” produces “aaba,” that “aba” gives rise to “abaa,” as well as to “abab, and that “baa” sires “baab,” At the next level, “aaba” produces “aabaa” and “aabab,” “abaa” gives “abaab,” “abab” gives “ababa,” and “baab” gives “baaba,” and “baba” gives “babaa.”

It turns out that the hyperparental sub-word, at any given length, is precisely the FW itself of that length, written in reverse order. That means that the FW reproduces itself upon reverse mapping (also called block renaming or deflation in renormalization theories in physics). This is the basic coding and search principle of information in our brain. According with Zipf's law the most common and short words have the highest probability of immediate access, rare words a low probability. The coding itself needs learning. Only the principle is the same, the details and content differ between individuals.

For computer science the FW is no newcomer. Processing of strings of symbols is the most fundamental and the most common form of computer processing: every computer instruction is a string, and every piece of data processed by these instructions is a string. Combinatorics of words is the study of arrangement of such strings, and there are literally thousands of combinatorial problems that arise in computer science.

The most essential formulas are from Ramanujan where Pi, e and Phi are closed-form expressions of infinite continued fractions, all three together united in one such formula. In mathematics Cantorian fractal space-time is now associated with reference to quantum systems. Recent studies indicate a close association between number theory in mathematics, chaotic orbits of excited quantum systems and the golden mean.

Optimal search strategy of bees: a lognormal expanding spiral, based on the golden section. This behaviour can be generalized to an optimal search strategy, for example, for searching words in long-term memory (Zipf's law) or filtering information from images. There are applications by Chaitin and others.

It is an astounding psychoacoustic fact, known as octave equivalence that all known musical cultures consider a tone twice the frequency of another to be, in some sense, the same tone as the other (only higher). On the background of such observations Robert B. Glassman wrote his review: “Hypothesized neural dynamics of working memory: Several chunks might be marked simultaneously by harmonic frequencies within an octave band of brain waves”. Glassman's review is essentially congruent with the papers by V. Weiss. We assume that behind octave equivalence is the relation between 2 Phi and 1 Phi, too.

As one can see, the idea that the Fibonacci word can be understood or can be used as a code, is not a new one. There are already a lot of applications. However, new (by neglecting a lot of nonsense with quasi-religious appeal) is the claim, supported by proven empirical facts of psychology and neurophysiology, that our brain uses the golden mean as the clock cycle of thinking and hence the powers of the golden mean and the FW as principle of coding.

In 1944 Oswald Avery discovered that DNA is the active principle of inheritance. It lasted still decades before the genetic code was known in detail and six decades later the human genome was decoded. It will last some decades more, to understand the network of genetic effects in its living environment. Volkmar Weiss believes that his discovery of the fundamental harmonic of the clock cycle of the brain can be compared with Avery's achievement.

The noted neuroscientist Karl Pribram, best known for his theories of holographic brain structures, describes how human skin is a piezoelectric receiver, able to interpret phase differences when in contact at two different points with vibrating tuning forks which the body interprets as a single point of vibration where such vibrations (wave forms) intersect or are phase locked.

The concept of multi-dimensions has roots in string theory. “The notion of any extra dimension to the four known dimensions was conceived by the Polish mathematician Theodor Kaluza in 1919. Kaluza thought that extra spatial dimensions would allow for the integration between general relativity and James Clerk Maxwell's electromagnetic theory. Suported by Swedish mathematician Oskar Klein in the 1920s, these extra dimensions were actually minute, curled-up dimensions that could not be detected due to their extremely small size. These two mathematicians said that within the common three extended dimensions (that we are familiar with) are additional dimensions in tightly curled structures. One possible structure that could envelop six extra dimensions is the Calabi-Yau shape, which was created by Eugenio Calabi and Shing-Tung Yau. Calabi-Yau spaces are important in string theory, where one model posits the geometry of the universe to consist of a ten-dimensional space of the form M×V|, where M|is a four dimensional manifold (space-time) and V|is a six dimensional compact Calabi-Yau space. They are related to Kummer surfaces. Although the main application of Calabi-Yau spaces is in theoretical physics, they are also interesting from a purely mathematical standpoint. Consequently, they go by slightly different names, depending mostly on context, such as Calabi-Yau manifolds or Calabi-Yau varieties.

Although the definition can be generalized to any dimension, they are usually considered to have three complex dimensions. Since their complex structure may vary, it is convenient to think of them as having six real dimensions and a fixed smooth structure.

A Calabi-Yau space is characterized by the existence of a nonvanishing harmonic spinor. This condition implies that its canonical bundle is trivial.

Consider the local situation using coordinates. In [symbol] , pick coordinates x̅₁̅,̅x̅₂̅,̅ x̅₃̅ and y̅₁̅,̅ y̅₂̅,̅ y̅₃̅×̅ [symbol]
(1)
gives it the structure of [symbol] . Then
φ₂=d z₁ˆd z₂ˆd z₃ (2)
is a local section of the canonical bundle. A unitary change of coordinates w=A z, where A̅ is a unitary matrix, transforms φ̅ by [symbol] , i.e.
φ_{w}=det Aφ₂. (3)

If the linear transformation A̅ has determinant 1, that is, it is a special unitary transformation, then φ̅ is consistently defined as φ̅z̅ or as φ̅w̅.

On a Calabi-Yau manifold V, such a φ can be defined globally, and the Lie group [symbol] is very important in the theory. In fact, one of the many equivalent definitions, coming from Riemannian geometry, says that a Calabi-Yau manifold is a 2 n|-dimensional manifold whose holonomy group reduces to S̅U̅ (̅n̅)̅. Another is that it is a calibrated manifold with a calibration form ψ, which is algebraically the same as the real part of [symbol]
(4)

Often, the extra assumptions that [symbol] is simply connected and/or compact are made.

Whatever definition is used, Calabi-Yau manifolds, as well as their moduli spaces, have interesting properties. One is the symmetries in the numbers forming the Hodge diamond of a compact Calabi-Yau manifold. It is surprising that these symmetries, called mirror symmetry, can be realized by another Calabi-Yau manifold, the so-called mirror of the original Calabi-Yau manifold. The two manifolds together form a mirror pair. Some of the symmetries of the geometry of mirror pairs have been the object of recent research.

The Fermat Equation (see below) that are relevant to the Calabi-Yau spaces that may lie at the smallest scales of the unseen dimensions in String Theory; these have appeared in Brian Greene's books, The Elegant Universe and The Fabric of the Cosmos, and in the book by Callender and Huggins, Physics Meets Philosophy at the Planck Scale.

These images show equivalent renderings of a 2D cross-section of the 6D manifold embedded in CP4 described in string theory calculations by the homogeneous equation in five complex variables:
z15+z25+z35+z45+z55=0

The surface is computed by assuming that some pair of complex inhomogenous variables, say z3/z5 and z4/z5, are constant (thus defining a 2-manifold slice of the 6-manifold), normalizing the resulting inhomogeneous equations a second time, and plotting the solutions to
z15+z25=1

The resulting surface is embedded in 4D and projected to 3D using Mathematica (left image) and our own interactive MeshView 4D viewer (right image).

[image]

In the right-hand image, each point on the surface where five different-colored patches come together is a fixed point of a complex phase transformation; the colors are weighted by the amount of the phase displacement in z1 (red) and in z2 (green) from the fundamental domain, which is drawn in blue and is partially visible in the background. Thus the fact that there are five regions fanning out from each fixed point clearly emphasizes the quintic nature of this surface.

For further information, see: A. J. Hanson. A construction for computer visualization of certain complex curves. Notices of the Amer.Math.Soc., 41(9):1156-1163, November/December 1994.

This structure is much like a tightly wound ball that surrounds six dimensions. This six-dimensional structure with the three spatial dimensions and the one time dimension results in the ten-dimensional world. Modern string theory requires these extra dimensions for mathematical purposes. Each of the five superstring theories requires a total of ten dimensions-nine spatial dimensions and one time dimension.

M-theory, which attempts to unify the five theories, requires one more spatial dimension than the five individual string theories. This new dimension was actually overlooked in past work because the calculations done were only estimations; this mathematical error blinded physicists from seeing this extra dimension. As new dimensions have been found, it begs the question as to whether there are only eleven dimensions? Are there infinite dimensions simply curled up into smaller and smaller structures?”

Along with a multidimensional reality this theory suggests that if we could peer at an electron we would not see a particle but a string vibrating; the string is extremely small so that the electron looks like a point, like a particle to us. If that same string vibrates in a different mode, then the electron can turn into something else, such as a quark, the fundamental constituent of protons and neutrons or at a different vibration, photons (light). Thus rather than millions of different particles there is only a single one ‘object’, the superstring; all sub-atomic particles are specific vibrations or notes on the superstring.

The velocity of the flow of water in an imploding vortex multiplied by the radius from the center of the vortex is theoretically infinite. As these forces increase the hydrogen bonds of the water molecule cannot sustain the pressure difference and begin to dissociate, at this point they can be permanently restructured (the bond angles). So first one needs to create a very powerful, very, very, very swiftly moving imploding spiral flow of water We find the circumference of the vessel relative to the speed, of import, and of course the Golden Mean enters into the equation here.

[Researchers studying physical and chemical processes at the smallest scales have found that fluid circulating in a microscopic whirlpool can reach radial acceleration more than a million times greater than gravity, or 1 million Gs. The research appears in the Sep. 4, 2003 edition of the journal Nature.]

The glass vessel containing the imploding water vortex lies in the midst of a large crystal grid, the angles of the relationship between the crystals as well as the type and resonance-quality of import for creating natural scalar, or standing waves. The equipment with the glass vessel containing the imploding water vortex is surrounded by a Tesla coil: actually two coils intertwined as one (Tesla technology does not produce harmful EMF or any form of electronic polution). At this point the liquid medium can be permanently restructured within a standing (or scalar) wave; permanently is the key here, most structured water will revert back to it's disorganized state (the hydrogen bonds begin to break between the crystal like structures; liquid entropy.) The key is the point where the effecting change is implemented to permanently restructure the hydrogen bonds. Scalar waves positively utilized (they are also being used destructively in weapon systems) have numerous health enhancing qualities beyond this, and hold a key to cellular regeneration, but for any of the positive qualities to be imparted they need to be “locked in” to the formulation. Researchers use sound, both within and beyond our human auditory range, sonics and ultra sonic frequencies, as well as pulsating light from different parts of the spectrum depending on the formulation being created.

This is a preliminary step to restructure the hydrogen bonds and prepare the medium at that critical point in the process. (Scientists have begun to change bond angles using lasers, focused light, so the mechanism is not esoteric magic, it's a known phenomenon. Dr. Jenny Dr. Hans Jenney, through well-documented studies, demonstrated that vibration produced geometry. By creating vibration in a material that we can see, the pattern of the vibration becomes visible in the medium. When we return to the original vibration, the original pattern reappears. Through experiments conducted in a variety of substances, Dr. Jenney produced an amazing variety of geometric patterns, ranging from very complex to very simple, in such materials as water, oil, and graphite and sulfur powder. Each pattern was simply the visible form of an invisible force. These geometric patterns have a three dimensional structure. Sound actually has a recognized form to it. This form is a geometric design. This design has depth, length and height to its structure. This is why the Tibetans refer to geometry as “frozen sound”. The mandalas that ancient cultures drew are two dimensional patterns that represent three dimensional sound. Cymatics—The Science of the Future?

Is there a connection between sound, vibrations and physical reality? Do sound and vibrations have the potential to create? Below, the inventor will review what various researchers in this field, which has been given the name of Cymatics, have concluded.

[image]

In 1787, the jurist, musician and physicist Ernst Chladni published Entdeckungen üiber die Theorie des Klangesor Discoveries Concerning the Theory of Music. In this and other pioneering works, Chladni, who was born in 1756, the same year as Mozart, and died in 1829, the same year as Beethoven, laid the foundations for that discipline within physics that came to be called acoustics, the science of sound. Among Chladni's successes was finding a way to make visible what sound waves generate. With the help of a violin bow which he drew perpendicularly across the edge of flat plates covered with sand, he produced those patterns and shapes which today go by the term Chladni figures. (se left) What was the significance of this discovery? Chladni demonstrated once and for all that sound actually does affect physical matter and that it has the quality of creating geometric patterns.

[image]

What we are seeing in this illustration is primarily two things: areas that are and are not vibrating. When a flat plate of an elastic material is vibrated, the plate oscillates not only as a whole but also as parts. The boundaries between these vibrating parts, which are specific for every particular case, are called node lines and do not vibrate. The other parts are oscillating constantly. If sand is then put on this vibrating plate, the sand (black in the illustration) collects on the non-vibrating node lines. The oscillating parts or areas thus become empty. According to Jenny, the converse is true for liquids; that is to say, water lies on the vibrating parts and not on the node lines.

In 1815 the American mathematician Nathaniel Bowditch began studying the patterns created by the intersection of two sine curves whose axes are perpendicular to each other, sometimes called Bowditch curves but more often Lissajous figures. (se below right) This after the French mathematician Jules-Antoine Lissajous, who, independently of Bowditch, investigated them in 1857-58. Both concluded that the condition for these designs to arise was that the frequencies, or oscillations per second, of both curves stood in simple whole-number ratios to each other, such as 1:1, 1:2, 1:3, and so on. In fact, one can produce Lissajous figures even if the frequencies are not in perfect whole-number ratios to each other. If the difference is insignificant, the phenomenon that arises is that the designs keep changing their appearance. They move. What creates the variations in the shapes of these designs is the phase differential, or the angle between the two curves. In other words, the way in which their rhythms or periods coincide. If, on the other hand, the curves have different frequencies and are out of phase with each other, intricate web-like designs arise. These Lissajous figures are all visual examples of waves that meet each other at right angles.

[image]

A number of waves crossing each other at right angles look like a woven pattern, and it is precisely that they meet at 90-degree angles that gives rise to Lissajous figures.

In 1967, the late Hans Jenny, a Swiss doctor, artist, and researcher, published the bilingual book Kymatik—Wellen und Schwingungen mit ihrer Struktur und Dynamik/Cymatisc—The Structure and Dynamics of Waves and Vibrations. In this book Jenny, like Chladni two hundred years earlier, showed what happens when one takes various materials like sand, spores, iron filings, water, and viscous substances, and places them on vibrating metal plates and membranes. What then appears are shapes and motion-patterns which vary from the nearly perfectly ordered and stationary to those that are turbulently developing, organic, and constantly in motion.

Jenny made use of crystal oscillators and an invention of his own by the name of the tonoscope to set these plates and membranes vibrating. This was a major step forward. The advantage with crystal oscillators is that one can determine exactly which frequency and amplitude/volume one wants. It was now possible to research and follow a continuous train of events in which one had the possibility of changing the frequency or the amplitude or both.

The tonoscope was constructed to make the human voice visible without any electronic apparatus as an intermediate link. This yielded the amazing possibility of being able to see the physical image of the vowel, tone or song a human being produced directly. (se below) Not only could you hear a melody—you could see it, too!

Jenny called this new area of research cymatics, which comes from the Greek kyma, wave. Cymatics could be translated as: the study of how vibrations, in the broad sense, generate and influence patterns, shapes and moving processes.

In the first place, Jenny produced both the Chladni figures and Lissajous figures in his experiments. He discovered also that if he vibrated a plate at a specific frequency and amplitude—vibration—the shapes and motion patterns characteristic of that vibration appeared in the material on the plate. If he changed the frequency or amplitude, the development and pattern were changed as well. He found that if he increased the frequency, the complexity of the patterns increased, the number of elements became greater. If on the other hand he increased the amplitude, the motions became all the more rapid and turbulent and could even create small eruptions, where the actual material was thrown up in the air.

[image]

[image]

The shapes, figures and patterns of motion that appeared proved to be primarily a function of frequency, amplitude, and the inherent characteristics of the various materials. He also discovered that under certain conditions he could make the shapes change continuously, despite his having altered neither frequency nor amplitude!

[image]

When Jenny experimented with fluids of various kinds he produced wave motions, spirals, and wave-like patterns in continuous circulation. In his research with plant spores, he found an enormous variety and complexity, but even so, there was a unity in the shapes and dynamic developments that arose. With the help of iron filings, mercury, viscous liquids, plastic-like substances and gases, he investigated the three-dimensional aspects of the effect of vibration.

In his research with the tono scope, Jenny noticed that when the vowels of the ancient languages of Hebrew and Sanskrit were pronounced, the sand took the shape of the written symbols for these vowels, while our modern languages, on the other hand, did not generate the same result! How is this possible? Did the ancient Hebrews and Indians know this? Is there something to the concept of “sacred language,” which both of these are sometimes called? What qualities do these “sacred languages,” among which Tibetan, Egyptian and Chinese are often numbered, possess? Do they have the power to influence and transform physical reality, to create things through their inherent power, or, to take a concrete example, through the recitation or singing of sacred texts, to heal a person who has gone “out of tune”?

[image]

An interesting phenomenon appeared when he took a vibrating plate covered with liquid and tilted it. The liquid did not yield to gravitational influence and run off the vibrating plate but stayed on and went on constructing new shapes as though nothing had happened. If, however, the oscillation was then turned off, the liquid began to run, but if he was really fast and got the vibrations going again, he could get the liquid back in place on the plate. According to Jenny, this was an example of an antigravitational effect created by vibrations.

In the beginning of Cymatics, Hans Jenny says the following: “In the living as well as non-living parts of nature, the trained eye encounters wide-spread evidence of periodic systems. These systems point to a continuous transformation from the one set condition to the opposite set.” (3) Jenny is saying that we see everywhere examples of vibrations, oscillations, pulses, wave motions, pendulum motions, rhythmic courses of events, serial sequences, and their effects and actions. Throughout the book Jenny emphasises his conception that these phenomena and processes not be taken merely as subjects for mental analysis and theorizing. Only by trying to “enter into” phenomena through empirical and systematic investigation can we create mental structures capably of casting light on ultimate reality. He asks that we not “mix ourselves in with the phenomenon” but rather pay attention to it and allow it to lead us to the inherent and essential. He means that even the purest philosophical theory is nevertheless incapable of grasping the true existence and reality of it in full measure.

[image]

What Hans Jenny pointed out is the resemblance between the shapes and patterns we see around us in physical reality and the shapes and patterns he generated in his investgations. Jenny was convinced that biological evolution was a result of vibrations, and that their nature determined the ultimate outcome. He speculated that every cell had its own frequency and that a number of cells with the same frequency created a new frequency, which was in harmony with the original, which in its turn possibly formed an organ that also created a new frequency in harmony with the two preceding ones. Jenny was saying that the key to understanding how we can heal the body with the help of tones lies in our understanding of how different frequencies influence genes, cells and various structures in the body. He also suggested that through the study of the human ear and larynx we would be able to come to a deeper understanding of the ultimate cause of vibrations.

In the closing chapter of the book Cymatics, Jenny sums up these phenomena in a three-part unity. The fundamental and generative power is in the vibration, which, with its periodicity, sustains phenomena with its two poles. At one pole we have form, the figurative pattern. At the other is motion, the dynamic process.

[image]

These three fields—vibration and periodicity as the ground field, and form and motion as the two poles—constitute an indivisible whole, Jenny says, even though one can dominate sometimes. Does this trinity have something within science that corresponds? Yes, according to John Beaulieu, American polarity and music therapist. In his book Music and Sound in the Healing Arts, he draws a comparison between his own three-part structure, which in many respects resembles Jenny's, and the conclusions researchers working with subatomic particles have reached. “There is a similarity between cymatic pictures and quantum particles. In both cases that which appears to be a solid form is also a wave. They are both created and simultaneously organized by the principle of pulse. This is the great mystery with sound: there is no solidity. A form that appears solid is actually created by a underlying vibration.” In an attempt to explain the unity in this dualism between wave and form, physics developed the quantum field theory, in which the quantum field, or in our terminology, the vibration, is understood as the one true reality, and the particle or form, and the wave or motion, are only two polar manifestations of the one reality, vibration, says Beaulieu. Thus, the forms of snowflakes and faces of flowers may take on their shape because they are responding to some sound in nature. Likewise, it is possible that crystals, plants, and human beings may be, in some way, music that has taken on visible form.

Dr. Masaru Emoto (The Hidden Message in Water) has shown some interesting interactions not unlike Tiller's experiments in lattice formation and interactions between mind and other energy around us. According to Emoto, “My efforts to photograph ice crystals and conduct research began to move ahead. Then one day the researcher—who was as caught up in the project as I—said something completely out of the blue: ‘Let's see what happens when we expose the water to music.’

I knew that it was possible for the vibrations of music to have an effect on the water. I myself enjoy music immensely, and as a child had even had hopes of becoming a professional musician, and so I was all in favor of this off-the-wall experiment.

At first we had no idea what music we would use and under what conditions we would conduct the experiment. But after considerable trial and error, we reached the conclusion that the best method was probably the simplest—put a bottle of water on a table between two speakers and expose it to a volume at which a person might normally listen to music. We would also need to use the same water that we had used in previous experiments.

We first tried distilled water from a drugstore. The results astounded us. Beethoven's Pastoral Symphony, with its bright and clear tones, resulted in beautiful and well-formed crystals. Mozart's 40th Symphony, a graceful prayer to beauty, created crystals that were delicate and elegant. And the crystals formed by exposure to Chopin's Etude in E, Op. 10, No. 3, surprised us with their lovely detail. All the classical music that we exposed the water to resulted in well-formed crystals with distinct characteristics. In contrast, the water exposed to violent heavy-metal music resulted in fragmented and malformed crystals at best. Can words affect water, too? But our experimenting didn't stop there. We next thought about what would happen if we wrote words or phrases like ‘Thank you’ and ‘Fool’ on pieces of paper, and wrapped the paper around the bottles of water with the words facing in. It didn't seem logical for water to ‘read’ the writing, understand the meaning, and change its form accordingly. But I knew from the experiment with music that strange things could happen. We felt as if we were explorers setting out on a journey through an unmapped jungle.

The results of the experiments didn't disappoint us. Water exposed to ‘Thank you’ formed beautiful hexagonal crystals, but water exposed to the word ‘Fool’ produced crystals similar to the water exposed to heavy-metal music, malformed and fragmented.” This obviously raises more questions than it answers. What laws of science or lattice formation are at work here? How connected is life and what amount of soul or ‘chhi’ is in all things? Could the ancients and even more materialistic man of the present use these energies to find water or minerals?

The inventor wishes to include some information about scalar waves. “Stoney and Whittaker showed that any scalar potential can be decomposed into a set of bidirectional wave pairs, with the pairs in harmonic sequence. Each pair consists of a wave and its true time-reversed replica. So, the interference of two scalar potential beams is simply the interference of two hidden sets of multiwaves. That the waves in each beam are “hidden” is of no concern; mathematically, scalar potential interferometry is inviolate, in spite of the archaic assumptions of classical EM (When Maxwell wrote his theory, everyone knew that the vacuum was filled with a thin “material” fluid—the ether. Maxwell incorporated that as a fundamental assumption of his theory. In other words, the scalar potential Phi already consisted of “thin fluid”.).

Indeed, Whittaker's 1904 paper showed that any ordinary EM field, including EM waves, can be replaced by such scalar potential interferometry. Further, the source of interfering potentials need not be local. In other words, EM field gradients of any pattern desired can be created at a distance, by the distant interference of two scalar potential beams.”

A scalar EM potential is comprised of bidirectional EM wave pairs, where the pairs are harmonics and phase-locked together. In each coupled wave/antiwave pair, a true forward-time EM wave is coupled to a time-reversal of itself, its phase conjugate replica antiwave. The two waves are spatially in phase, but temporally they are 180 degrees out of phase. To suggest an analogy that will be clearer to many of you: We would suggest that when you balance the two hemispheres of your brain (the waves), you are creating “like onto” a scalar wave. The thoughts and feelings you have at that point are exponentially more powerful. All these descriptions are actually over simplifications because in the real world, multiple interference patterns are involved in the formation of scalar waves; a spiritual gathering for example creates these powerful scalar waves. There are numerous ways to create scalar waves, many are familiar with Tesla's work but perhaps more interesting is the use of natural scalar waves that can be created with crystal grids, crystals in geometric patterns. The angles between the crystals important for those doing their own research and more importantly the honoring of the crystals as conscious evolving life-forms.

A little more technical is the use of the noble gases “constrained” in plasma tubes. Connecting to a frequency generator, the plasma tubes create scalar waves that can be very specifically targeted with the generator. Each of the noble gases; Helium, Neon, Argon, Krypton, Xenon has their own quality. Using specific frequencies to create the scalar waves with different noble gases one can then target the powder to act on certain levels; not just of the physical body but of the subtle bodies as well.

Scalar waves are very real and can be used to heal or destroy. Bond angles can be changed. The resonance that is emitted from a specific angle creates an energetic pattern with particular properties; reference the squares, trines, etc. that are so often misunderstood.

If one sits within a square structure and feel . . . then within a harmonically constructed pyramid . . . then within a tetrahedron; you can feel the different effects created by the angles and, if you move around, your relationship to the angles within the given space. Angles are part of the alphabet of the Language of Light. This language is multidimensional and is reflected on the molecular level as well as the subtle.

All healthy humans came into this world with predominately hexagonically clustered water, as do baby rabbits and baby eagles. All life on this planet is born with bio-water predominately microclustered as hexagons. Over time this hexagonically clustered bio-water begins to break down.

A team in South Korea has discovered a whole new dimension to just about the simplest chemical reaction known; what happens when you dissolve a substance in water and then add more water.

Conventional wisdom says that the dissolved molecules simply spread further and further apart as a solution is diluted. But two chemists have found that some do the opposite: they clump together, first as clusters of molecules, then as bigger aggregates of those clusters. Far from drifting apart from their neighbors, they got closer together.

The discovery has stunned chemists, and could provide the first scientific insight into how some homeopathic remedies work. Homeopaths repeatedly dilute medications, believing that the higher the dilution, the more potent the remedy becomes.

Some dilute to “infinity” until no molecules of the remedy remain. They believe that water holds a memory, or “imprint” of the active ingredient which is more potent than the ingredient itself. But others use less dilute solutions—often diluting a remedy six-fold. The Korean findings might at last go some way to reconciling the potency of these less dilute solutions with orthodox science.

German chemist Kurt Geckeler and his colleague Shashadhar Samal stumbled on the effect while investigating fullerenes at their lab in the Kwangju Institute of Science and Technology in South Korea. They found that the football-shaped buckyball molecules kept forming untidy aggregates in solution, and Geckler asked Samal to look for ways to control how these clumps formed.

What he discovered was a phenomenon new to chemistry. “When he diluted the solution, the size of the fullerene particles increased,” says Geckeler. “It was completely counterintuitive,” he says.

Further work showed it was no fluke. To make the otherwise insoluble buckyball dissolve in water, the chemists had mixed it with a circular sugar-like molecule called a cyclodextrin. When they did the same experiments with just cyclodextrin molecules, they found they behaved the same way. So did the organic molecule sodium guanosine monophosphate, DNA and plain old sodium chloride.

Dilution typically made the molecules cluster into aggregates five to 10 times as big as those in the original solutions. The growth was not linear, and it depended on the concentration of the original.

“The history of the solution is important. The more dilute it starts, the larger the aggregates,” says Geckeler. Also, it only worked in polar solvents like water, in which one end of the molecule has a pronounced positive charge while the other end is negative.

But the finding may provide a mechanism for how some homeopathic medicines work something that has defied scientific explanation till now. Diluting a remedy may increase the size of the particles to the point when they become biologically active.

It also echoes the controversial claims of French immunologist Jacques Benveniste. In 1988, Benveniste claimed in a Nature paper that a solution that had once contained antibodies still activated human white blood cells. Benveniste claimed the solution still worked because it contained ghostly “imprints” in the water structure where the antibodies had been.

Other researchers failed to reproduce Benveniste's experiments, but homeopaths still believe he may have been onto something. Benveniste himself does not think the new findings explain his results because the solutions were not dilute enough. “This [phenomenon] cannot apply to high dilution,” he says.

Fred Pearce of University College London, who tried to repeat Benveniste's experiments, agrees. But it could offer some clues as to why other less dilute homeopathic remedies work, he says. Large clusters and aggregates might interact more easily with biological tissue.

Chemist Jan Enberts of the University of Groningen in the Netherlands is more cautious. “It's still a totally open question,” he says. “To say the phenomenon has biological significance is pure speculation.” But he has no doubt Samal and Geckeler have discovered something new. “It's surprising and worrying,” he says.

The two chemists were at pains to double-check their astonishing results. Initially they had used the scattering of a laser to reveal the size and distribution of the dissolved particles. To check, they used a scanning electron microscope to photograph films of the solutions spread over slides. This, too, showed that dissolved substances cluster together as dilution increased.

“It doesn't prove homeopathy, but it's congruent with what we think and is very encouraging,” says Peter Fisher, director of medical research at the Royal London Homeopathic Hospital.

“The whole idea of high-dilution homeopathy hangs on the idea that water has properties which are not understood,” he says. “The fact that the new effect happens with a variety of substances suggests it's the solvent that's responsible. It's in line with what many homeopaths say, that you can only make homeopathic medicines in polar solvents.”

Geckeler and Samal are now anxious that other researchers follow up their work.

In 1920, American scientists proposed the concept of hydrogen bonds in their discussion of liquids having dielectric constant values much higher than anticipated (like water). Hydrogen bonding between water molecules occurs not only in liquid water but also in ice and in water vapour. It has been estimated from the heat of fusion of ice that only a small fraction, say about 10 per cent of hydrogen bonds in ice are broken when it melts at O 2° C. Liquid water is still hydrogen bonded at 100 2° C. as indicated by its high heat of vaporization and dielectric constant. That water is highly hydrogen bonded and still a fluid and not a solid is a paradox.

The dielectric constant of water is very high; water is one of the most polar of all solvents. Consequently electrically charged molecules are easily separated in the presence of water. The heat capacity of water is also very high or in other words, a large amount of heat is needed to raise its temperature by a degree. This property gives a tremendous advantage to biological systems wherein the cells undergo moderate biological activity. Despite the fact that large amount of heat is generated by these metabolic activities the temperature of the cell-water system does not rise beyond reasonable limits.

Water has a high heat of vaporization resulting in perspiration being an effective method of cooling the body. The high heat of vaporization also prevents water sources in the tropics from getting evaporated quickly. The high conductivity of water makes nerve conduction an effective and sensitive mechanism of the body. It would appear that nature has designed the properties of water to exactly suit the needs of the living.

Water has higher melting point, boiling point, heat of vaporization, heat of fusion and surface tension than comparable hydrides such as hydrogen sulphide or ammonia or, for that matter, most liquids. All these properties indicate that in liquid water, the forces of attraction between the molecules is high or, in other words, internal cohesion is relatively high. These properties are due to a unique kind of a bond known as the hydrogen bond. This bond is a weak electrostatic force of attraction between the proton of a hydrogen atom and the electron cloud of a neighboring electro-negative atom. In other words, hydrogen atom with its electron locked in a chemical bond with an electro negative atom has an exposed positively charged proton, which in turn electrostatically interacts with the electron cloud of the neighbor.

The importance of water is further enhanced as it is expected to be the source of energy in the future. Hydrogen, which is expected to be an energy carrier, can be obtained from water using any primary energy source like solar energy, electricity or thermal energy or a hybrid system consisting of more than one of these primary energy sources. Hydrogen, a secondary energy carrier, can be converted to produce water and this water appears to be an endless source of energy.

The importance of water to life can be gauged from the fact that cellular life, evolved in water billions of years ago. The cells are filled with water and are bathed in watery tissue fluids. Water is the medium in which the cell's biochemical reactions take place. The cell surface, a lipid-protein-lipid is stabilized by hydrophobic interaction.

Moreover, the proteins and membranes in cells are hydrogen bonded through water, which protects them from denaturation and conformational transitions when there are thermal fluctuations. Transportation of ions from cell to cell is possible only because of the presence of water.

Water is extremely important for structural stabilization of proteins, lipids, membranes and cells. Any attempt to remove water from these structures will lead to many changes in their physical properties and structural stability. This then raises the question whether biological systems can survive without water or precisely, can there be any ‘life without water’.

Tremendous amount of research has gone into in the understanding of water and its structure. Despite all this, it is surprising that the microscopic forces that define the structure of water is not fully known. Even now several publications aim at better understanding of the structure of water. For instance, in a report in Nature (December 1993), scientists have studied the details of the inter-atomic structure of water at super critical temperature using neutron diffraction. Recently they have shown that a minimum of six molecules of water are required to form a three-dimensional cage-like structure. Groups up to five water molecules and fewer form one-molecule-thick, planar structures (New Scientist, February 1997).

Imagine a non-polar group in a cluster of water molecules. Since there is no interaction between water, a polar solvent and a non-polar group, water tends to surround this non-polar group resulting in higher ordering of water molecules.

Consequently the entropy of the system lowers with increase in Free Energy. When yet another non-polar group is brought closer to the first non-polar group the energy of the surrounding water forces the two groups to be close to one another.

One of the most important components of life as we know it is the hydrogen bond. It occurs in many biological structures, such as DNA. But perhaps the simplest system in which to learn about the hydrogen bond is water. In liquid water and solid ice, the hydrogen bond is simply the chemical bond that exists between H2O molecules and keeps them together. Although relatively feeble, hydrogen bonds are so plentiful in water that they play a large role in determining their properties.

Arising from the nature of the hydrogen bond the unusual properties of H2O have made conditions favorable for life on Earth. For instance, it takes a relatively large amount of heat to raise water temperature one degree. This enables the world's oceans to store enormous amounts of heat, producing a moderating effect on the world's climate, and it makes it more difficult for marine organisms to destabilize the temperature of the ocean environment even as their metabolic processes produce copious amounts of waste heat.

In addition, liquid water expands when cooled below 4 degrees Celsius. This is unlike most liquids, which expand only when heated. This explains how ice can sculpt geological features over eons through the process of erosion. It also makes ice less dense than liquid water, and enables ice to float on top of the liquid. This property allows ponds to freeze on the top and has offered a hospitable underwater location for many life forms to develop on this planet.

In water, there are two types of bonds. Hydrogen bonds are the bonds between water molecules, while the much stronger “sigma” bonds are the bonds within a single water molecule. Sigma bonds are strongly “covalent,” meaning that a pair of electrons is shared between atoms. Covalent bonds can only be described by quantum mechanics, the modern theory of matter and energy at the atomic scale. In a covalent bond, each electron does not really belong to a single atom-it belongs to both simultaneously, and helps to fill each atom's outer “valence” shell, a situation, which makes the bond very stable.

On the other hand, the much weaker hydrogen bonds that exist between H2O molecules are principally the electrical attractions between a positively charged hydrogen atom—which readily gives up its electron in water—and a negatively charged oxygen atom—which receives these electrons—in a neighboring molecule. These “electrostatic interactions” can be explained perfectly by classical, pre-20th century physics—specifically by Coulomb's law, named after the French engineer Charles Coulomb, who formulated the law in the 18th century to describe the attraction and repulsion between charged particles separated from each other by a distance.

After the advent of quantum mechanics in the early 20th century, it became clear that this simple picture of the hydrogen bond had to change. In the 1930s, the famous chemist Linus Pauling first suggested that the hydrogen bonds between water molecules would also be affected by the sigma bonds within the water molecules. In a sense, the hydrogen bonds would even partially assume the identity of these bonds.

How do hydrogen bonds obtain their double identity? The answer lies with the electrons in the hydrogen bonds. Electrons, like all other objects in nature, naturally seek their lowest-energy state. And whenever anobject reduces its momentum, it must spread out in space, according to a quantummechanical phenomenon known as the Heisenberg Uncertainty Principle. In fact, this “delocalization” effect occurs for electrons in many other situations, not just in hydrogen bonds. Delocalization plays an important role in determining the behavior of superconductors and other electrically conducting materials at sufficiently low temperatures.

Implicit in this quantum mechanical picture is that all objects—even the most solid particles—can act like rippling waves under the right circumstances. These circumstances exist in the water molecule, and the electron waves on the sigma and hydrogen bonding sites overlap somewhat. Therefore, these electrons become somewhat indistinguishable and the hydrogen bonds cannot be completely be described as electrostatic bonds. Instead, they take on some of the properties of the highly covalent sigma bonds—and vice versa. However, the extent to which hydrogen bonds were being affected by the sigma bonds has remained controversial until recently.

Working at the European Synchrotron Radiation Facility (ESRF) in Grenoble, France, a US-France-Canada research team designed an experiment that would settle this issue once and for all. Taking advantage of the ultra-intense x-rays that could be produced at the facility, they studied the “Compton scattering” that occurred when the x-ray photons ricocheted from ordinary ice.

Measuring the differences in x-rays' intensity when scattered from various angles in a single crystal of ice, and plotting this scattering “anisotropy” against the amount of momentum in the electrons scattered in the ice, the team recorded wavelike interference fringes corresponding to interference between the electrons on neighboring sigma and hydrogen bonding sites.

Taking the differences in scattering intensity into account, and plotting the intensity of the scattered x rays against their momentum, the team recorded wavelike fringes corresponding to interference between the electrons on neighboring sigma and hydrogen bonding sites. The presence of these fringes demonstrates that electrons in the hydrogen bond are quantum mechanically shared-covalent-just as Linus Pauling had predicted. The experiment was so sensitive that the team even saw contributions from more distant bonding sites.

Many scientists dismissed the possibility that hydrogen bonds in water had significant covalent properties. This fact can no longer be dismissed. The experiment provides highly coveted details on water's microscopic properties. Not only will it allow researchers in many areas to improve theories of water and the many biological structures such as DNA which possess hydrogen bonds. Improved information on the h-bond may also help us to assume better control of our material world. For example, it may allow nanotechnologists to design more advanced self-assembling materials, many of which rely heavily on hydrogen bonds to put themselves together properly. Meanwhile, researchers are hoping to apply their experimental technique to study numerous hydrogen-bond-free materials, such as superconductors and switchable metal-insulator devices, in which one can control the amount of quantum overlap between electrons in neighboring atomic sites.

Like-charged biomolecules can attract each other, in a biophysics phenomenon that has fascinating analogies to superconductivity. Newly obtained insights into biomolecular “like-charge attraction” may eventually help lead to improved treatments for cystic fibrosis, more efficient gene therapy and better water purification. The like-charge phenomenon occurs in “polyelectrolytes,” molecules such as DNA and many proteins that possess an electric charge in a water solution. Under the right conditions, polyelectrolytes of the same type, such as groups of DNA molecules, can attract each other even though each molecule has the same sign of electric charge. Since the late 1960s, researchers have known that like-charge attraction occurs through the actions of “counterions,” small ions also present in the water solution but having the opposite sign of charge as the biomolecule of interest. But they have not been able to pin down the exact details of the phenomenon. To uncover the mechanism behind like-charge attraction, a group of experimenters (led by Gerard Wong, at the University of Illinois at Urbana-Champaign) found that counterions organize themselves into columns of charge between the protein rods. Along these ‘columns’, the ions are not uniformly distributed, but rather are organized into frozen “charge density waves.”

Remarkably, these tiny ions cause the comparatively huge actin molecule to twist, by 4 degrees for every building block (monomer) of the protein. This process has parallels to superconductivity, in which lattice distortions (phonons) mediate interactions between pairs of like-charged particles (electrons). In the case of actin, charge particles (ions) mediate attractions between like-charged distorted lattices (twisted actin helix). (Angelini et al., Proceedings of the National Academy of Sciences, Jul. 22, 2003). In the next experiment, they investigated what kinds of counterions are needed to broker biomolecular attraction. Researchers have long known that doubly charged (divalent) ions can bring together actin proteins and viruses, and triply charged (trivalent) ions can make DNA molecules stick to one another, but monovalent ions cannot generate these effects. Studying different-sized versions of the molecule diamine (a dumbbell-shaped molecule with charged NH3 groups as the “ends” and one or more carbon atoms along the handle) to simulate the transition between divalent and monovalent ion behavior, they found that the most effective diamine counterions for causing rodlike M13 viruses to attract were the smallest ones. These small diamine molecules had a size roughly equal to the “Gouy-Chapman” length, the distance over which its electric charge exerts a significant influence. Nestled on the Ml 3 virus surface, one end of the short diamine molecule neutralizes the virus's negative charge, while the other end supplies a positive charge that can then draw another M13 virus towards it (Butler et al., Physical Review Letters, 11 Jul. 2003; also see Phys. Rev. Focus, 21 Jul. 2003).

Below, the inventor reports experimental work carried out in Moscow at the Institute of Control Sciences, Wave Genetics Inc. and theoretical work from several sources. This work changes the notion about the genetic code essentially. It asserts:

1) That the evolution of biosystems has created genetic “texts”, similar to natural context dependent texts in human languages, shaping the text of these speech-like patterns.

2) That the chromosome apparatus acts simultaneously both as a source and receiver of these genetic texts, respectively decoding and encoding them, and

3) That the chromosome continuum of multicellular organisms is analogous to a static-dynamical multiplex time-space holographic grating, which comprises the space-time of an organism in a convoluted form.

That is to say, the DNA action, theory predicts and which experiment confirms,

i) is that of a “gene-sign” laser and its solitonic electro-acoustic fields, such that the gene-biocomputer “reads and understands” these texts in a manner similar to human thinking, but at its own genomic level of “reasoning”. It asserts that natural human texts (irrespectively of the language used), and genetic “texts” have similar mathematical-linguistic and entropic-statistic characteristics, where these concern the fractality of the distribution of the character frequency density in the natural and genetic texts, and where in case of genetic “texts”, the characters are identified with the nucleotides, and ii) that DNA molecules, conceived as a gene-sign continuum of any biosystem, are able to form holographic pre-images of biostructures and of the organism as a whole as a registry of dynamical “wave copies” or “matrixes”, succeeding each other. This continuum is the measuring, calibrating field for constructing its biosystem.

Keywords: DNA, wave-biocomputer, genetic code, human language, quantum holography.

The principle problem of the creation of the genetic code, as seen in all the approaches [Gariaev 1994; Fatmi et al. 1990; Perez 1991: Clement et al. 1993; Marcer, Schempp 1996; Patel, 2000] was to explain the mechanism by means of which a third nucleotide in an encoding triplet, is selected. To understand, what kind of mechanism resolves this typically linguistic problem of removing homonym indefiniteness, it is necessary firstly to postulate a mechanism for the context-wave orientations of ribosomes in order to resolve the problem of a precise selection of amino acid during protein synthesis [Maslow, Gariaev 1994]. This requires that some general informational intermediator function with a very small capacity, within the process of convolution versus development of sign regulative patterns of the genome-biocomputer endogenous physical fields. It lead to the conceptualization of the genome's associative-holographic memory and its quantum nonlocality.

These assumptions produce a chromosome apparatus and fast wave genetic information channels connecting the chromosomes of the separate cells of an organism into a holistic continuum, working as the biocomputer, where one of the field types produced by the chromosomes, are their radiations. This postulated capability of such “laser radiations” from chromosomes and DNA, as will be shown, has already been demonstrated experimentally in Moscow, by the Gariaev Group. Thus it seems the accepted notions about the genetic code must change fundamentally, and in doing so it will be not only be possible to create and understand DNA as a wave biocomputer, but to gain from nature a more fundamental understanding of what information [Marcer in press] really is! For the Gariaev Group's experiments in Moscow and Toronto say that the current understanding of genomic information i.e. the genetic code, is only half the story [Marcer this volume].

These wave approaches all require that the fundamental property of the chromosome apparatus is the nonlocality of the genetic information. In particular, quantum nonlocality/teleportation within the framework of concepts introduced by Einstein, Podolsky and Rosen (EPR) [Sudbery 1997; Bouwmeester et al.1997].

This quantum nonlocality has now, by the experimental work of the Gariaev Group, been directly related

(i) to laser radiations from chromosomes,

(ii) to the ability of the chromosome to gyrate the polarization plane of its own radiated and occluded photons and

(iii) to the suspected ability of chromosomes, to transform their own genetic-sign laser radiations into broadband genetic-sign radio waves. In the latter case, the polarizations of chromosome laser photons are connected nonlocally and coherently to polarizations of radio waves. Partially, this was proved during experiments in vitro, when the DNA preparations interplaying with a laser beam (=632.8 nm), organized in a certain way, polarize and convert the beam simultaneously into a radio-frequency range. In these experiments, another extremely relevant phenomenon was detected: photons, modulated within their polarization by molecules of the DNA preparation.

These are found to be localized (or “recorded”) in the form of a system of laser mirrors' heterogeneities. Further, this signal can “be read out” without any essential loss of the information (as theory predicts [Gariaev 1994; Marcer, Schempp 1996]), in the form of isomorphously (in relation to photons) polarized radio waves. Both the theoretical and experimental research on the convoluted condition of localized photons therefore testifies in favor of these propositions.

These independent research approaches also lead to the postulate, that the liquid crystal phases of the chromosome apparatus (the laser mirror analogues) can be considered as a fractal environment to store the localized photons, so as to create a coherent continuum of quantum-nonlocally distributed polarized radio wave genomic information. To a certain extent, this corresponds with the idea of the genome's quantum-nonlocality, postulated earlier, or to be precise, with a variation of it.

This variation says that the genetic wave information from DNA, recorded within the polarizations of connected photons, being quantum-nonlocal, constitutes a broadband radio wave spectrum correlated—by means of polarizations—with the photons. Here, the main information channel, at least in regard to DNA, is the parameter of polarization, which is nonlocal and is the same for both photons and the radio waves. A characteristic feature is, that the Fourier-image of the radio spectra is dynamic, depending essentially on the type of matter interrogated. It can therefore be asserted, that this phenomenon concerns a new type of a computer (and biocomputer) memory, and also a new type of EPR spectroscopy, namely one featuring photon-laser-radiowave polarization spectroscopy.

The fundamental notion is, that the photon-laser-radiowave features of different objects (i.e. the Fourier-spectra of the radiowaves of crystals, water, metals, DNA, etc) are stored for definite but varying times by means of laser mirrors, such that the “mirror spectra” concern chaotic attractors with a complex dynamic fractal dynamics, recurring in time. The Gariaev Group experiments are therefore not only unique in themselves, they are a first example, that a novel static storage/recording environment (laser mirrors) exists, capable of directly recording the space-time atomic/molecular rotary dynamical behavior of objects. Further the phenomena, detected by these experiments described in part two, establish the existence of an essentially new type of radio signal, where the information is encoded by polarizations of electromagnetic vectors. This will be the basis of a new type of video recording, and will create a new form of cinema as well.

Further experimental research has revealed the high biological (genetic) activity of such radio waves, when generated under the right conditions by DNA.

For example, by means of such artificially produced DNA radiations, the super fast growth of potatoes (up to 1 cm per day) has been achieved, together with dramatic changes of morphogenesis resulting in the formation of small tubers not on rootstocks but on stalks. The same radiations also turned out to be able to cause a statistically authentic “resuscitation” of dead seeds of the plant Arabidopsis thaliana, which were taken from the Chernobyl area in 1987. By contrast, the monitoring of irradiations by polarized radio waves, which do not carry information from the DNA, is observed to be biologically inactive. In this sequence of experiments, additional evidence was also obtained in favor of the possibility of the existence of the genetic information in form of the polarization of a radio wave physical field.

This supports the supposition that the main information channel in these experiments is the biosign modulations of polarizations mediated by some version of quantum nonlocality. A well known fact can therefore be seen in new light, namely, that the information biomacromolecules—DNA, RNA and proteins—have an outspoken capacity to optical rotatory dispersion of visible light and of circular dichroism. Similarly, the low molecular components of biosystems, such as saccharides, nucleotides, amino acids, porphyrins and other biosubstances have the same capacity; a capacity, which until now made little biological sense. Now, however, it supports, the contention that this newly detected phenomenon of quantized optical activity can be considered as the means by which the organism obtains unlimited information on its own metabolism. That is, such information is read by endogenous laser radiations of chromosomes, which, in their turn, produce the regulative (“semantic”) radio emission of the genome biocomputer. Furthermore, the apparent inconsistency between the wavelengths of such radiations and the sizes of organisms, cells and subcell structures is abrogated, since the semantic resonances in the biosystems' space are realized not at the wavelength level, but at the level of frequencies and angles of twist of the polarization modes. This mechanism is the basis for the artificial laser-radio-wave vitro-in vivo scanning of the organism and its components.

However, chromosome quantum nonlocality as a phenomenon of the genetic information is seen as particularly important in multicellular organisms and as applying on various levels. The 1-st level is that the organism as a whole. Here nonlocality is reflected in the capacity for regeneration, such that any part of the body recreates the whole organism, as, for example, in case of the worm Planaria. That is to say, any local limiting of the genetic information to any part of a biosystem is totally absent. The same concerns the vegetative reproduction of plants.

The 2nd level is the cellular level. Here it is possible to grow a whole organism out of a single cell. However with highly evolved animal biosystems, this will be a complex matter. The 3rd level is the cellular-nuclear level. The enucleation of nuclei from somatic and sexual cells and the subsequent introduction into them of other nuclei does not impede the development of a normal organism. Cloning of this kind has already been carried out on higher biosystems, for example, sheep.

The 4th level is the molecular level: here, the ribosome “would read” mRNA not only on the separate codons, but also on the whole and in consideration of context.

The 5th level is the chromosome-holographic: at this level, a gene has a holographic memory, which is typically distributed, associative, and nonlocal, where the holograms “are read” by electromagnetic or acoustic fields. These carry the gene-wave information out beyond the limits of the chromosome structure. Thus, at this and subsequent levels, the nonlocality takes on its dualistic material-wave nature, as may also be true for the holographic memory of the cerebral cortex [Pribram 1991; Schempp 1992; 1993; Marcer, Schempp 1997; 1998]

The 6th level concerns the genome's quantum nonlocality. Up to the 6th level, the nonlocality of bio-information is realized within the space of an organism. The 6th level has, however, a special nature; not only because it is realized at a quantum level, but also because it works both throughout the space of a biosystem and in a biosystems own time frame. The billions of an organism's cells therefore “know” about each other instantaneously, allowing the cell set is to regulate and coordinate its metabolism and its own functions. Thus, nonlocality can be postulated to be the key factor explaining the astonishing evolutionary achievement of multicellular biosystems. This factor says that bioinformatic events, can be instantaneously coordinated, taking place “here and there simultaneously”, and that in such situations the concept of “cause and effect” loses any sense.

The intercellular diffusion of signal substances and of the nervous processes is far too inertial for this purpose. Even if it is conceded that intercellular transmissions take place electro-magnetically at light speeds, this would still be insufficient to explain how highly evolved, highly complex biosystems work in real time [Gariaev 1994; Ho 1993]. The apparatus of quantum nonlocality and holography is in the inventor's view, indispensable to a proper explanation of such real time working. The 6th level therefore says, the genes can act as quantum objects, and that, it is the phenomenon of quantum non locality/teleportation, that ensures the organism's super coherency, information super redundancy, super knowledge, cohesion and, as a totality or whole, the organism's integrity (viability).

Indeed it can be said that this new understanding of biocomputers, constitutes a further step in a development of computer technology in general. An understanding that will bring about a total change of the constituent basis of that technology, in the history of analogue > to > digital > to > now, the figurative semantic (nonlocal) wave computer or biocomputer. This biocomputer will be based on new understanding of the higher forms of the DNA memory, and the chromosome apparatus, as the recording, storaging, transducing and transmitting system for genetic information, that must be considered simultaneously both at the level of matter and at the level of physical fields.

The latter fields, having been just studied, as showed experimentally in this research, are carriers of genetic and general regulative information, operating on a continuum of genetic molecules (DNA, RNA, proteins, etc). Here, previously unknown types of memory (soliton, holographic, polarization) and also the DNA molecule, work both as biolasers and as a recording environment for these laser signals. The genetic code, considered from such a point of view, will be essentially different from today's generally accepted but incomplete model. This, the wave-biocomputer model asserts, only begins to explain the apparatus of protein biosynthesis of living organisms, providing an important interpretation for the initial stages within this new proposed composite hierarchic chain of material and field, sign, holographic, semiotic-semantic and, in the general case, of figurative encoding and deciphering chromosome functions. Here the DNA molecules, conceived as a gene-sign continuum of any biosystem, are able to form pre-images of biostructures and of the organism as a whole as a registry of dynamical “wave copies” or “matrixes”, succeeding each other. This continuum is the measuring, calibrating field for constructing any biosystem.

Adleman [1994], for example, has used the mechanism for fast and precise mutual recognition between the DNA anti-parallels half-chains to solve the “the traveling salesman's problem”. However in the wave model of biosystems, this is only one aspect of the self-organization taking place. For here, as the experimental evidence now confirms, the mutual recognition of one DNA anti parallel half chain (+) by the other (−) concerns special super persistent/resonant acoustic-electromagnetic waves or solitons. Such DNA solitons have two connected types of memory. The first is typical of the phenomenon discovered by Fermi-Pasta-Ulam (FPU) [Fermi, 1972]. It concerns the capability of non-linear systems to remember initial modes of energization and to periodically repeat them [Dubois 1992].

The DNA liquid crystals within the chromosome structure form such a non-linear system. The second is that of the DNA-continuum in an organism. Such memory is an aspect of the genome's nonlocality. It is quasi-holographic/fractal, and relates, as is the case for any hologram or fractal, to the fundamental property of biosystems i.e. to their ability to restore the whole out of a part. This property is well known (grafting of plants, regeneration of a lizard's tail, regeneration of a whole organism from the oocyte). And a higher form of such a biological memory would be a holographic (associative) memory of the brain cortex, i.e. of its neural network [Pribram 1991; Schempp 1992; Marcer Schempp 1997, 1998; Sutherland 1999]. Such wave sign encoding/decoding therefore, like DNA's ability to resolve “the travelling salesman's problem”, is, it can be hypothesized, an integral part of DNA's computational biofunctionality. Indeed DNA solitary waves (solitons), and in particular, the nucleotide waves of oscillatory rotation, “read” the genome's sign patterns, so that such sign vibratory dynamics may be considered as one of many genomic non-linear dynamic semiotic processes. The expression “DNA's texts”, borrowed earlier as a metaphor from the linguists, is it turns out therefore related directly to actual human speech. For as mathematical-linguistic research into DNA and human speech textual patterns, shows [Maslow, Gariaev 1994] the key parameter of both such patterns is fractality. It can therefore be hypothesized that the grammar of genetic texts is a special case of the general grammar of all human languages.

Returning however to DNA computation based on matter-wave sign functions with a view to realizing its wave coding capabilities, as distinct from those used by Adleman, which might be termed its matter capabilities. Such true wave control capabilities of the DNA or chromosomes are, the inventor hypothesizes, those conditions that apply inside the living cell, i.e. in an aqueous solution but which correspond to a liquid-crystal condition as well. For under such conditions, in the unique circumstances of cell division, the living cell has the ability to replicate itself, and has the property of what in relation to a self replicating automaton, von Neumann [1966] called “universal computer construction” so that we may say that the living cell is such a computer based on DNA [Marcer Schempp 1997a]. And while the artificial cloning of a single cell is not yet feasible, what some have been able to do, is to record the DNA-wave information appropriate to these wave sign conditions of the DNA in a cell on laser mirrors, and to use, for example, the recorded DNA-wave information from living seeds in the form of radio waves to resuscitate the corresponding “dead” seeds damaged by radioactivity.

The next step forward is therefore to bring into general use, such wave information and memory as now newly identified in relation to DNA and gene structure. Such applications could be on the basis of, for example,

i) The FPU-recurrence phenomenon, and/or,

ii) The ability to record holograms, as well as,

iii) The recording the polarization-wave DNA's information onto localized photons.

Regarding volume and speed, such memory could exceed many times over the now available magnetic and optical disks, as well as current classical holographic systems. But in particular, such applications may employ the principles of quantum nonlocality. For DNA and the genome have now been identified as active “laser-like” environments, where, as experimentally shown, chromosome preparations may act as a memory and as “lasers”, with the abilities i), ii) and iii) above. And finally there are the quasi-speech features of the DNA, as these concern both natural gene texts, and artificial (synthesized) sign sequences of polynucleotides, which emulate natural quasi-speech gene programs. However, the inventor believes this maybe a rather dangerous path, where a regulatory system of prohibitions on artificial wave genes is indispensable.

The reason is that such an approach to DNA-wave biocomputation means entering new semiotic areas of the human genome and the biosphere in general; areas, which are used by the Nature to create humankind. This thought follows from the theoretical studies on a collective symmetry of the genetic code as carried out by the Eigen's laboratory [Scherbak, 1988] at the Max Planck Institute in Germany. This research shows, that the key part of the information, already recorded and still being recorded as quasi-speech in the chromosomes of all organisms on our planet, may concern semantic exobiological influences, since in regard to DNA-wave biocomputation, DNA acts as a kind of aerial open to the reception of not only the internal influences and changes within the organism but to those outside it as well. Indeed the inventor regards this as a primary finding, which in view of quantum nonlocality of organisms extends not only to the organism's local environment, but also beyond it to the extent of the entire universe.

With reference to what the inventor have said already, it is possible to offer the following perspectives on the sign manipulations with gene structures.

1. Creation of artificial memory on genetic molecules, which will indeed possess both fantastic volume and speed.

2. Creation of biocomputers, based on these totally new principles of DNA-wave biocomputation, which use quantum teleportation [Sudbury 1997] and can be compared to the human brain regarding methods of data processing and functional capabilities.

3. The implementation of a remote monitoring of key information processes inside biosystems by means of such artificial biocomputers, resulting in treatments for cancer, AIDS, genetic deformities, control over socio-genetic processes and eventually prolongation of the human life time.

4. Active protection against destructive wave effects, thanks to wave-information channel detectors.

5. Establishing exobiological contacts.

2. What Experiment Confirms, Part Two, the Experiments

Some of the experiments and computer simulations carried out in Moscow are now described. These descriptions concern the specific apparatus used and results obtained, together with computer simulations carried out to validate specific aspects of the developing understanding. The principal elements are a laser, the light of which is directed through a lens system and a DNA sandwich sample. The workings of the experiment which employs a dynamic light scattering system of the type Malvern. This shows the scattering by the DNA sample of the laser light, which is then guided through another lens system into the type Malvern analysing device, which counts the photons registered in different serial channels. The results of two experiments are shown at end of paper: the first entitled “Background—Empty Space”, done without a DNA sample, and the second, with it in place, entitled “Physical DNA in SSC Solution”.

The latter has the typical form of a periodically reoccurring pattern, which is of the same functional type as found in an autocorrelation. Such regularly occurring periodic patterns have an interpretation in terms of the phenomenon of so-called Fermi-Pasta-Ulam recurrence, which concerns solitonic waves. That is to say, this interpretation says that roughly speaking, the DNA, considered as a liquid-crystal gel-like state, acts on the incoming light in the manner of a solitonic Fermi-Pasta-Ulam lattice, as illustrated here:

The leading question, if this is the case, is what could such action achieve? The starting idea was that it must be concerned with the reading of the genetic texts encoded in the DNA, where however this language metaphor is now applied directly to these texts. That is to say, rather than the usual analogy taking such texts as a digital computer language or symbolic instruction code, such texts are considered instead as having the semantic and generative grammatical features of a spoken or written context dependent human language. That is, the inventor suggests that the DNA acting in the same way as the human would, when presented with a text from a good book on a fascinating theme, which, as it is read, invokes actual 3 dimensional pictures/images in the mind's eye.

The reason for this choice concerned the problem in DNA coding raised by the question of synonymy and homonymy as it applies to the third element/codon of the codon triplets. For while, see figure below, synonymy even seems to provide a kind of redundancy, homonymy constitutes a serious difficulty under the often proposed postulate that only the first two elements of the DNA codon triplet (standing for a particular protein—the picture in the mind's eye, so to speak) are the significant ones. That is to say, how does the reading ribosome know which protein has to be generated, if the third nucleotide in codon's triplet does not of itself provide the answer with total certainty? The proposed answer was, that this ambiguity might be resolved by some kind of context dependent reading similar to that inherent in human speech and language understanding.

Figure: Synonymy versus Homonymy:

Satisfyingly, this need to explain how such context-dependent reading might be implemented in the DNA reduplication/reading process, as will be shown, led back to the experimental evidence as presented above, for it supports the postulate that such context dependent reading of the DNA is indeed best understood in the framework of a biosolitonic process model.

A soliton is an ultra stable wave train often with a seemly simple closed shape, which can arise in the context of non-linear wave oscillations. It actually consists of a rather complexly interrelated assembly of sub wave structures, which keep the whole solitonic process in a stationary state over a comparatively long time. In the literature, a soliton is often described as an entity, which is neither a particle nor a wave in much the same way as is a quantum, for it, too has wave/particle duality. It can also be a means to carry information. Solitonic processing in DNA, would therefore, it was hypothesized, relate, in one of its aspects, the reading of the codons, to quantum computing [Patel 2000], and this could therefore concern the soliton viewed as the travelling “window”, that opens in the double helix structure as the reading takes place, as is illustrated below:

It was therefore decided to model this reading process as a complex mechanical oscillator [Gariaev 1994], capable of producing solitonic wave transmissions, which takes the form of a system of rotary pendulums, like those in a certain type of pendulum clock, as illustrated, to see if the computer simulations could shed more light on just what might be happening in the DNA. In the basic model, each of the oscillatory movements of each element of the linked chain of oscillators depends heavily on the motion of its neighbours, and on the differences in the specific weights of the elements. Imagine now that the DNA forms such a kind of pendulum, whilst the intertwined helices/chains are opened at one particular section to provide the traveling window, as in the previous figure. That is to say, the model to be simulated is a chain of non-linear oscillators, the four types of which can be identified with the Adenine (A), Cytosine (C), Guanine (G), and Thymine (T) or Uracil (C) components DNA, all having different spatial structures and masses, and where there is a travelling window opened in the double helix. Such a model allows a rather complex pattern of oscillation in the DNA chain of elements, depending on the actual layout of the elements as specified by the actual genetic code sequence involved. The window as it travels, is therefore highly context dependent.

Thus subject to the assumption that DNA is a certain kind of liquid crystal structure with dynamic properties, where the interrelated solitonic activities are linked, as may be supposed, together to form a highly coherent wave structure, then:

i) The masses of the nucleotides and other parameters show that these oscillatory activities should be located somewhere together in the “acoustic” wave domain, and ii) That, as a liquid crystal, the DNA could influence the polarization of the weak light emission known to exist in cells, the so called “biophotons”. This kind of emitted light in cells was first discovered by the Russian investigator Alexander Gurwitsch [1923], who called it the “mitogenic radiation”. Today it is known from the work of Fritz Albert Popp [Popp, 2000], that such biophotonic or mitogenic light, while being ultraweak, is however on the other hand, highly coherent, so that it has an inherent laser-like light quality.

The experimental setting and the resulting simulations therefore say that:

iii) The experimental laser beam is simply a substitute for the endogenous intracellular coherent light emitted by the DNA molecule itself, and that iv) The superimposed coherent waves of different types in the cells are interacting to form diffraction patterns, firstly in the “acoustic” domain, and secondly in the electromagnetic domain. Furthermore such diffraction patterns are by definition (and as is known for example from magnetic resonance imaging (MRI) [Binz, Schempp 2000a,b] a kind of quantum hologram. Thus, it seems that our original picture is confirmed and that the considered interaction between solitonic oscillations in the liquid crystal structure of DNA, and the polarization vector of the ultraweak biophotonic highly coherent light, could indeed be hypothetically understood as a mechanism of translation between holograms in the “acoustic” frequency domain, which concerns rather short range effects and those in the electromagnetic domain and vice versa.

The basis of such a hypothetical mechanism as a translation process, between acoustic and optical holograms, can be easily illustrated in the laboratory, where, as shown below, there is a fish illuminated in water by means of the acoustic radiation, in such a way that on the surface of the water an interference pattern or hologram forms, such that when this interference pattern is illuminated from above in the right way, by light of a high laser quality, a virtual visual image of the fish appears above the water. It shows that the hologram in question acts as a holographic transducer between the acoustic and electromagnetic domains.

Laboratory illustration of a holographic transducer between the acoustic and electromagnetic domains. This illustrated transduction when described in terms of the formalization of Huygens' principle of secondary sources [Jessel 1954], has been used as the basis of a new topological computing principle [Fatmi, Resconi 1988] which defines entire classes of non-commutative control structures, Fatmi et al [1990]. It was applied to DNA. and more recently to the brain [Clement et al. 1999].

3. Another Theoretical but Experimentally Validated Perspective—Quantum Holography Sections 1 and 2 are in excellent agreement with the independently researched model of DNA produced by Marcer and Schempp [1996]. This explains the workings of the DNA-wave biocomputer in terms of a quantum mechanical theory called quantum holography.

[Schempp 1992] used by Schempp [1998] and Binz and Schempp [2000a,b; 1999] to correctly predict the workings of MRI. These two DNA-wave biocomputer models are also, as cited, in good agreement with qubit model explanation of DNA more recently published by Patel [2000], and earlier independent researched models by Clement et al [1993] and Perez [1991].

The quantum holographic DNA-wave biocomputer model describes the morphology and dynamics of DNA, as a self-calibrating antenna working by phase conjugate adaptive resonance capable of both receiving and transmitting quantum holographic information stored in the form of diffraction patterns (which in MRI can be shown to be quantum holograms). The model describes how during the development of the embryo of the DNA's organism, these holographic patterns carry the essential holographic information necessary for that development. This would explain the almost miraculous way the multiplying assembly of individual cells is coordinated across the entire organism throughout every stage of its development—in complete agreement with the explanation arrived at in Moscow by Gariaev and his co-workers.

The quantum holographic theory requires that the DNA consists of two antiparallel (phase conjugate) helices, between which (in conformity with DNA's known structure, ie the planes on which the base pairing takes place) the theory says, are located hologram planes/holographic gratings, where the necessary 3 spatial dimensional holographic image data of the organism is stored in agreement with the Gariaev group's hypothesis. It says, as described in relation to laser illumination of a DNA sample, that such illumination can be expected to turn the DNA into a series of active adaptive phase conjugate mirrors (see figure below)/holographic transducers (see figure of laboratory illustration earlier), from which would resonantly emerge a beam of radiation, on which is carried the holographic information as encoded in the DNA. As indeed is the case in the Gariaev group experiments already described. These experiments thus confirm the quantum holographic prediction that DNA functions an antenna capable of both encoding and decoding holographic information. This functionality is also in good agreement with the findings of Schempp [1986] that quantum holography is capable of modelling antennae such as synthetic aperture radars, and that this mathematical description of radar can be applied [Marcer and Schempp 1997] to a model, working by quantum holography, of the neuron.

This model is in good accord with the biological neuron's information processing morphology and signal dynamics. As indeed are the quantum holographic models of the brain as a conscious system, and of the prokaryote cell [Marcer, Schempp 1996, 1997a]. It is a viewpoint originally voiced by de Broglie, who presciently pictured the electron as being guided by its own pilot wave or radar! These examples including MRI all demonstrate that quantum holography does indeed incorporate signal theory into quantum physics and it can be hypothesized biocomputation.

Phase conjugate mechanism or mirror in the laboratory. Action of an active adaptive phase conjugate mirror.

Furthermore, quantum holography predicts that the planes, in which the base pairing takes place, constitute a “paged” associative holographic memory and filter bank (carrying holograms which can be written and read) and which has no cross talk between the pages. The orthogonality of the holograms encoded on these pages, arises as the result of the sharp frequency adaptive coupling conditions (1), which specify very narrow spectral windows, i.e. the “pages”.
<Hv(a,b; x,y)|Hv(c,d; x,y)>=0 when frequency v is not equal v′
<Hv(a,b; x,y)|Hv(c,d; x,y)>=<aOb|cOd> when v=v′ (1)

for non-degenerate four wavelet mixing where a,b,c,d are the corresponding wave functions of the mixing; Hv(a,b; x,y) is the holographic transform which in quantum holography defines the probability of detecting a wave quantum frequency v within a unit area attached to the point (x,y) of the hologram plane, where the wavelet mixing aOb takes place and is described in terms of a tensor multiplication O. The orthogonality condition (1) can be seen therefore as specifying a set of diagonal elements or trace Tr in a unit matrix in the frequency domain. It implies, as can be shown, that the Shannon encoding schema employed in DNA is optimally efficient, which following a billion or more years of evolution, in DNA could be expected to be the case.

The conditions (1) are therefore in excellent agreement with Gariaev group's conclusion. It confirms that the planes on which the base pairing takes places, concerns two quantum holograms, ie the wavelet mixings aOb and cOd, where each specifies a “context”, one for the other. Further quantum holography predicts, based on the symmetries of the 3 dimensional representation of the Heisenberg Lie group G, that in relation to the quantum hologram defined by a wavelet mixing aOb, the coherent wavelet packet densities a(t)dt and b(t′)dt′ are indistinguishable by means of relative time and phase corrections applied to the respective wavelet pathways (x,y) in the hologram plane. That is, to say, the tensor operation O, in the case of quantum holography, describes a quantum entanglement, even though aOb defines a quantum hologram, from which quantum holography shows and MRI proves, holographic information can be both written/encoded and read/decoded. Thus, mathematically, DNA can on the basis of quantum holography be thought of represented quantum mechanically very simply by the trace Tr <a,b |c,d >such that when the double helix is opened, in accordance with the Gariaev description above, this corresponds to the representation
<a,b |><|c,d>

The process of completed duplication of DNA can therefore represented as
Tr<a,b |c,d><a,b |c,d >

because as it is crucial to understand in the case of DNA, the two strands of the double helix are, quantum holography shows, not the same but phase conjugate, ie what biologists call complementary/antiparallel, and so must be represented within the context of DNA itself by a,b and c,d respectively. These pairs differ quantum holography shows, constituting covariant and contragrediant representations, which are essentially topologically cohomologous [Marcer 2000]. It could explain why to quote de Duve [1984], just the two elementary base-pairing {A,U/T}and {G,C} of respectively the nucleotides Adenine and Uracil/Thymine together with Guanine and Cytosine, are needed, to “govern through the two relatively fragile structures they embody, the whole of information transfer throughout the biosphere”. That is to say, in DNA, these two nucleotide base pairings are the universal chemical mechanisms producing the wavelet mixing O on the hologram planes (which they also define) such that DNA can then be given a shorthand description in terms of context dependent genetic texts written in the four letters A,T,G,C.

The topological differentiation referred to above follows from the fact that, while in quantum mechanics, a wave function is only determined up to an arbitrary phase, phase difference is of physical significance (as in holography), because there exists a class of quantum observables, which are the gauge invariant geometric phases of the state vector or wave function [Resta 1997; Schempp 1992; Anandan 1992]. These observables must therefore be distinguished from those which are the eigenvalues of some operator, usually the Hamiltonian or energy function. Such a state vector description (with gauge invariant phases) by means of which each DNA molecule can clearly be expected to be described, would explain the difference between the nature of quantum interference and quantum self interference, which DNA from its double helical structure can thus be recognized to concern.

In the above means of representing DNA therefore, |><| represents by the quantum correspondence principle, the quantum soliton control [see also, Denschlag et al, 2000] or wavepacket activity rather than its classical soliton counterpart, which was the subject of the Moscow computer simulations. These all confirm the Gariaev group's conclusions reached as a result of their experiments, that DNA functions as a quantum coherent system/assembly (of now quantum oscillators) or whole, by means of quantum entanglement. A whole, where as (1) shows, this may be decomposed into an orthogonal family of holographically encoded 3 spatial dimensional images in line with the usual description of a quantum mechanical diagonalization. It also says in line with the Gariaev group's findings that DNA can be described as an “autocorrelation”, where as shown here, this is an optimally efficient decomposition into a decorrelated family of holographic code primitives /holograms, and that this, as Schempp[1992] shows, follows from the fact a quantum mechanical harmonic oscillator (in this case the highly complex DNA molecule itself) is equivalent to an assembly of bosons each having one polarization state. The latter substantiates the Gariaev group conclusion that they have indeed discovered an entirely new form of electromagnetic vector by means of which holographic images are carried in the form of a polarization state, suitable for a new form of cinema, video and computer.

Quantum holography says that DNA satisfies the principle of computer construction [Von Neumann, 1966], since it carries a copy of itself, and is

(a) its own blueprint written in the genetic texts, where the mechanism engineering the DNA replication is the biophotonic electromagnetic field, while the “letters” of the genetic texts A, G, C, U are held invariant, but where,

(b) in the case of the replication of the organism, for which DNA is the blueprint written in the holographic information, the reverse is the case. That is, it is the “acoustic field” in this case, which mechanically constructs/engineers the organism out of the available matter, in accordance with the information held in the electromagnetic field holograms (these being held invariant in this case). This must therefore mean that Adenine, Uracil, Guanine, and Cytosine are invariants structures/weightings in both the acoustic and electromagnetic field domains. These mechanisms therefore correspond with the know basic features of quantum communication/information transfer known as quantum teleportation, which consists of two inseparable signal processes one classical, one quantum.

The latter is instantaneous transmission from X to Y (unlimited in principle as to distance), but which cannot be used without the other, which is transmission from X to Y by conventional means at the speed of light or lower. In the case of DNA, therefore, it is the existence of the genetic text of the organism itself which constitutes the classical signal process of quantum teleportation, able to facilitate the quantum mechanical signal processes of both the copying of the DNA as its own blueprint, and of the construction of the organism (for which DNA is the blueprint) in a massively parallel way by the means of quantum teleportation.

Remarkably too, quantum holography also confirms and is confirmed by another astonishing experimental finding. This is the so-called “DNA-Phantom-Effect” [Gariaev, Junin, 1989; Gariaev et al, 1991; Gariaev, 1994], a very intriguing phenomenon, widely discussed, when it was first found by Peter Gariaev. Later similar phenomenon termed “mimicking the effect of dust” [Allison et al, 1990]. was detected by group of R.Pecora. This is the discovery that the pattern below, found in the first experiment described, when a laser illuminated DNA, does not immediately disappear if the DNA samples are removed from the apparatus. It continues in different form for sometime. An explanation would be that quantum holography defines an admitter/absorber quantum vacuum model of quantum mechanics in terms of annihilation/creation operators [Schempp 1993], implying that DNA does indeed behave like a single quantum, which induces a “hole” temporarily in the vacuum by its removal.

In this contribution, the inventor is going to describe some observations and interpretations of a recently discovered anomalous phenomenon, which the inventor is calling the DNA Phantom Effect in Vitro or the DNA Phantom for short. The inventor believes this discovery has tremendous significance for the explanation and deeper understandings of the mechanisms underlying subtle energy phenomena including many of the observed alternative healing phenomena [1,2]. This data also supports the heart intelligence concept and model developed by Doc Lew Childre [3,4]. (See also contributions by Rollin McCraty and Glen Rein in this volume). This new phenomenon—the DNA phantom effect—was first observed in Moscow at the Russian Academy of Sciences as a surprise effect during experiments measuring the vibrational modes of DNA in solution using a sophisticated and expensive “MALVERN” laser photon correlation spectrometer (LPCS) [5]. These effects were analyzed and interpreted by Gariaev and Poponin [6]. The new feature that makes this discovery distinctly different from many other previously undertaken attempts to measure and identify subtle energy fields [1] is that the field of the DNA phantom has the ability to be coupled to conventional electromagnetic fields of laser radiation and as a consequence, it can be reliably detected and positively identified using standard optical techniques. Furthermore, it seems very plausible that the DNA phantom effect is an example of subtle energy manifestation in which direct human influence is not involved.

These experimental data provide us not only quantitative data concerning the coupling constant between the DNA phantom field and the electromagnetic field of the laser light but also provides qualitative and quantitative information about the nonlinear dynamics of the phantom DNA fields. Note that both types of data are crucial for the development of a new unified nonlinear quantum field theory which must include the physical theory of consciousness and should be based on a precise quantitative background. RESULTS The background leading to the discovery of the DNA phantom and a description of the experimental set up and conditions will be helpful. A block diagram of the laser photon correlation spectrometer used in these experiments is presented in FIG. 1. In each set of experimental measurements with DNA samples, several double control measurements are performed. These measurements are performed prior to the DNA being placed in the scattering chamber. When the scattering chamber of the LPCS is void of physical DNA, and neither are there are any phantom DNA fields present, the autocorrelation function of scattered light looks like the one shown in FIG. 2a. This typical control plot represents only background random noise counts of the photomultiplier.

Note that the intensity of the background noise counts is very small and the distribution of the number of counts per channel is close to random. FIG. 2b demonstrates a typical time autocorrelation function when a physical DNA sample is placed in the scattering chamber, and typically has the shape of an oscillatory and slowly exponentially decaying function. When the DNA is removed from the scattering chamber, one anticipates that the autocorrelation function will be the same as before the DNA was placed in the scattering chamber. Surprisingly and counter-intuitively it turns out that the autocorrelation function measured just after the removal of the DNA from the scattering chamber looks distinctly different from the one obtained before the DNA was placed in the chamber. Two examples of the autocorrelation functions measured just after the removal of the physical DNA are shown in FIGS. 2c and d. After researchers duplicated this many times and checked the equipment in every conceivable way, the inventor was forced to accept the working hypothesis that some new field structure is being excited from the physical vacuum. The researchers termed this the DNA phantom in order to emphasize that its origin is related with the physical DNA. The researchers have not yet observed this effect with other substances in the chamber. After the discovery of this effect the researchers began a more rigorous and continuous study of this phenomena. They have found that, as long as the space in the scattering chamber is not disturbed, they were able to measure this effect for long periods of time. In several cases the inventor have observed it for up to a month. It is important to emphasize that two conditions are necessary in order to observe the DNA phantoms.

The first is the presence of the DNA molecule and the second is the exposure of the DNA to weak coherent laser radiation. This last condition has been shown to work with two different frequencies of laser radiation. Perhaps the most important finding of these experiments is that they provide an opportunity to study the vacuum substructure on strictly scientific and quantitative grounds. This is possible due to the phantom field's intrinsic ability to couple with conventional electromagnetic fields. The value of the coupling constant between the DNA phantom field and the electromagnetic field of the laser radiation can be estimated from the intensity of scattered light. The first preliminary set of experiments carried out in Moscow and Stanford have allowed us to reliably detect the phantom effect; however, more measurements of the light scattering from the DNA phantom fields are necessary for a more precise determination of the value of the EMF-DNA phantom field coupling constant. It is fortunate that the experimental data provides us with qualitative and quantitative information about the nonlinear dynamical properties of the phantom DNA fields. Namely, these experimental data suggest that localized excitations of DNA phantom fields are long living and can exist in non-moving and slowly propagating states. This type of behavior is distinctly different from the behavior demonstrated by other well known nonlinear localized excitations such as solitons which are currently considered to be the best explanation of how vibrational energy propagates through the DNA.

It is a remarkable and striking coincidence that a new class of localized solutions to anharmonic Fermi-Pasta-Ulam lattice (FPU)—nonlinear localized excitations (NLE), which have been recently obtained [7], demonstrate very similar dynamical features to those of the DNA phantom. Nonlinear localized excitations predicted by the FPU model also have unusually long life-times. Furthermore, they can exist in both stationary or slowly propagating forms. In FIG. 3, one example of a NLE is shown which illustrates three stationary localized excitations generated by numerical simulation using the FPU model [7].

It is worthy to note that this NLE has a surprisingly long life-time. Here, the inventor presents only one of the many possible examples of the patterns for stationary excitations which are theoretically predicted. Slowly propagating and long lived NLE are also predicted by this theory. Note that the FPU model can successfully explain the diversity and main features of the DNA phantom dynamical patterns. This model is suggested as the basis for a more general nonlinear quantum theory, which may explain many of the observed subtle energy phenomena and eventually could provide a physical theory of consciousness. According to our current hypothesis, the DNA phantom effect may be interpreted as a manifestation of a new physical vacuum substructure which has been previously overlooked. It appears that this substructure can be excited from the physical vacuum in a range of energies close to zero energy provided certain specific conditions are fulfilled which are specified above. Furthermore, one can suggest that the DNA phantom effect is a specific example of a more general category of electromagnetic phantom effects [8]. This suggests that the electromagnetic phantom effect is a more fundamental phenomenon which can be used to explain other observed phantom effects including the phantom leaf effect and the phantom limb [9]. Dr. Poponin is a quantum physicist who is recognized world wide as a leading expert in quantum biology, including the nonlinear dynamics of DNA and the interactions of weak electromagnetic fields with biological systems. He is the Senior Research Scientist at the Institute of Biochemical Physics of the Russian Academy of Sciences and is currently working with the Institute of HeartMath in a collaborative research project between IHM and the RAS.

The human DNA is a biological Internet and superior in many aspects to the artificial one. The latest Russian scientific research directly or indirectly explains phenomena such as clairvoyance, intuition, spontaneous and remote acts of healing, self healing, affirmation techniques, unusual light/auras around people (namely spiritual masters), mind's influence on weather patterns and much more. In addition, there is evidence for a whole new type of medicine in which DNA can be influenced and reprogrammed by words and frequencies WITHOUT cutting out and replacing single genes. Only 10% of our DNA is being used for building proteins. It is this subset of DNA that is of interest to western researchers and is being examined and categorized. The other 90% are considered “junk DNA.” The Russian researchers, however, convinced that nature was not dumb, joined linguists and geneticists in a venture to explore those 90% of “junk DNA.” According to them, our DNA is not only responsible for the construction of our body but also serves as data storage and in communication. The Russian linguists found that the genetic code, especially in the apparently useless 90%, follows the same rules as all our human languages. To this end they compared the rules of syntax (the way in which words are put together to form phrases and sentences), semantics (the study of meaning in language forms) and the basic rules of grammar.

They found that the alkalines of our DNA follow a regular grammar and do have set rules just like our languages. So human languages did not appear coincidentally but are a reflection of our inherent DNA.

The Russian biophysicist and molecular biologist Pjotr Garjajev and his colleagues also explored the vibrational behavior of the DNA. They concluded that; “Living chromosomes function just like solitonic/holographic computers using the endogenous DNA laser radiation.” This means that they managed for example to modulate certain frequency patterns onto a laser ray and with it influenced the DNA frequency and thus the enetic information itself. Since the basic structure of DNA-alkaline pairs and of language (as explained earlier) are of the same structure, no DNA decoding is necessary. One can simply use words and sentences of the human language. This, too, was experimentally proven! Living DNA substance (in living tissue, not in vitro) will always react to language-modulated laser rays and even to radio waves, if the proper frequencies are being used. This finally and scientifically explains why affirmations, autogenous training, hypnosis and the like can have such strong effects on humans and their bodies.

It is entirely normal and natural for our DNA to react to language. While western researchers cut single genes from the DNA strands and insert them elsewhere, the Russians enthusiastically worked on devices that can influence the cellular metabolism through suitable modulated radio and light frequencies and thus repair genetic defects.

Garjajev's research group succeeded in proving that with this method chromosomes damaged by x-rays for example can be repaired. They even captured information patterns of a particular DNA and transmitted it onto another, thus reprogramming cells to another genome. So they successfully transformed, for example, frog embryos to salamander embryos simply by transmitting the DNA information patterns. This way the entire information was transmitted without any of the side effects or disharmonies encountered when cutting out and re-introducing single genes from the DNA.

This represents an unbelievable, world-transforming revolution and sensation! All this by simply applying vibration and language instead of the archaic cutting-out procedure! This experiment points to the immense power of wave genetics, which obviously has a greater influence on the formation of organisms than the biochemical processes of alkaline sequences. Esoteric and spiritual teachers have known for ages that our body is programmable by language, words and thought. This has now been scientifically proven and explained. Of course the frequency has to be correct. And this is why not everybody is equally successful or can do it with always the same strength. The individual person must work on the inner processes and maturity in order to establish a conscious communication with the DNA. The Russian researchers work on a method that is not dependent on these factors but will ALWAYS work, provided one uses the correct frequency. But the higher developed an individual's consciousness is, the less need is there for any type of device! One can achieve these results by oneself, and science will finally stop to laugh at such ideas and will confirm and explain the results. And it doesn't end there. The Russian scientists also found out that our DNA can cause disturbing patterns in the vacuum, thus producing magnetized wormholes! Wormholes are the microscopic equivalents of the so-called Einstein-Rosen bridges in the vicinity of black holes (left by burned-out stars). These are tunnel connections between entirely different areas in the universe through which information can be transmitted outside of space and time. The DNA attracts these bits of information and passes them on to our consciousness. This process of hypercommunication is most effective in a state of relaxation. Stress, worries or a hyperactive intellect prevent successful hypercommunication or the information will be totally distorted and useless. In nature, hypercommunication has been successfully applied for millions of years. The organized flow of life in insect states proves this dramatically. Modern man knows it only on a much more subtle level as “intuition.” But we, too, can regain full use of it. An example from Nature: When a queen ant is spatially separated from her colony, building still continues fervently and according to plan. If the queen is killed, however, all work in the colony stops. No ant knows what to do. Apparently the queen sends the “building plans” also from far away via the group consciousness of her subjects. She can be as far away as she wants, as long as she is alive. In man, hypercommunication is most often encountered when one suddenly gains access to information that is outside one's knowledge base. Such hypercommunication is then experienced as inspiration or intuition. The Italian composer Giuseppe Tartini for instance dreamt one night that a devil sat at his bedside playing the violin. The next morning Tartini was able to note down the piece exactly from memory, he called it the Devil's Trill Sonata.

For years, a 42-year old male nurse dreamt of a situation in which he was hooked up to a kind of knowledge CD-ROM. Verifiable knowledge from all imaginable fields was then transmitted to him that he was able to recall in the morning. There was such a flood of information that it seemed a whole encyclopaedia was transmitted at night. The majority of facts were outside his personal knowledge base and reached technical details about which he knew absolutely nothing. When hypercommunication occurs, one can observe in the DNA as well as in the human being special phenomena. The Russian scientists irradiated DNA samples with laser light. On screen a typical wave pattern was formed. When they removed the DNA sample, the wave pattern did not disappear, it remained. Many control experiments showed that the pattern still came from the removed sample, whose energy field apparently remained by itself. This effect is now called phantom DNA effect. It is surmised that energy from outside of space

and time still flows through the activated wormholes after the DNA was removed. The side effect encountered most often in hypercommunication also in human beings are inexplicable electromagnetic fields in the vicinity of the persons concerned.

Electronic devices like CD players and the like can be irritated and cease to function for hours. When the electromagnetic field slowly dissipates, the devices function normally again.

Many healers and psychics know this effect from their work. The better the atmosphere and the energy, the more frustrating it is that the recording device stops functioning and recording exactly at that moment. And repeated switching on and off after the session does not restore function yet, but next morning all is back to normal. In their book “Vernetzte Intelligenz” (Networked Intelligence), Grazyna Gosar and Franz Bludorf explain these connections precisely and clearly. The authors also quote sources presuming that in earlier times humanity had been, just like the animals, very strongly connected to the group consciousness and acted as a group. To develop and experience individuality we humans however had to forget hypercommunication almost completely. Now that we are fairly stable in our individual consciousness, we can create a new form of group consciousness, namely one, in which we attain access to all information via our DNA without being forced or remotely controlled about what to do with that information.

We now know that just as on the internet our DNA can feed its proper data into the network, can call up data from the network and can establish contact with other participants in the network. Remote healing, telepathy or “remote sensing” about the state of relatives etc. can thus be explained. Some animals know also from afar when their owners plan to return home. That can be freshly interpreted and explained via the concepts of group consciousness and hypercommunication. Any collective consciousness cannot be sensibly used over any period of time without a distinctive individuality. Otherwise we would revert to a primitive herd instinct that is easily manipulated. As a rule, whether for example, is rather difficult to influence by a single individual. But it may be influenced by a group consciousness (nothing new to some tribes doing it in their rain dances). Weather is strongly influenced by Earth resonance frequencies, the so-called Schumann frequencies. But those same frequencies are also produced in our brains, and when many people synchronize their thinking or individuals (spiritual masters, for instance) focus their thoughts in a laser-like fashion, then it is scientifically speaking not at all surprising if they can thus influence weather. Researchers in group consciousness have formulated the theory of Type I civilizations. A humanity that developed a group consciousness of the new kind would have neither environmental problems nor scarcity of energy. For if it were to use its mental power as a unified civilization, it would have control of the energies of its home planet as a natural consequence. And that includes all natural catastrophes.

A theoretical Type II civilization would even be able to control all energies of their home galaxy. In the book “Nutze die taeglichen Wunder,” The author describes an example of this:

Whenever a great many people focus their attention or consciousness on something similar like Christmas time, football world championship or the funeral of Lady Diana in England then certain random number generators in computers start to deliver ordered numbers instead of the random ones. An ordered group consciousness creates order in its whole surroundings. When a great number of people get together very closely, potentials of violence also dissolve. It looks as if here, too, a kind of

humanitarian consciousness of all humanity is created. At the Love Parade, for example, where every year about one million of young people congregate, there has never been any brutal riots as they occur for instance at sports events. The name of the event alone is not seen as the cause here. The result of an analysis indicated rather that the number of people was TOO GREAT to allow a tipping over to violence. To come back to the DNA: It apparently is also an organic superconductor that can work at normal body temperature. Artificial superconductors require extremely low temperatures of between 200 and 140° C. to function.

Karl Pribram's explanations of how material is learned, in particular, his explanation of how the complex motions of a tennis serve are learned, go a long way toward explaining the improved learning capacity of individuals whose brains are in states of coherent vibration, in particular, the vibrational ratios of phi in its promotion of predominantly theta brainwave coherence, strongly associated with more efficient (holographic) learning, mental calmness, physical coordination as well as long term memory formation, consolidation and retrieval termed LPT (long term potentiation) for promoting the entrainment of complex motor skills an general improvements in cognition reflected in such skill acquisition.

In short, the invention can serve as, among other things, a piezoelectric inductor that transmits fractally coherent vibrations through the body that, in addition to dissipating heat, promote other benefits such as brainwave fractal phase coherence associated with enhanced states of learning, calmness, memory formation and retrieval, openness to new information, resolution of mental and emotional conflicts and many other less easily defined, but no less real, effects contributing to overall well being and sports skills.

### FIELD OF THE INVENTION

The invention pertains to the application of piezoelectric effects to objects. More particularly, the invention pertains to improved designs for golf putters based upon those effects.

### DESCRIPTION OF RELATED ART

Golf is an ancient game whose modern day version is played by millions of people around the world. It continues to enjoy ever-increasing commercial and social successes, largely reflected in, and dependent upon, the rules that govern play. Any attempt to successfully commercialize a golf club design for competition, whether it be for competing in a professional or amateur tournament, or merely for establishing a handicap for the purpose of enjoying the game in a country club or public course setting, must take into account the rules as set down by the two main governing bodies (the USGA United States Golfer's Association and the Royal and Ancient R&A whose rules have recently been, for the most part, aligned) and who together, effectively regulate all golf play worldwide.

Harmonics are often also referred to as overtones, but the precise definition of ‘overtone’ for the purpose of this application, refers to a particular partial in the timbre. For example, an instrument could contain 3 overtones—say . . . harmonics 1, 2, 5 and 8. Harmonic 1 is the fundamental so this doesn't count. Harmonic 2 is overtone 1, harmonic 5 is overtone 2, and 8 is the third overtone.

Harmonic one=the fundamental. Harmonic 2=overtone 1. Harmonic 3=overtone 2. Harmonic 4=overtone 3 and so on.

Golf is primarily a social sport, largely made possible by the uniqueness of its handicapping system effectively allowing young and old, skilled and novice, to compete on a relatively even footing using a kind of skill differential. This handicapping system is predicated on averaging, at regular intervals, the scores of golfers into a profile that allows more skilled players to essentially “donate” strokes to less skilled players, giving less skilled players a metaphorical “head start” so that players of all skill levels can compete on a relatively equal footing.

If all golfers were not required to conform to the rules that underpin golf, one could easily envision anarchical situations where amateurs and professionals alike, could exploit every equipment advantage, resulting in potentially ridiculous scenarios of unfair advantage that would render any direct comparison of skill, or even relative comparisons, such as those scaled comparisons of men to boys made possible by the existing system, impossible.

On an individual level, it would also render it difficult, if not impossible, for the average player to know what aspect of his or her game was due to improved skill or simply an equipment-mediated improvement. So it is not tradition for its own sake per se, it is a rule based system to provide a fair competitive environment where players are equally matched for skill, or in the case of handicaps, unequally matched, enabling players of differing abilities to compete head to head with the same or similar equipment.

In short, it has proven more logical, practical and enforceable, to donate strokes to a weaker player rather than provide him or her, for example, with a ball that travels further. The obvious flaw in such an equipment-based strategy for handicapping would be in deciding what piece of skill enhancing equipment, allowed the weaker player to improve, in what way, and by how much. Put differently, when the weaker player's average score improves, should the governing body take away his longer-flying balls, his bigger clubs, his range finder or some combination of these items? It would become unworkable to disentangle which part of the handicapped equipment was contributing to the lower scores. There are already distance modifications employed for women and children when competing against men so as to allow a highly skilled, but less powerful, child for example, to compete head to head with an adult. The child simply “tees off” (hits his first shot) closer to the hole than his stronger competitor. This was done so as to promote uniformity in the ever-increasing international nature of the game for professionals and amateurs alike.

Such rules alignment, particularly those governing club design, allow a player to effectively compete anywhere golf is regulated without fear of being out of compliance wherever he or she might be playing, eliminating the need to familiarize himself with different clubs and thus, reduces the likelihood of inadvertent rules violations, further enhancing the ease, enjoyment and overall quality of the game. It is obvious to anyone even tangentially familiar with the game of golf that it consists primarily of two basic movement types.

One is aggressive, requiring power and skill to propel the golf ball relatively long distances, and the other is a more refined movement category, largely using the arms and shoulders for chipping and putting the ball shorter distances which obviously requires great skill, but much less power, as evidenced by the economized bodily movements to promote finer control. A useful comparison of the relative power between full shots and chipping/putting, would be to examine the obvious differences between throwing a javelin and throwing a dart. Javelin throwing requires a coordination of all the large muscle groups whereas darts is primarily played from the elbow. If one tried using a javelin technique in darts, accuracy would no-doubt suffer.

Thus, the full swing and putting stroke reflect entirely different biomechanics. In a full swing, the golfer's feet, legs, hips, and shoulders are in motion: the body dominates the swing. Conversely, during a preferred, or traditional, putting stroke, the body remains relatively motionless, with the arms and shoulders acting in consort to form a kind of pendulum. Full-swing clubs may be swung at speeds in excess of one hundred miles per hour. The inventor, for example, has achieved clubhead speeds in excess of 120 miles per hour and has propelled golf balls in excess of 400 yards.

In short, putters perform a very different function than the other thirteen full-swing clubs, and yet the designs of putter shafts, are, in terms of their length, weight, flexion and hence, capacity to transmit energy to the ball, demonstrably similar to full club shafts. “The putting stroke is only one of several different types of golf swings, yet it accounts for nearly half of all swings made” 43% (Pelz 2000) 45% (Swash 2001).

Putting has been described as a game within a game on numerous occasions. The majority of coaching magazines, manuals, textbooks suggest ‘feel’ as the key to success, along with a ‘good technique’. A good technique is required in order to create the confidence necessary to hole putts. There is no recovery opportunity from bad putting or bad luck. Controlling the speed of the putter at impact is vital for distance control and good green reading. “Every putt is a straight putt—it just depends on how hard you hit the putt as to whether the ball takes the break or not” Swash (2001).

Given the advanced state of knowledge in human kinematics, there appears to be a mismatch between what are essentially full club shafts that have been traditionally employed in putters despite the relatively low-power requirements of putting.

Indeed, on face value, this mismatch seems to be driven more by tradition than any deep understanding of putting which is obviously a highly refined, relatively low-power, proceduralized skill. That being said, much of this perceived stagnation in innovation also stems from laudable efforts to try and strike a balance between allowing for the technological growth of the game while simultaneously preserving its essential traditions as well as leveling the playing field to avoid grossly unfair equipment advantages.

Golf has a long and colorful history of disputes over equipment, not least of which, disputes arising between British and American professionals, especially when American's began dominating tournaments overseas, in particular, the British Open.

This historical rift has been all but erased by an alignment of rules between the two main governing bodies of golf that effectively allow any golfer to play by the same rules with the same types of clubs anywhere in the world. It stands to reason that anyone serious about capitalizing on a golf club invention would want to conform to such rules, the exception being practice clubs.

The inventor wishes to draw a subtle but important distinction here between practice clubs or club fixtures that promote strength for increasing the power and or skill of full shots, and those promoted as training aids for the finer-skilled, relatively low-power, movements of chipping and putting and also explain how the aforementioned shaft mismatches potentially stem, at least partially, from the erroneously perceived restrictiveness of the rules regulating club design.

There are probably hundreds, if not thousands, of training aids relating to golf; everything from lasers for helping golfers align shots, to special grips designed to mold to the contours of the hands for improved gripping, some of which may be beneficial as teaching tools, but none of which are allowed in competition, even for establishing a local country club handicap. This is not to diminish their utility, just to point out the restrictive nature of golf's rules and how they relate to actual competitive play, even among amateurs.

Many, if not most, of the prior art references cited in the latest Office Action Summary in response to this application would not conform to the rules of golf under either governing body. There also exists prior art that would conform to existing rules, but only in the narrowest of scope. Increasing, for example, the mass of a given section of a traditional golf shaft to the limit of its claims would necessitate a bulge so large, as to render the club non-conforming.

The inventor has received communication from the R&A stating that they would not accept any bulge in a golf shaft larger than that of the “Bubble II” shaft (U.S. Pat. No. 5,692,970), whose namesake reflects an elliptical bulge in the upper portion of their shafts. An imperfect putting stroke may result in the clubhead (or blade) being struck off-center, which may cause the putter to twist in the golfer's hands and lose the all-important line.

A club's resistance to this twisting is a function of the club's moment of inertia. More specifically, the moment of inertia of a golf club affects the club's shaft resistance to rotating about an axis when the golf ball is struck away from the center of percussion (sweet spot) of the clubhead. An increase in the magnitude of the moment of inertia of a golf club, and particularly the putter, is a desirable object of golf club design. This object has been recognized, as designs incorporating heel-toe weighting in the club head to increase the moment of inertia of putters. While they have increased the moment of inertia somewhat, it would be most desirable to increase the moment of inertia by an order of magnitude or more.

The inventor has successfully employed shaft stiffening, either alone, or in combination with, alterations to conventional shaft mass distribution to affect desired changes to ball impact dynamics, irrespective of any compensatory weighting of the putterhead itself, born out in the kinematic experiments conducted by Hurrion and the inventor that demonstrate conclusively such effects through the use of high speed video capture and statistical analysis of putts struck off center with robots using traditionally weighted putterheads attached to the inventor's shafts.

It is critical to note, that not only has the inventor strategically increased both the stiffness and mass in certain preferred embodiments of his invention, resulting in increased moment of inertia, defined by Bloom as a club's tendency to resist twisting in the hands during putting, he also has successfully improved controllability of both distance and direction of putts through either:

1. strategic increases in stiffness, or

2. strategic reductions in stiffness, or

3. alterations to shaft materials, or

4. alterations to shaft geometries or

any combination of 1, 2, 3, or 4 (independent of any substantial alterations to the mass distribution characterizing traditional shafts). Put differently, even if the golfer's hands resist the shaft twisting by increasing grip pressure, with sufficient impact force, he cannot resist the shaft twisting relative to the hands and weight. An absurd but useful example illustrating this would be to strike a putt off-center with a section of rope replacing the shaft.

No amount of grip pressure would stop the rope from twisting, as the rope's ability to resist torsional loads would be uninfluenced by any increases in grip pressure. These subtle but important dynamics, often overlooked in putting analysis, can make a large difference, especially over long putts or full shots struck with substantial force.

There is s benefit in strategically increasing both mass and shaft stiffness (stiffness being defined as resisting both flex and twist), and that is the actual behavior of the ball as it leaves the clubface. The Swash patent (5,637,044) claims reduced skid when the ball leaves the clubhead; that is to say, all putts skid, but the grooves employed in the Swash putterhead reduce the length of skid when compared to traditional putterhead faces for equivalent putts (same impact velocity), promoting a more consistent putt line (ball rolling closer to, deviating less from, the initial target line).

Subsequent to the original filing of this application, the inventor uncovered, after viewing high speed video of laboratory putts struck with robots, a unique benefit of his shaft modification in that it too, like Swash heads on traditional shafts, reduces skid length when compared to traditional putterhead faces attached to traditional shafts, but most strikingly, further reduces skid length when combined with Swash-like putterheads beyond that possible with Swash heads alone on traditional shafts, or Swash-like heads combined with shafts including extra mass but that do not substantially increase stiffness or exploit fractal ratios in the region of the added mass.

This is obviously beneficial in that the inventor's shaft could be combined with Swash or other similar anti-skid heads for even greater skid reduction than would be possible with anti skid heads on traditional or weighted shafts alone. The inventor has already shown a 20 percent reduction in the length of putt skid with a wide range of putter heads attached to his shaft. In the case of golfers not willing to part with putterheads to which they have become accustomed, the inventor's shaft would still allow golfers to achieve dramatic skid reduction without having to part with their preferred putterheads.

Incidentally, the same robots, statistical analysis and video capture tools used in the Swash experiments were employed by the same scientist, under the same conditions, in the same laboratory, with the inventor's shafts. The inventor's shafts have also exhibited impact ratio benefits as a result of strategically increasing, or in some cases, reducing shaft stiffness, in conjunction with altering the vibrational spectra of shafts by strategically locating, longitudinally, modifications to shaft stiffness according to certain mathematical ratios. This is to point out that the increased stiffness of certain portions of the shaft over traditional bending and twisting dynamics, exhibit analogous changes to impact ratios, vibrational feedback, reduced skid, increased effortfulness, increased moment of inertia and other related benefits. The inventor has also definitively proved an enlarged sweet spot effect as a result of such modifications independent of extra mass.

There is much confusion among golfers as to what role moment of inertia plays and what benefits, if any, its increase represents for putting. Bloom, for example (U.S. Pat. No. 6,966,846), makes a potentially misleading association between what he calls an increased moment of inertia and an enlarged “sweet spot.” His definition of moment of inertia is technically correct insofar as it is, as he claims, the tendency of an object (the shaft) to resist twisting (in the hands) when struck off center, however, this overly simplistic definition does not represent a strategic or competitive advantage in putting.

His statement may unwittingly mislead due, as far as the inventor can see, to a widespread misunderstanding of relative dampening. In order to dramatically enlarge a putter's sweet spot, not only must the putter resist twisting when struck off-center, the ball must, when struck with the same impact velocity as putts struck on the sweet spot, travel as close as possible to putts struck on the sweet spot. The inventor also wishes to point out that the addition of weight in the form of lead tape to either a golf club shaft or head, has been public knowledge for decades and is even stipulated in the rules of golf as being a permissible club modification. The limits of the addition of such weight would however, be reached if such additions significantly altered the appearance of the club, rendering it “non-customary.” An example of this, as explained to the inventor by both the R&A and the USGA would be to add an excessive amount of lead tape to a shaft so as to create a bulge that exceeded the diameter of the aforementioned “Bubble II” shaft.

The long-standing problem of peripheral weighting has been solved, and demonstrated experimentally, by the inventor to a much greater extend than any other single design or combination of designs through the use of relative dampening. The inventor has, through stiffening a portion of the shaft, independent of any extra mass additions, rendered the “sweet spot” less efficient at kinetically transmitting energy to the ball while simultaneously increasing, relative to the newly dampened sweet spot, the amount of energy toe or heel struck putts transfer to the ball, independent of any added mass. In short, when putts are struck with the inventor's shaft stiffening effect, sweet spot putts are demonstrably deadened whereas off center struck putts are more energetic relative to the sweet spot than they were previously.

If one merely increases the peripheral weighting of a putterhead, or increases the mass of a portion of the shaft without concomitant changes in shaft stiffness (either increasing or decreasing), along with certain vibrational states associated with specific frequencies, the putterhead will indeed resist twisting during off-center struck putts but sweet spot putts will travel that much further due to the overall increase in the putter's mass, and hence, potential/kinetic energy. The inventor has obviously demonstrated much higher credibility on this point by conducting the research that quantifies his effect.

Using ambiguous descriptors such as “increased moment of inertia” and then attaching such “increases” to a supposed “sweet spot enlargement” is potentially misleading. While the inventor concedes that there may be psychoneuromuscular placebo effects stemming from basic misconceptions of putting physics, he submits that given the glaring lack of even the most basic of knowledge demonstrated in the physics, kinematics and psychology of putting by the prior art cited, contrasted with the empirical evidence supporting the inventor's explanation of the invention's function, he respectfully submits that his invention is analogous to a carefully tested drug, whereas the prior art cited in the office action, amounts to little more than placebos, both in terms of accuracy of defining function (mechanism of action) and in terms of practical utility, not least of which the predominantly non-conforming nature of many, if not most, embodiments under the rules of golf.

The inventor also wishes to, for the purpose of emphasizing his invention's utility, point out that conformity to the rules of golf for practical and commercial considerations, is as important for a golf club (with the exception of weighted practice clubs for the expressed purpose of building muscle strength and power) as it is for pharmaceuticals to gain FDA approval. Patenting the use of gasoline, a known carcinogen, to treat skin conditions may be theoretically permissible, but it would probably not be put to practical use insofar as anyone with a medical license employing such unapproved therapies would, no doubt, quickly find themselves among the ranks of the unlicensed.

For those not skilled in the art such terminology may sound convincing, but it makes no more sense to increase peripheral weighting or shaft weighting, without relative dampening effects than to enlarge the diameter of automobile tires as a means for increasing gross vehicle weight for improved traction.

Obviously, any negligible increase in the gross vehicle's weight for the purpose of increasing the surface friction between tires and road would be far outweighed by the instability brought about by raising the vehicles center of gravity; small gains in friction are obviously outweighed by dramatic losses in stability. The relative dampening effect is shown most dramatically in the high speed video capture and subsequent analysis made during the Hurrion and Winey kinematic studies.

Blooms' description of correcting the putt's line leaves the impression that faulty line is the most pernicious influence in putting. This is another myth propagated by golfers that reflects a distortion of the statistical reality of missed putts. To quote Harold Swash, inventor of the C-Groove putter referenced in this application and a highly respected expert on putting physics, “All putts are straight putts.”

What he means by this statement is that the vast majority of putts are missed by a misjudgment in putt speed, not line. Put differently, almost no golfer, aims five feet off line on a ten-foot putt, but can, and often does, hit a 10-foot putt only five feet, or 15 feet. It is simply not the line of putts that cause the vast majority of three putts; it is, rather, overwhelmingly, misjudgment of speed. The Hurrion study commissioned by the inventor, examined the effect that a weighted/stiffened putter has on the impact and performance of a golf ball.

The results of the Hurrion study demonstrated that the inventor's shaft modification caused a relative reduction of the impact ratio when striking the golf ball from the sweet spot as compared to toe and heel struck putts. The range of the impact ratios (IR) using the inventor's shaft was 0.44 (1.41 Toe-1.85 Sweet Spot). By contrast, the IR range for the standard putter was 0.51 (1.41 Toe-1.92 Sweet Spot). The greater this range, the greater the variation in the peak ball velocity and therefore variation in distance traveled. This wouldn't be a problem for a golfer, if they struck the putt out of the same point of the putter each time. The impact speed of the putter controls the distance the ball travels AND more importantly the line the golfer needs to start the putt to be successful. By reducing the impact ratio the inventor's putter increases the size of the sweet spot of the putter. An increased sweet spot in turn allows the golfer a greater degree of error if they were to miss-hit the putt.

While the inventor is fully aware of the myriad devices and supplemental training aids and clubs on the market, he hopes to impress upon the examiner the practical and commercial difference between non-conforming training clubs and those approved for competition such as the inventor's shaft, already submitted to, and approved by, both governing bodies. The inventor would also like to point out that the rules regulating club design are rarely changed.

While the inventor is aware of persuasive arguments for employing practice devices and fixtures such as weights, elastic cords, devices to increase wind drag and the like, in order to promote muscle strength and coordination during powerful athletic movements such as the full swing in golf, he is unaware of any research whatsoever demonstrating even the slightest shred of evidence that adding substantial weight to a non-conforming de facto “practice” putter, considering all of the subtle psychoneurophysiological refinements of the putting process, that suggest a transference of skills to conforming clubs that in any way, improve putting measurably.

Rather than cite mountains of research for such an assertion, the inventor will, for the sake of brevity, appeal to the examiner's common sense and ask him to imagine a dart champion practicing with heavy darts, or a ping-pong champion practicing with heavy paddles. Competitive athletes simply do not refine low-power skills in such a way; on the contrary, there is substantial empirical and anecdotal evidence overwhelmingly in favor of the opposite view; that is to say, not only does switching from a “heavy” putter during practice not improve putting with an approved “light” putter, it worsens it. This is common knowledge among kinematics experts and explains the almost non-existent commercialization of such products.

Clearly, if one could improve the putting process by modifying the bending and twisting properties of a golf shaft with or without added mass within the rules, rendering it unnecessary to switch between a “heavy” practice putter and conforming “light” putter for competition, it would represent a legitimate competitive advantage within the rules of golf and by extension, represent a more commercially viable product.

There are actually weighted or “heavy” clubs already on the market that exploit their conformity to the rules of golf with some limited success. The problem arises in golf where players want to exploit the maximum benefit and versatility from their limit of 14 clubs and do not want to have to modify their swing mechanics to accommodate clubs with substantially differing swing weights, especially under the stress of competition where familiarity and repeatability of movement is critical for success. This point is almost too obvious when one imagines, for example, the absurdity of a professional baseball player switching between long or short, heavy or light bats during a game. The inventor is unaware of any high-ranking professional golfer using a “weighted” full club during competition where he is, nonetheless, familiar with several (including top-ten-ranked golfers) who use and promote weighted clubs for muscle conditioning.

### SUMMARY OF THE INVENTION

An object of this invention is to promote piezoelectric effects in carbon-based life forms using specific geometries, ratios, frequencies and combinations therein using associated vibrational states functioning in part, as bi-directional holographic transducers between the acoustic and electromagnetic domains.

### BRIEF DESCRIPTION OF THE DRAWINGS

FIG. 1 shows a conventional shaft geometry.

FIG. 2 shows a shaft with an upper portion 2, a stiffening means 1, and a lower portion 3.

FIG. 3 shows the ratios formed by A, B and C.

FIG. 4 shows shows a sampling of possible means placement according to the phi ratio.

FIG. 5 shows a shaft as in FIG. 1 with a structural means taking the form of a phi ellipse.

FIG. 6 shows fractal geometric shapes.

FIG. 7 shows a putter with a shaft 37, a striking face 38, cone-shaped projections 39a, 39b.

FIG. 8 shows a slightly different view angle of the putter of FIG. 7

FIG. 9 shows a putter with a shaft 40, a striking face 41, Schauberger whirlpipe-shaped projections on the back of said face 42a, 42b.

FIG. 10 shows a putter with a shaft 43, a striking face 44, rectangular projections on the back of said face 45a, 45b.

FIG. 11 shows a putterhead with a shaft 46 and a striking face 47, the head 48 taking the shape of interlocking regular pentagons

FIG. 12 shows a putterhead with a shaft 49 and a striking face 50, the head 51 taking the shape of the Fibonacci sequence

FIG. 13 shows an example of a hammer, 52 whereby a fractal geometric is employed structurally to help dissipate excess vibration via piezoelectric induction.

### DETAILED DESCRIPTION OF THE INVENTION

A specific preferred embodiment has been shown in the drawings and will be described in detail herein. However, it should be understood that the invention is not intended to be limited to the particular form disclosed. Rather, the invention is to cover all modifications, equivalents and alternatives falling within the spirit and scope of the invention as defined by the appended claims.

In order to relate phi with certain geometric shapes, the inventor wishes to direct the examiner to a brief overview of certain fractal geometries. All instruments created by man, use what he has known for thousands of years, that when strings are stretched over a hollow space, more or less beautiful sounds or tones can be created. In India, an instrument of this kind was built around 3000 B.C. Later, Pythagoras (around 500 B.C.), discovered that it was possible to express the relationship between two tones-called intervals-by rational numbers.

Pythagoras invented a one-stringed instrument, a monochord, which the Pythagoreans used for demonstrations, and as a musical instrument. Today, it is used to demonstrate intervals. For example, if you press down on ⅓ of the length of the string, and then pluck or strike it, the resulting tone will be the interval of a fifth above the tone of that same string when it vibrates freely. The significance of his invention was that man recognizes, or experiences, only a few specific intervals as beautiful. These intervals were called synphon by the Pythagoreans, and are the following:

Octave (ratio 1:2),

Fifth (ratio 2:3),

Fourth (ratio 3:4), and

Third (ratio 4:5).

In addition, there is also the 5:6 ratio, which is the minor third.

The Pythagoreans possessed an 8-stringed lyre and kitharra. All the stringed instruments taken as a whole, up to the beginning of the 16th Century—that is up until the invention of the violin family—had the following characteristics, which significantly limited the quality of their sound, and did not leave much room for expressing a variety of the scale's tone colors (for more on this, see Appendix 1):

(1) The fingerboards of these instruments are divided by small ridges, called frets, most familiar to us today from the guitar. The pitch is determined beforehand by these frets, so that for “pure” playing in all the keys one often has to make compromises. Depending on the kind of instrument, there was a certain tempering chosen which allowed for playing in the greatest possible number of keys. One aspect of this, is that the distance from one fret to the next is always different; whence there were naturally many different temperings. When the limits of each instrument's tempering were reached, it had to be retuned, which was the general practice. The discrepancy between the notes sounded on the frets and the proper pitches, as the musician moved through different keys, is sometimes described as the problem of the Pythagorean comma.

(2) As for the sound, the resonance chambers of these instruments were for the most part quite flat, or as is the case with fiddles, lutes, or many viols, arched according to certain specific geometrical forms (a cylinder), or with a shape taken from forms in nature. This, from the start, put a limit on the capacity of providing for a “real” or peer-quality accompaniment to the trained bel canto voice. Moreover, the bridge of the instrument is not curved, so that the bow cannot avoid touching all the strings at once, which means that only chords can be played. This kind of limitation can be easily recognized in the accompanying painting of the angel by Fra Angelico (p.19).

The new instrument family of the violin, viola, and cello were revolutionary relative to both these points. The characteristic vaulting curves of these instruments have remained unchanged until today, the instruments showing the same proportions down to the smallest detail. Unlike almost all of man's other inventions, this form has stayed unchanged for 550 years. Moreover, the paradox of the colors of the tonal scale is solved with genius: They simply eliminated the frets, so that the player himself can determine the pitch and how he will play it. Other than the human singing voice, there is no other instrument which allows this. What a revolutionary breakthrough in music! The instrumentalist could finally “sing” with his instrument, as we know today, from hearing the great violin, viola, or cello virtuosi. These two points also prove that there is no way that the violin family could have developed stepwise from some other instrument.

The luthier Max Möckel, who worked around the turn of the 19th Century in St. Petersburg and Berlin, did not rest until he had investigated the true origin of the sonorous and architectonic beauty of the violin. His idea was to investigate whether, in the light of the knowledge of the Renaissance, it might not be possible to discover what part had been played by Leonardo da Vinci, Luca Pacioli, and Albrecht Dürer in the revolution in instrument building. Thus, he began to look for clues to support his hypothesis in the works of these great artists, and he came to the following conclusion:

Is there really an Italian secret? Yes and no. If we think of it as some kind of recipe, hidden somewhere in some old chest, then no. . . . We must put ourselves into the time in which the violin was invented, and the ideas out of which each of the old masters created their works . . . The most significant minds, to name but two of them, Leonardo da Vinci and his friend Luca Pacioli, had shortly before concerned themselves, in their work of so many facets, with mathematical problems, and when they saw the triangle and the pentagon, they did not see them as merely simple geometrical figures, but they saw in the pentagon, for example, the secret eye of God, a living sensuous image, with its infinite number of unfoldings, for everything that is becoming.

With this hypothesis as a starting point, Möckel developed a procedure for building the violin, viola, and cello, whose standard was what Luca Pacioli called the Divine Proportion. (In the Divine Proportion, the division of a line or a geometrical figure is such that the smaller dimension is to the greater as the greater is to the whole.) From that time on, he built many excellent instruments according to this method.

The invention also may exploit certain tunings associated with phi, and other fractally coherent frequencies such as 432 Hertz or close approximations thereof plus or minus 5 Hertz or any of its numerical inverses such as 324 to include the original tuning of the Stradivarius violins (432 [Stradivarius violins themselves being geometrically replete with phi geometries]) and the scale which said tuning generates to promote or take advantage of the following:

Harmonically aligns to astronomical time count of Precession of the equinoxes, 432×60=25920 Synchronization with countless ancient sacred sites and the subtle energy fields associated with them, elucidated in the seminal work by Patrick Flanagan titled “Pyramid Power.”

The Great Pyramid in Egypt, 432 is found at the largest Buddhist temple in the world The borobudur—At the Borobudur the amount of statues at “The temple of countless Buddhas” is 432.

The correction to 432 is made, the others notes of the entire octave display a multitude of Gematrian ancient sacred numbers that are astoundingly relative to astronomy, sacred geometries, longitude and latitudes and hundreds of pyramids and other sacred sites.

The work of Kepler, Pythagoras and Hawkins is pure genius. However their ratios for the intervals in the diatonic scale are non-symmetrical and slightly simplified. They have used the ratio 27/24 for the whole step, which for one is incorrect. Following this logic, in the 880 octave and in others we have a full 1.76868 left over leaving the octave highly off its mark. These mathematical giants 4/3 ratio for the perfect 4th is also a full 1.009 Hertz off the mark as well. They have taken the symmetrical chromatic scale out of phase as to simplify to the ideal of whole numbers.

The inventor's main contention is the fact that they are using only 7 notes, when any musician knows there are 12 notes in each octave. (in western music theory, some other cultures have more). What the inventor has done is to include these neglected sharps and flats, which he will demonstrate, are important to the conversion of geometry into music. The inventor proposes to exploit a re-tuning of any octave bringing in full phase to the ancient number systems. Below are some relations of retuning to said number systems.

A=432 has been explained.

A# or its inharmonic equivalent, B flat: A#=57.29578 Mathematicians will recognize this as The Radian. (180/pi). The entire Earth grid is radian based. With this as our A# one can interact on many geometric levels with frequency and with the other 11 notes.

B=240.17358 exactly one half of the height of the Great Pyramid (one octave below [remember that any octave of a frequency can be extracted by multiplying or dividing by two]).

C#=272 decimal harmonic of the e/pi constant 2.72.

D=288 diameter of the outer circle of Stonehenge, 144 Gematrian for light. Pythagorean ratio 4/3 which also represents the Chephren Pyramids apex angle tangent. (also a ratio between 2 Gematrian systems).

D#=152.89924 the augment 4th from its root “A” a once outlawed interval. Divide by pi=the radius of the inner circle of Stonehenge. Multiplied by pi=height of the Great Pyramid. The entrance to the Great Pyramid is at the 17th course (level)

1+2+3+4+5+6+7+8+9+10+11+12+13

17×9 (total pyramids at the Giza complex)=153

204 (total courses at the Great Pyramid)/1.3333333(a 4th)=153

360 feet up the Great Pyramid is the 153rd course

The length of the grand gallery inside the Great Pyramid is 153 feet

153+513=666 6×6×6=216(new standard)

315+351=666 2160 miles is the diameter of the moon

1 and 5 and 3 are the degrees in a scale used to make a chord

E=324 octaves of the precession of the equinoxes 648, 1296, 2592

F=42.85742 MUSICAL PI 4.2857142 degrees (mp)

It is interesting that the amount of notes multiplied by the proposed tuning equals the nine factorial (9) 432×84=36288 (1×2×3×4×5×6×7×8×9=362880)

G=48.034717 a decimal harmonic of the height of the Great Pyramid. (480.34717 feet) divide it by pi and you have D#.

G#=101.93282 represents the difference in height of Chephren and the Great Pyramid 1.0193282 and also the distance in arc seconds between Cheph. and the G.P. when divided by all 12 notes.

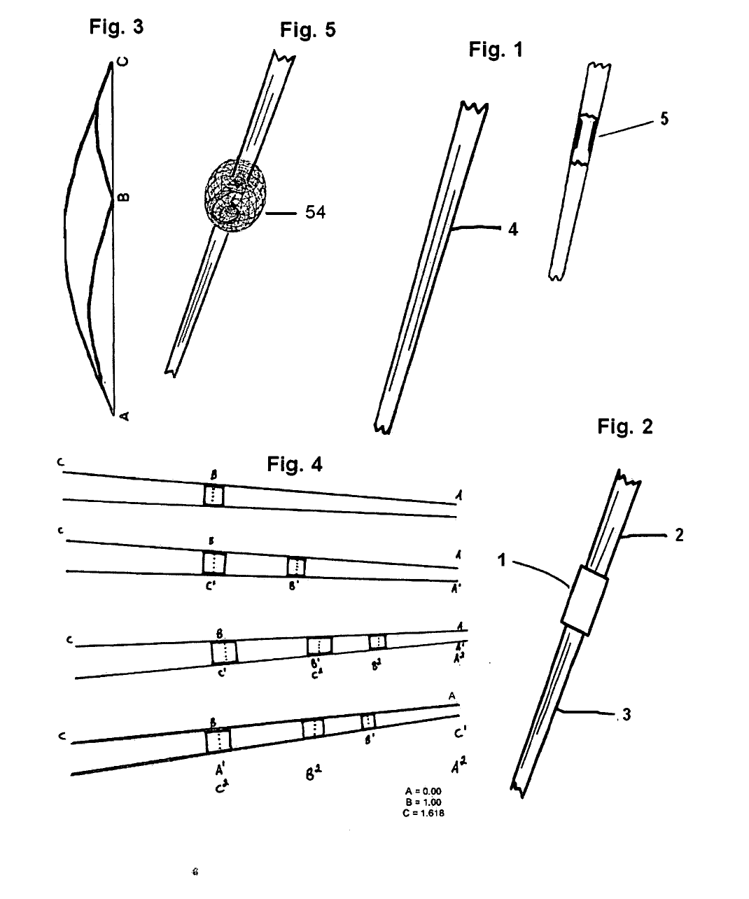

Referring to FIG. 1 of the accompanying drawings showing a conventionally tapering shaft 4, where a stiffening means is shown as an increase in the internal diameter of shaft in a cutaway view 5;

Referring to FIG. 2 of the accompanying drawings, showing a golf shaft with upper 2 and lower 3 portions having a stiffening means 1;

Referring to FIG. 5 of the accompanying drawings, showing a golf shaft with a structural means taking the form of a phi ratio ellipse 54.

In FIG. 4 are depicted a limited set of example means placements according to the phi ratio of 1.618 plus or minus a 10 percent margin.

None of the means of the shafts depicted in FIGS. 1, 2 and 5 are not meant to be construed as the only geometric manifestation of all possible actual means, but rather, to exemplify the use of phi ratio geometries employed longitudinally according to phi positioning (metrically depicted in FIG. 3) along the shaft.

Although the list is not exhaustive, other fractal geometries brought to bear at the desired longitudinal position depicted FIG. 4 or independent of longitudinal placement are as follows:

6a, 6b (fullerene shapes) which reflect the geometries of interlocking hexagons and pentagons), 7 (ellipse conforming to the phi ratio), 8 another fullerene, 9 (Schauberger whirlpipe shape), 10 (water vortex shape) 11 (Tetrahedron), 12 (Hexahedron or cube), 13 (Octahedron), 14 (Dodecahedron), 15 (Icosahedron), 16 (120 sided dodecahedral), 17-26 (variations on ellipses), 27-29 (variations on vortices), 30-34 (more variations on ellipses), 35 (quasi crystal shape) and 36 (phi pyramid).

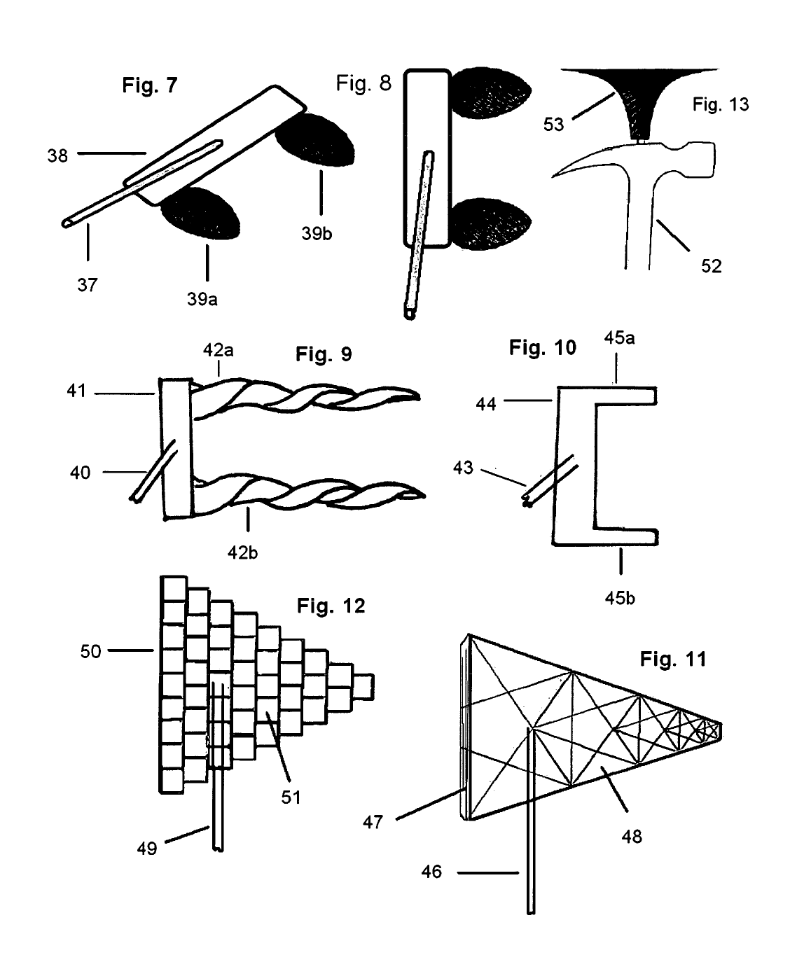

Referring to FIGS. 7, 8, 9, 10, 11, and 12, there is depicted a limited set of geometries structurally employed as resonators with or without specific tunings to frequencies associated with healing such as the Schumann resonance and other tunings serving to improve vibrational feedback through attunement, piezoelectric shock dampening and related fractal benefits independent of specific tunings or resonant frequencies.

FIG. 13 shown one example of how another implement, outside the field of golf (hammer), could also benefit from the piezoelectric dampening and related fractal benefits elucidated herein.

Further, shapes 17, 19, 18, 20 of FIG. 2 may also be incorporated into head geometries. In addition, shapes 4, 14, 7, 8, 9, 10, 11 and 13 may also be incorporated into clubhead geometries all of which are based on phi geometry derived from the golden ratio depicted at FIG. 3. In performing a putting stroke in particular, it is a general intention to strike a golf ball with the striking face in a vertical plane relative to the putter surface.

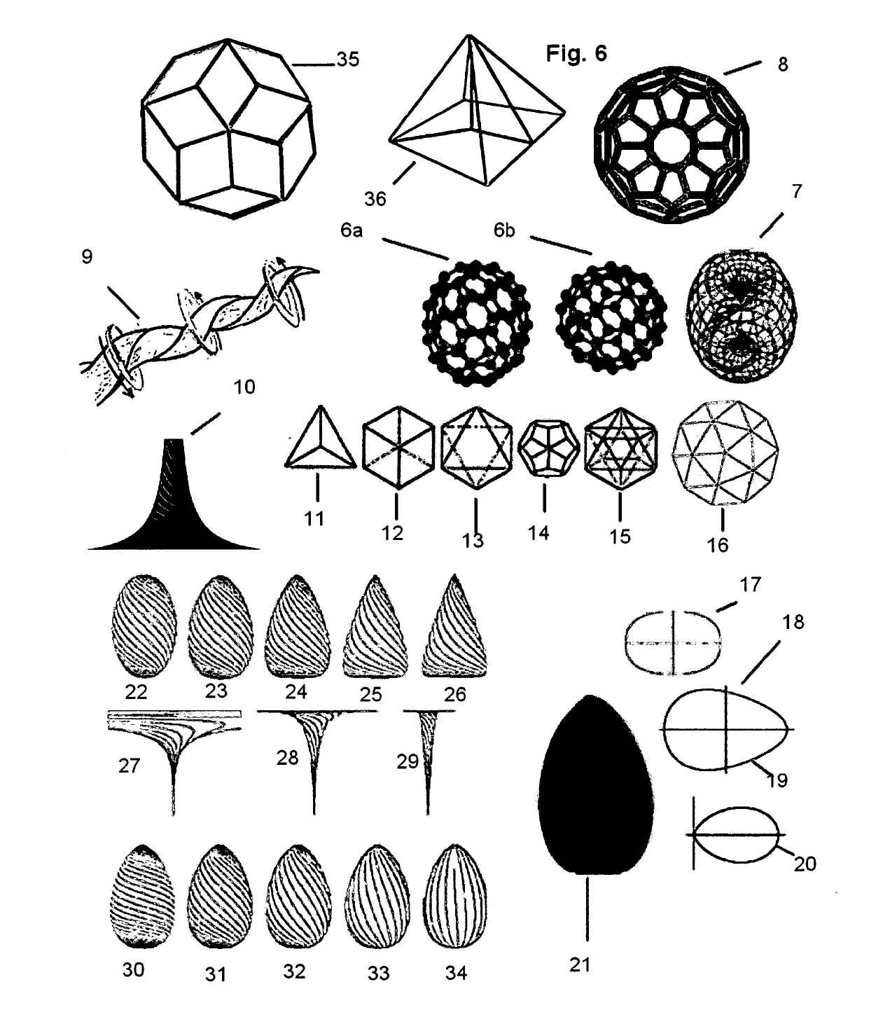

FIGS. 5-6 Show the phi ratio two dimensionally with golden (phi) spirals superimposed. The golden ratio (phi ratio, sacred cut, golden mean, divine proportion) is about 1.618033988749894848204586834365638117720309180 . . . ). The golden ratio is the unique ratio such that the ratio of the whole to the larger portion is the same as the ratio of the larger portion to the smaller portion.

In FIGS. 7-11 are show the regular Platonic Solids that could be employed either alone, or in combination, in the stiffening means, with or without phi ratio placement longitudinally. The Platonic Solids are the basic building block three-dimensional shapes of life. They are five in number, being the tetrahedron, the cube, the octahedron, the dodecahedron and the icosahedron. The geometric information within the platonic solids is like the invisible skeleton to solid forms.

The inventor wishes to place special emphasis on the fact that he is unfamiliar with any prior art claiming or demonstrating experimentally, shaft modifications that reduce putt skid length such as was demonstrated in the Swash experiments via grooved faces which ultimately lead to the granting of U.S. Pat. No. 5,637,044 and as such, the inventor wishes to emphasize that he has, through relative stiffening, solved the same long standing problem of excessive putt skid without replacing or modifying putterheads.

The inventor has also uniquely exploited phi harmonics and related fractal phenomena to improve utilized characteristics associated with phi ratio's and related fractal coherence for the optimization of vibrational feedback to promote, mental/emotional calmness, holographic learning, heightened intuition, brain hemispheric synchronization, muscle entrainment, improved intuition, improved impact dynamics, pyramid power effects as described by Patrick Flanagan and others and bioelectric effects for improved health.

Fractal theory is a unifying concept integrating scale-dependence and complexity, both of which are central to our understanding of biological patterns and processes (West and Goldberger 1987; Wiens 1989; Lam and Quattrochi 1992). Given that fractal and chaos theory are comparatively new fields, it is perhaps not surprising that biologists are still grappling with these concepts. Recognition of the fractal geometry of nature has important implications to biology, as evidenced by the numerous examples presented here. Zeide and Gresham (1991) describe as ‘self-evident’ the fractal nature of biological structures and systems. The inventor feels that one of the great challenges facing biologists lies in translating these self-evident concepts into comprehensive models of the patterns and processes observed in nature.

Fractal objects are objects that are composed of sub-units that resemble the larger scale shape. These sub-units are in turn composed of yet smaller sub-units that also look similar to the larger one. This is analogous to looking in a mirror while holding a second mirror in your hand that is facing the first mirror. An infinite series of reflections can be seen, with each reflection getting smaller until the eye can no longer discriminate the images. If one changes the distance between the two mirrors, the scale will change but the ratio remains constant. Mathematically speaking, fractals maintain the same ratio while changing scale. It is this geometry that allows electrical and light frequency harmonics to exchange energy across great distances of wavelengths.

Formally, a mathematical fractal is defined as any series for which the Hausdorff dimension (a continuous function) exceeds the discrete topological dimension (Tsonis and Tsonis 1987). Topologically, a line is one-dimensional. The dimension D of a fractal ‘trace’ on the plane, however, is a continuous function with range 1<=D<=2. A completely differentiable series has a fractal dimension D=1 (the same as the topological dimension), while a Brownian trace completely occupies two-dimensional topological space and therefore has a fractal dimension D=2. Fractal dimensions 1<=D <=2 quantify the degree to which a trace ‘fills’ the plane. In the same way, a planar curved surface is topologically two-dimensional, while a fractal surface has dimension 2<=D<=3.

Consider estimation of the length of a complex ‘coastline’. For a given spatial scale, the total length L is estimated as a set of N straight-line segments of length. Because small ‘peninsulas’ and other features not recognized at coarser scales become apparent at finer scales, the measured length L increases as decreases (Mandelbrot 1967). This dependence of length on measurement scale is a fundamental feature of fractal objects.

There have been terms for complexity in everyday language since antiquity. But the idea of treating complexity as a coherent scientific concept potentially amenable to explicit definition is quite new: indeed this became popular only in the late 1980s—in part as a result of Steven Wolfram's efforts. That what one would usually call complexity can be present in mathematical systems was for example already noted in the 1890s by Henri Poincaré in connection with the three-body problem. And in the 1920s the issue of quantifying the complexity of simple mathematical formulas had come up in work on assessing statistical models. By the 1940s general comments about biological, social and occasionally other systems being characterized by high complexity were common, particularly in connection with the cybernetics movement. Most often complexity seems to have been thought of as associated with the presence of large numbers of components with different types or behavior, and typically also with the presence of extensive interconnections or interdependencies. But occasionally—especially in some areas of social science—complexity was instead thought of as being characterized by somehow going beyond what human minds can handle. In the 1950s there was some discussion in pure mathematics of notions of complexity associated variously with sizes of axioms for logical theories, and with numbers of ways to satisfy such axioms.

The development of information theory in the late 1940s—followed by the discovery of the structure of DNA in 1953—led to the idea that perhaps complexity might be related to information content. And when the notion of algorithmic information content as the length of a shortest program emerged in the 1960s it was suggested that this might be an appropriate definition for complexity. Several other definitions used in specific fields in the 1960s and 1970s were also based on sizes of descriptions: examples were optimal orders of models in systems theory, lengths of logic expressions for circuit and program design, and numbers of factors in Krohn-Rhodes decompositions of semigroups. Beginning in the 1970s computational complexity theory took a somewhat different direction, defining what it called complexity in terms of resources needed to perform computational tasks.

Starting in the 1980s with the rise of complex systems research, it was considered important by many physicists to find a definition that would provide some kind of numerical measure of complexity. It was noted that both very ordered and very disordered systems normally seem to be of low complexity, and much was made of the observation that systems on the border between these extremes—particularly class 4 cellular automata—seem to have higher complexity. In addition, the presence of some kind of hierarchy was often taken to indicate higher complexity, as was evidence of computational capabilities.

It was also usually assumed that living systems should have the highest complexity—perhaps as a result of their long evolutionary history. And this made informal definitions of complexity often include all sorts of detailed features of life. One attempt at an abstract definition was what Charles Bennett called logical depth: the number of computational steps needed to reproduce something from its shortest description. Many simpler definitions of complexity were proposed in the 1980s. Quite a few were based just on changing pi Log[pi] in the definition of entropy to a quantity vanishing for both ordered and disordered pi. Many others were based on looking at correlations and mutual information measures—and using the fact that in a system with many interdependent and potentially hierarchical parts this should go on changing as one looks at more and more.

Some were based purely on fractal dimensions or dimensions associated with strange attractors. Following Steven Wolfram's 1984 study of minimal sizes of finite automata capable of reproducing states in cellular automaton evolution, a whole series of definitions were developed based on minimal sizes of descriptions in terms of deterministic and probabilistic finite automata. In general it is possible to imagine setting up all sorts of definitions for quantities that one chooses to call complexity. But what is most relevant for the inventor's purposes in this application is instead to find ways to capture everyday notions of complexity—and then to see how complexity can benefit golf specifically and other related fine and gross motor sports skills. (Note that since the 1980s there has been interest in finding measures of complexity that instead for example allow maintainability and robustness of software and management systems to be assessed.

Sometimes these have been based on observations of humans trying to understand or verify systems, but more often they have just been based for example on simple properties of networks that define the flow of control or data—or in some cases on the length of documentation needed.) (The kind of complexity discussed here has nothing directly to do with complex numbers such as Sqrt[−1] introduced into mathematics since the 1600s.) The ratio 1.618 “Golden Mean” is the most efficient ratio when energy is transferred between scales. When energy is phase-locked with this ratio, it cascades between frequencies without losing momentum or memory of itself. In examining the spectrum analysis of the EKG when loving thoughts are being sent to someone, the ratio between the frequency peaks is 1.618. The fractal design of the heart uses this principle to send energy cascading down the harmonic series to the DNA. The geometry of these wave nests looks exactly like DNA as viewed from the top.

If we look in the body where the greatest amount of electrical focus can stand as a wave, we arrive at the heart. This is because the geometry of the heart muscle contains all the symmetry or mirror sharing between spins. Specifically, the seven discreet layers of heart muscle are arranged in exactly the spin angles of the seven arrows of spin of the tetrahedra (the seven arrows of the heart.) Spin is always the activator of symmetry, or persuasion to share. Unfolding spin into usable wavelengths is what the Golden Mean fractal heart shape is all about. The transformer for maximum entry of spin or energy into the body is the heart. There is a weathervane-like spiral strip off the donut torus shape at the center of the heart. Since all the spins about the heart focus here, this “element” or essential ingredient to symmetry, would know immediately the heart axis or phase as compared to the donut-shaped pressure waves surrounding it.

This densest center of the heart would then affect the sound of the heart projected onto the wall of the pericardium, the cave surrounding the heart. This part of the heart affects the phase of the sonic energy that vibrates both the pericardium and thymus. The umbrella-like screen for this projector is the thymus located around the heart, the site where immune instructions are translated. The thymus uses these sonic shadows on the wall of the cave to know which wave length ingredients to crochet into cellular identity. This is because only phase or wave-sharing coherence makes cell membranes possible. Membranes are libraries on which turns of fold or shapes of touch can be shared.

The point here is to understand that concentricity of focus—literally the convergence of electrical and sonic pressure—is exemplified by the muscular and toroidal electrical structure of the heart itself. If the orderliness or coherence of electrical energy grows, then radiance to the immune system of the body expands.

Takahashi (1989) hypothesized that the basic architecture of a chromosome is tree-like, consisting of a concatenation of ‘mini-chromosomes’. A fractal dimension of D=2.34 was determined from an analysis of first and second order branching patterns in a human metaphase chromosome. Xu et al. (1994) hypothesized that the twistings of DNA binding proteins have fractal properties.

Lewis and Rees (1985) determined the fractal dimension of protein surfaces (2<=D<=3) using microprobes. A mean surface dimension of D=2.4 was determined using microprobe radii ranging from 1-3.5 angstroms. More highly irregular surfaces (D>2.4) were found to be sites of inter-protein interaction. Wagner et al. (1985) estimated the fractal dimension of heme and iron-sulfur proteins using crystallographic coordinates of the carbon backbone. They found that the structural fractal dimension correlated positively with the temperature dependence of protein relaxation rates.

Smith et al. (1989) used fractal dimension as a measure of contour complexity in two-dimensional images of neural cells. They recommend D as a quantitative morphological measure of cellular complexity.

Self-similarity has recently been found in DNA sequences (summarized in Stanley 1992; see also papers in Nonnenmacher et al. 1994). Glazier et al. (1995) used the multifractal spectrum approach to reconstruct the evolutionary history of organisms from m-DNA sequences. The multifractal spectra for invertebrates and vertebrates were quite different, allowing for the recognition of broad groups of organisms. They concluded that DNA sequences display fractal properties, and that these can be used to resolve evolutionary relationships in animals. Xiao et al. (1995) found that nucleotide sequences in animals, plants and humans display fractal properties. They also showed that exon and intron sequences differ in their fractal properties.

The kinetics of protein ion channels in the phospholipid bilayer were examined by Liebovitch et al. (1987). The timing of openings and closings of ion channels had fractal properties, implying that processes operating at different time scales are related, not independent (Liebovitch and Koniarek 1992). López-Quintela and Casado (1989) developed a fractal model of enzyme kinetics, based on the observation that kinetics is a function of substrate concentration. They found that some enzyme systems displayed classical Michaelis-Menten kinetics (D=1), while others showed fractal kinetics (D<1).

5.4 Dichotomous Branching Systems:

Fractal dichotomous branching is seen in the lung, small intestine, blood vessels of the heart, and some neurons (West and Goldberger 1987; Goldberger et al. 1990; Glenny et al. 1991; Deering and West 1992). Fractal branching greatly amplifies the surface area of tissue, be it for absorption (e.g. lung, intestine, leaf mesophyll), distribution and collection (blood vessels, bile ducts, bronchial tubes, vascular tissue in leaves) or information processing (nerves). Fractal structures are thought to be robust and resistant to injury by virtue of their redundancy and irregularity. Nelson et al. (1990) examined power-law relationships between branch order and length in human, dog, rat and hamster lung tissue. Differences between the human lung and those of other species were hypothesized to be related to postural orientation. Long (1994) relates Leonardo da Vinci's ratio of branch diameters in trees (=0.707) to observed dichotomous fractal bifurcations.

Nonlinear dynamics is the study of systems that respond disproportionately to stimuli. A simple deterministic nonlinear system may behave erratically (though not randomly), a state, which has been termed chaos. Chaotic systems are characterized by complex dynamics, determinism, and sensitivity to initial conditions, making long-term forecasting impossible. Chaos, which is closely related to fractal geometry, refers to a kind of constrained randomness (Stone and Ezrati 1996). Wherever a chaotic process has shaped an environment, a fractal structure is left behind.

Goldberger et al. (1990) state that physiology may prove to be one of the richest laboratories for the study of fractals and chaos as well as other types of nonlinear dynamics. A good example is the study of heart rate time series (Goldberger 1992). Conventional wisdom states that the heart displays ‘normal’ periodic rhythms that become more erratic in response to stress or age. However, recent evidence suggests just the opposite: physiological processes behave more erratically (chaotically) when they are healthy and young. Normal variation in heart rate is ‘ragged’ and irregular, suggesting that mechanisms controlling heart rate are intrinsically chaotic. Such a mechanism might offer greater flexibility in coping with emergencies and changing environments.

Lipsitz and Goldberger (1992) found a loss of complexity in heart rate variation with age. Based on this result, they defined aging as a progressive loss of complexity in the dynamics of all physiological systems. Sugihara (1994), using a different analytical approach, found that prediction-decay and nonlinearity models are good predictors of human health. Healthy patients have a steeper heart rate decay curve, and have greater nonlinearity in their heart rhythms. Teich and Lowen (1994) found that human auditory neuron transmissions are best modelled as fractal point processes, and that such transmissions display long-term persistence (H>0.5).

Projective geometry is concerned with incidences, that is, where elements such as lines planes and points either coincide or not. The diagram illustrates DESARGUES THEOREM, which says that if corresponding sides of two triangles meet in three points lying on a straight line, then corresponding vertices lie on three concurrent lines.

[image]

The converse is true i.e. if corresponding vertices lie on concurrent lines then corresponding sides meet in collinear points. This illustrates a fact about incidences and has nothing to say about measurements. This is characteristic of pure projective geometry.

It also illustrates the PRINCIPLE OF DUALITY, for there is a symmetry between the statements about lines and points. If all the words ‘point’ and ‘line’ are exchanged in the statement about the sides, and then we replace ‘side’ with ‘vertex’, we get the dual statement about the vertices.

The most fundamental fact is that there is one and only one line joining two distinct points in a plane, and dually two lines meet in one and only one point. But what, you may ask, about parallel lines? Projective geometry regards them as meeting in an IDEAL POINT at infinity. There is just one ideal point associated with each direction in the plane, in which all parallel lines in such a direction meet. The sum total of all such ideal points form the IDEAL LINE AT INFINITY.

The next Graphic shows the process of projection of a RANGE of points on a yellow line into another range on a distinct (blue) line. The set of (green) projecting lines in the point of projection is called a PENCIL of lines. The points are indicated by the centre points of white crosses.

[image]

The two ranges are called PERSPECTIVE ranges. The process of intersection of a pencil by a line to produce a range is called SECTION. Projection and section are dual processes. The above procedure may be repeated for a sequence of projections and sections. The first and last range are then referred to as PROJECTIVE RANGES. If corresponding points of two projective ranges are joined the resulting lines do not form a pencil, but instead envelope a CONIC SECTION, that is an ellipse, hyperbola or parabola. These are the shapes arising if a plane cuts a cone, and in fact include a pair of straight lines and also, of course, the circle.

[image]

Using the dual process a conic can be constructed by points using projective pencils.

There are many theorems that there is no space to explain here. A particularly important subject for counter space is that of polarity, which is related to the principle of duality. If the tangents to a conic through a point are drawn, the line joining the two points of tangency is called the POLAR LINE of the point, and dually the point is called the POLE of that line. This is illustrated below.

[image]

[image]

The fact to note here is that the polars of the points on a line form a pencil in a point, which is the polar of that line. The situation is self-dual.

In three dimensions we illustrate the same principle but with a sphere and a point. The cone with its apex in that point, and which is tangential to the sphere, determines a plane (red) containing the circle of contact. That plane is the POLAR PLANE of the point, and the point is the POLE of the plane.

[image]

Similarly to the two-dimensional case, if we take the polar planes of all the points in a plane, they all contain a common point, which is the pole of that plane. Lines are now self-polar.

When counter space is studied this property of points and planes is used to conceptualize the idea of a negative space, as we reverse the roles of center and infinity.

Infinity is not invariant for projective geometry, in the sense that ideal points may be transformed by it into other points. In a plane the ideal points form an ideal line, and in space they form an ideal plane or plane at infinity. A special case of projective geometry can be defined which leaves the plane at infinity invariant (as a whole) i.e. ideal elements are never transformed into ones that are not at infinity. This is known as affine geometry. A further special case is possible where the volume of objects remains invariant, which is known as special affine geometry. Finally a further specialization ensures that lengths and angles are invariant, which is metric geometry, so called because measurements remain unaltered by its transformations.

The picture below shows an egg form constructed mathematically. The spirals are characteristic of the mathematics and are known as PATH CURVES. They were discovered by Felix Klein in the 19th Century, and are very simple and fundamental mathematically speaking. Geometry studies transformations of space, and these curves arise as a result. A simple movement in a fixed direction such as driving along a straight road is an example, where the vehicle is being transformed by what is called a translation. In our mathematical imagination we can think of the whole of space being transformed in this way. Another example is rotation about an axis. In both cases there are lines or curves which are themselves unmoved (as a whole) by the transformation: in the second case circles concentric with the axis (round which the points of space are moving), and in the first case all straight lines parallel to the direction of motion. These are simple examples of path curves. More complicated transformations give rise to more interesting curves.

[image]

The transformations concerned are projective ones characteristic of projective geometry, which are linear because neither straight lines nor planes become curved when moved by them, and incidences are preserved (this is a simplification, but will serve us here). They allow more freedom than simple rotations and translations, in particular incorporating expansion and contraction. Apart from the path curves they leave a tetrahedron invariant in the most general case. George Adams studied these curves as he thought they would provide a way of understanding how space and counter space interact. A particular version he looked at was for a transformation, which leaves invariant two parallel planes, the line at infinity where they meet, and an axis orthogonal to them. This is a plastic transformation rather than a rigid one (like rotation) and a typical path curve together with the invariant planes and axis is shown below.

[image]

This will be recognized as the type of curve lying in the surface of an egg. If we take a circle concentric with the axis and all the path curves that pass through it then we get that egg-shaped surface. The construction is shown in the following illustration:

[image]

We can vary the transformation to get our eggs more or less sharp, or alternatively we can get vortices such as the following:

[image]

In these pictures particular path curves have been highlighted. This particular vortex is an example of a watery vortex, so called by Lawrence Edwards because its profile fits real water vortices. It is characterised by the fact that the lower invariant plane is at infinity. If instead the upper plane is at infinity we get what he calls an airy vortex.

Two parameters are of particular significance: lambda and epsilon. Lambda controls the shape of the profile while epsilon determines the degree of spiralling. Lambda is positive for eggs and negative for vortices, while the sign of epsilon controls the sense of rotation. This is illustrated below.

[image]

Holographic theory tells us that wherever the pattern essences for building bodies come from, they must be information-dense or packed. Informationally, we might think of this as survival-critical information, umbilicus to the soul. Getting this wiring connected without shorts or interference is key to health and mental and emotional stability. High frequency ordering, or information density, is what the living cell does. For example, food's long-wave energy is transformed to short-wave energy that is usable by the cells through the steps in cellular metabolism. This information-rich ultraviolet blue short wave light drives our cellular metabolism. High quality ultraviolet light choreographs cell replication. This “blue light” is the cell's life energy source, which flashes measurably at the moment of DNA braid cell division.

There is much support for theoretical arguments that the healthy heart beat is a temporal fractal and that the heart's anatomy is fractal-like. Spectral analysis of the EKG's QRS complexes reveals a broad band frequency spectrum with most of the frequency content or power below 30 Hz, yet extending several hundred Hz. Ary Goldberger of Harvard Medical School has confirmed that changes in the geometry of the heart's branching conduction system can alter the frequency content of the QRS complex, independent of any changes in myocardial conduction.

It is well known that the cardiac electricities are the dominant electrical force in the human system, although the source of the heartbeat is still a mystery. Another piece of this puzzle is starting to emerge—the discovery of the fractal structure of the physical heart and chaos theory of the heart rate. Before these discoveries, the classical notion of homeostasis relating health to constancy was that perturbations are likely to cause a loss of regularity in the heart rate. The chaos hypothesis predicts just the opposite, namely that a variety of disease states which alter autonomic function may lead to a loss of physiologic complexity and therefore to greater, not less, regularity. When the heartbeat becomes regular and loses its complexity, there is a high risk of sudden death through heart failure. Aging has also been associated with this loss of physiologic complexity along with a number of other diseases. The term “complexity” is used here to include the fractal type of variability found in the heart's structure.

The nonlinear complexities of cardiac electricities cannot be quantified by the use of traditional statics such as variance. The advancement in chaos theory and computer power has made these new discoveries possible, but it's still only one step closer to understanding the dynamics of heart electricities.

The inventor postulates that the ordered randomness found in the cardiac electricities and nervous system, which have been termed chaos, contains encoded intelligence and is only chaotic from the perspective of not understanding the intelligence that it contains. This is analogous to a TV signal in which both FM and AM modulations are used to transmit intelligence or information. If the receiver of the signals does not understand the complete technology or the language of the information being transmitted it would appear as randomness with some sort of organization, yet chaotic.

The existence of an electrical body or organizing field of intelligence that forms around all living organisms is well established and has been measured. This field contains the system's intelligence that organizes the structure of the body down to the atomic level. It is the fractal structure of the physical heart, which receives and transforms this electrical energy and the information encoded within it. The brain acts as a demodulator of this information and then communicates with the cellular systems of the body. The flow of information is duplex, traveling both up and down the harmonic series of scale. Each heartbeat is like a phrase or part of a song that sends organizing instructions throughout your system. We just don't have the intellectual understanding of this language yet. A series of these beats or packets of information make up what could be called a song or “event,” such as climbing a hill. When you climb a hill the body expends more energy and a whole series of complex events must take place: the heart beats faster and harder, supplying more energy and information throughout your system. The inventor is suggesting that it is the next level of organizing intelligence that runs this show and that it is through the heart that all this information flows to make up the events of life.

One could map the brain neuron by neuron and perhaps eventually understand the wiring structure, but what then? The brain is just the machinery of the mind, which is far more complex than the brain itself. Where does the mind receive its instructions? The inventor is suggesting the source is the heart electricities and by learning to listen to its intelligence, it will facilitate our understanding of how the mind and brain function.

From the many hours of coherent EKG data sampled, it appears that the center frequency ratio of the cardiac electricity is the Golden Mean ratio of 1.618 with modulations between 2 Hz and 1.42 (which are also geometrically and harmonically important but beyond the scope of this application). The main point is that 1.618 is also the ratio of the DNA structure and is the only ratio that allows complete information or geometry to cascade down the harmonic series without loss of power or geometry.

One 360-degree turn of DNA measures 34 angstroms in the direction of the axis. The width of the molecule is 20 angstroms, to the nearest angstrom. These lengths, 34:20, are in the ratio of the golden mean, within the limits of the accuracy of the measurements. Each DNA strand contains periodically recurring phosphate and sugar subunits. There are 10 such phosphate-sugar groups in each full 360 degree revolution of the DNA spiral. Thus the amount of rotation of each of these subunits around the DNA cylinder is 360 degrees divided by 10, or 36 degrees. This is exactly half the pentagon rotation, showing a close relation of the DNA sub-unit to the golden mean.

Power spectrum graphs show Golden Mean ratio spacing between the power peaks in the frequency content of the EKG, extending up past 45 Hz. Results of this kind would be highly improbable unless there is conscious intention and focus. (Inset later note added here, this 1.618 approximate interval between harmonics shows up on Septrum 2 order fft as 1/×value−0.618).

The mindibrain can literally learn to tune to the heart frequency; it just needs to know the right “access codes.” When it learns to stay tuned to the heart center frequency, then balanced energies can flow up and down the harmonic series and the human system takes on a new level of operating efficiency. This can add energy and clarity to what ever one engages in and feels good to the mental, emotional and physical aspects of our nature. It is the lack of this communication between the mind and the heart that leads to stress and lack of efficiency.

The heart is a balance organ whose function is to balance and regulate the physical, mental and emotional natures. (The importance of balance is not yet fully understood, but the inventor believes it will be discovered to be the key to energy efficiency in many areas in the near future.) The lower the frequency of a wave, the more power or force the wave contains. Another way of saying this is that the closer to balance or singularity a wave is the more power it has. Most of the power contained in the heartbeat is in the low frequency range below what is audible. Heart energy originates from balance or zero and radiates from there; then it rests or returns to zero, regenerates and fires again, sending energy throughout your system. It is when the heart no longer returns to its balance point of regeneration that ventricular fibrillation occurs.

It is widely believed that there is no such thing as a free energy machine, yet there are individuals who have the ability to live and fully function with very little or no food intake for extended periods of time. Once instrumentation is developed which is capable of measuring the energy output of living beings, the inventor believes it will be easy to show that the amount of energy output from most people will far exceed the caloric input they consume. Where does this additional energy come from? The inventor's conclusion is that it originates from the same place as the heartbeat—a less dense octave in the harmonic series. Geometrically, we know the ratio, which allows energy and information to change scale or dimension without loss of power.

This is the same ratio as the one the heart is operating on when sincere love or appreciation is experienced. The fractal structure of the heart is designed to transform this electrical energy from one dimension into another, and from the point of view of the physical dimension, this energy is free as long as balance can be maintained. A deeper look at heart geometry could be the key to understanding and developing a new source of energy.

Consider the relationship between the electrical pulse of the heart, called EKG, and what it pushes as a strictive wave of pressure into the bloodstream. The relationship in muscle between the electrical wave and the sound wave, or phonon, is called piezo-electricity. This refers to the principle of coupling between mechanical or strictive pressure versus electrical pressure called voltage. The mechanics of the piezo-electric connection in crystal or muscle (as liquid crystal) occurs because of a helical stairway shape in the molecules. If you wring out a braided rope, like you would a wet towel, the long wave pull end to end is “coupled” mechanically to the short wave move inward tightening the braid. It's like you had a slinky between your right and left hands.

When you pull the “Slinky” apart, the sides of the Slinky move inward or closer together, mechanically coupling the long wave of your hand motion to the short wave of the slinky's braid. This is an important clue to the information relationship of the long wave to the short. A coherent, orderly braiding is required to couple them. The short or electrical wave is more information dense; the long or sound wave is more information unpacked or accessible. This is the heart of the matter, the principle of ALL connections across scale or dimension. Emotion allows attention or feeling in the long wave of sound pressure to reach into the short wave life of cells.

This helps us to understand why helical braiding is nature's choice for the structure of piezo-electric quartz, and for DNA. These structures are the wave braids, which permit information to reach between worlds of scale by ratio.

This fractal approach to minimizing incoherence and by extension, maximizing efficiency, has also been exploited in nuclear energy (see U.S. Pat. No. 5,563,568) and in information theory (see U.S. Pat. No. 4,290,051). Also, the geometries and ratios employed in the present invention may also serve to facilitate piezoelectric transduction insofar as they fascilitate the body's efficiency at dissipating excess vibration by transduction, wherein the body more efficiently transforms the strain energy of shaft vibration into electricity, and is capable of dissipating the electricity as heat, by using itself as a more efficient piezoelectric transducer given the fractal nature of the geometry employed in the invention (see U.S. Pat. No. 7,029,598).

As mentioned earlier, the heart muscle is shaped like seven layers of nested donut or torus-shaped muscle. This is the shape of all natural wave fields. So, essentially the “geometry of pressure” or “shape of the hug,” which the muscle folds around the vortex of blood in the heart, is also the shape of the electrical wave which triggers that muscle. In other words, by looking at the wave shape of heart electricity (by spectral analysis or frequency signature) we are in actuality looking at the shape of the pressure wave being squeezed into the bloodstream. It may not be too romantic to think of this as “the whispers of the heart” reaching out into the far corners of the body.

By looking at the shape of the heart electricity we are actually looking at the shape of the mechanical pressure wave being sent to the far corners of the body by the heart. The heart is not a simple pump. Ralph Marinelli in Royal Oak, Mich., has documented that the heart moves blood by generating tornado-like vortex momenta (these vortices were illustrated by Leonardo Da Vinci). Victor Schauberger also exploited these vortex phenomena for energy production. The coherence of these orderly little tornadoes in the blood is what then travels throughout the body. They remember the instructions of the heart from the shape of the pressure waves in the EKG-triggered heart muscle, which pushed them into their aorta world. So when we find an orderly harmonic series in the EKG, we may be finding the whispers of the electrical “soul,” reaching out musically to touch each cell around the body.

Another puzzle piece supporting this is the sonic resonance the brain has with the heartbeat. Bentov showed that the sounds coming from the heart phase-locked or arranged the sound ordering in the liquid ventricles of the brain. He later came to believe it was this sonic ordering which set up the conditions necessary for superconductive ecstasy in the brain. Bentov built a sensitive capacitive accelerometer to measure the sonic thrust of the heartbeat which causes a ringing sound in the brain which can be heard. This ringing sound is often heard by meditators and many non-meditators when they still the processing of the mind. Bentov started his research in this area by having many meditators tune an oscillator to the same frequency they heard in their ears. He then determined that this frequency was a direct harmonic of the heart sonic. Bentov showed that the heart controlled the brain resonance, and when phase-locked, a standing wave is set up that can be physically heard. Orderly sound collimates the fluids contained in the ventricles of the brain toward conductive crystal, and gently massages the gland centers to their secretion of psychoactive hormones. The heart sounds set the beat to start the sonic superconduction in the brain ventricles whose psychoactive chemicals are largely responsible for our perceptions of reality and our mental and emotional reactions to stimuli from both internal and external sources.

It also appears that low frequency coherent sonics program the immune system by projecting on the thymus gland as if onto the walls of the cave. The thymus is the radiative source of most of immune system chemistry. It is like a sound dish umbrella around the heart that vibrates in resonance with the sonics of the heartbeat. When the thymus shrinks, apparently so does its ability to receive instructions from the heart sonics.

Medical research has proven that the emotional state of mind programs the cell's health more than perhaps any other factor (or it can be said that negative emotions distort the accurate flow of information). Dr. Manfred Clynes, author of Sentics, is well known for his work in mapping the wave shape of emotions and the invention of a pressure transducer and related equipment to measure the wave shape of emotion. His work has been tested in many different cultures around the world.

It is interesting to note that the ratio 1/3 is the ratio of hate, and in a waveform, this ratio creates destructive interference among waves. This can be likened to the mechanical waves traveling down a cowboy's whip. If the wave shape is correctly programmed in the long wave at the handle of the whip, then the whip cracks at the short end. If an interfering wave motion is programmed into the whip it will not snap. Positive emotions are constructive or coherent waves and cause the long wave to transform or “crack” into the short waves imparting its energy to the smaller scale ratio such as the DNA. This could explain why, when certain ratios are employed in full club shafts, particularly the driver, the inventor was able to increase his driving distance from 300 to 400 yards. Not only is the “whip” or shaft programmed at the beginning of the swing more efficiently, it may also be that coordinating muscular movements is enhanced via the fractal nature of the vibrational feedback through the hands pre impact. In essence, one could think of this as Energy Motion, or E-Motion.

There is another clue to the emotive feeling state creating geometry in the electromagnetic field of the body. This clue is in the extensive body of literature correlating ordering in brain waves, or EEG, to psychological states. Power spectra analyses (frequency signature) of EEG (brain waves) has shown that under certain unstressful and consciously focused conditions coherence exists within the power spectrums of the brain waves. MIT physicist Larry Domash has published elaborate data which illustrate that cross-hemispheric EEG ordering or coherence, correlates to the health benefits of intentional relaxation. It also seems that onsetting coherence ordering in brain electrical resonances correlates to shared information in a group or telepathy between several people. This was also documented in the “Mind Mirror,” EEG spectra research of Cade et al, in “Awakened Brain.” The spectral range of significant EEG resonance coherence found in these studies are the same resonances found to be significant in EKG power spectra.

Current research shows a possible link between coherent cardiac electricities and DNA programming. The output of the EKG machine is fed into a spectrum analyzer which shows the frequency content of the heart beat. When people who are skilled in mental and emotional self-management focus on loving or appreciating, the frequency content of their EKG (heart electricity) changes in a significant way. The distribution of the power content of the heart electricity is normally scattered and cancels out.

This is called incoherent. However, when love and other positive feelings are being experienced the distribution dramatically changes to a coherent and ordered pattern. This, by itself, is amazing, but even more amazing is the fact that the mathematical ratio between the power peaks is the same ratio as the Golden Mean ratio. This ratio is the one that allows electrical power to change scales or harmonic octaves without losing any of its power or information carried in its modulation.

The DNA of every cell in our bodies is built upon this same ratio. There are many other examples of this ratio in cellular structures, but this discovery is especially important because it shows a direct link between the heart electricities and the DNA. In other words, the electricity of the heart programs the DNA much like a radio wave is sent through the air to your radio. The DNA is like a radio receiver and the heart is like the transmitter.

There is also new evidence appearing in the spectrum analysis showing that the heart electricities contain a highly ordered or encoded intelligence that is ultimately responsible for the instructions sent to the DNA. These waves from the heart are affected by people's emotions and thoughts, so when people are processing negative emotions such as fear, anger, anxiety, etc., the electricities are affected in a way that blocks the proper flow of information from reaching the DNA. If these types of negative patterns are experienced repeatedly over time it eventually manifests in disease.

The symptoms of this are already well documented. Doctors and researchers have known for many years that negative emotions and thoughts are the main cause of aging and many diseases. These negative patterns have also been linked directly to heart disease. New research also indicates that conscious generation of “heart frequencies” such as love, care, and appreciation has a positive, beneficial effect on immune system health and brain function, and can reverse the effect of negative stress patterns in the mental and emotional nature.

Commencing in the Scientific American September issue's reportage, as well as their announcement of the multidimensional universe, to be tested in 2005, at the CERN particle accelerator in Switzerland, there appears to be a revolution at hand, amidst mainstream discoveries. A revolution that began some 7 years earlier, and that could be set to shake the very foundation of what we call reality, depending on further research.

In The apparent PHI, or golden number harmonics, are described in some superluminal experiments.

Their appearence here may yield extreme significance, in a vast array of fields, from charting the universe, it matrix and laws, and beyond, all the way to the personal including biofeedback enhancement in superlearning techniques and whole body intelligence. However, this research began to receive attention when the following obscure science paper highlighted their first glimpse of superluminality.

Results were consistent with the group delay predictions, and also with Buttiker's proposed Larmor time, but not with the “semiclassical” time. The measured times exceeded the predictions by approximately 0.5 fs [femto seconds], but this result was at the borderline of statistical significance, and not discussed. Since then, further data taken at various angles of incidence have continued to show a discrepancy, ranging from an excess of 0.5 fs near normal incidence to a decit of over 1 fs at large angles of incidence.” Sub-femtosecond determination of transmission delay times for a dielectric mirror (photonic bandgap) as a function of angle of incidence. Aephraim M. Steinberg and Raymond Y. Chiao Department of Physics, U.C. Berkeley, Berkeley, Calif. 94720.

During the mid 1990s the European media highlighted a potential science shattering discovery, faster-than-light signalling of Mozart's 40th Symphony. Vortexijah (issue 4/5, Autumn 1994) also reported on this odd finding, which was stated to be a “failure in causality”, Einstein's version of Karma, or cause and effect, which states that nothing goes faster than the speed of light.

Amidst this European media spur, was a 1995 article in the conservative foundation stone news paper of Germany, de Zeit, which published this as a headline story entitled: “Mozart's Symphony #40 Causes Breakdown In Modern Physics.

Here are some excerpts translated into English: Koeln physics professor Guenther Nimtz, used a hollow metal pipe, called a wave transducer. On the end of the Ca. 20 cm long metal pipe a section of Mozart's Symphony #40 became audible through an amplifier. Not digital quality, but good enough for radio. There was a speed change of the waves that were transduced. This tunnel effect was 4.7×C [c=speed of light].

The lengths of the microwaves that Nimtz chose were actually too wide for the wave transducer. But still some of them found their way through the other side to the amplifier. In the tunnel occurrence the waves do not seem to require any time. Whereas outside the tunnel the waves were behaving well enough to follow the classical laws and travel at the speed of light. Mozart's symphony has information content, Nimtz contends.

Such an almost unbelievable news item, herein without a date, however was based on actual accepted research. Quoting Dr. Raymond Chiao's brief summary of these experiments:

Other experiments confirming the superluminality of tunnelling have been performed in Cologne, Florence, and Vienna [14, 15, 16].

The Cologne and Florence groups performed microwave experiments, and the Vienna group performed a femtosecond laser experiment. All these groups have confirmed the Hartman effect. One of these groups [17] has claimed to have sent Mozart's 40th symphony at a speed of 4:7c through a microwave tunnel barrier 114 mm long consisting of a periodic dielectric structure similar to our dielectric mirror.” Quantum Nonlocality in Two-Photon Raymond Y. Chiao , Paul G. Kwiat z and Aephraim M. Steinberg. Department of Physics, University of California, Berkeley, Calif. 94720-7300, Dec. 21, 1994). Pp 10. One could be enabled to model or understand the ‘high dimensions’ through which the signal may have transversed, by the Golden Mean or PHI.

Many have speculated that PHI would be the first localized form of the virtual, and in making cosmological models that are post-infinite maps. Mentioning that PHI would be the best model of coherence, or highest order, that is the simplest pathway by which the nature of this dimension could translate, or mirror in personification, the coherent pathways of those vacuum hyperspaces, even though they may be post-PHI therein. Nevertheless in our localised spatial dimension, PHI would be the simplest constant which would personify the unique signals of these N-spaces.

A book written by the famous Polish journalist and scientist Jan Grejzdelsky titled “Energy-Geometric Code of Nature” contains a number of very deep scientific ideas. As is well known a sphere was considered in the ancient period as the “ideal” geometric form to simulate the laws of Nature. The idea about spherical character of planet's orbits brought into the creation of trigonometry and was put forward by Ptolemy as the basis of his geocentric system of the Universe. The discovery of some mistakes in the basic principle of the Solar system organization (“the cult of sphere”) was the greatest shock to Kepler and led him to the ellipsoidal insight as to the character of planet's orbits. As is well known the ellipse is a geometric plane figure meeting so-called “additional” principle since the sum of the distances from some point of the ellipse to the its focuses is a constant value. It follows from the “ellipsoidal” insight that the geometry of the Solar system is the “additional” geometry based on the “addition” principle.

In Cassiny's opinion, the first Kepler law is not correct. Cassiny affirmed that planets move in accordance with Cassiny's oval. The basic geometric peculiarity of Cassiny's oval consists of the following (Graphic. 1 below).

Let's suppose that F1 and F2 are the focus points of the oval and OF1=OF2 and F1F2=2b. Then a geometric definition of Cassiny's oval consists of the following: MF1 □ MF2=a2. This means that the product of the distances from some point M to the focuses F1 and F2 is a constant value. Then the equation of Cassiny's oval in the rectangular coordinates x and y has the following form:
(x²+y²)²−2b²(x²−y²)=a⁴−b⁴ (1)

It is clear that Cassiny's oval is the curve of the 4-th order. In contrast to the ellipse, which does not change its form in dependence on the focus distance, the form of Cassiny's oval depends on the focus distance. If a □ 2b Cassiny's oval is a convex curve (Graphic. 1-a) similar to the ellipse. If b<a<2b there appears a negative curvature in Cassiny's oval form (Graphic. 1-b). If a=b Cassini's oval equation has the following form:
(x²+y²)²−2b²(x²−y²)=0. (2)

It is the equation of the curve having the form of the number of 8 (Graphic. 1-c) and called Bernoulli's lemniscate. Just this figure is supposed to be chosen by the ancient Greeks as symbol of infinity (□).

At least for the case b>a the Cassiny oval falls into two separate geometric figures (Graphic. 1-d).

[image]

It was Jan Grejzdelsky who was the first after Cassiny to advance the idea that the geometry of Nature is the geometry of Cassiny's ovals and ovaloids. Moreover, the addition geometry following from the Kepler laws is replaced by the multiplication geometry (Cassiny's oval). The basic advantage of such an approach to the geometry of Nature consists of the fact that it allows to give a logical and energetic explanation of the division processes widely observed in natural phenomena. The cause of the “Cassinyable” divisions is the change of the equilibrium conditions of the system. Geometrically this is expressed in increasing the focus distance (Graphic. 1-b,c,d). Upon overcoming the certain energy threshold, the rotating solid, having Cassiny's oval form in its cross-section, strives to the stability state but this process demands not only the energy change but also the form change.

Grejzdelsky spares a special attention for Bernoulli's lemniscate (FIG. 1-c) and its space form called lemniscatoide, which is the expression of the system thermodynamic equilibrium. Grejzdelsky found out the Golden Section in Bernoulli's lemniscate and advances the idea that just the Golden Section is the proportion of the thermodynamic equilibrium. As is well known the Golden Section is presented in the form of an infinite fractional:

$$τ = \frac{1}{1 + \frac{1}{1 + \frac{1}{1 + …}}} \qquad ( 3 )$$

which contains only coefficients 1 in its representation (3).

The unique mathematical property of infinite fraction (3) consists of the fact that it is the most sluggish infinite fractional among other infinite fractionals. Grejzdelsky affirms that“this property is connected with the thermodynamic equilibrium and the given sequence presents very nice the idea of the most sluggish movement”. Just the latter is suggested by Grejzdelsky as the alternative to the Newton doctrine of the “absolute rest”.

Grejzdelsky demonstrates the idea of the thermodynamic equilibrium by an example of optical crystals. As is well known the ellipsoidal model permits to explain of the light rays spreading in the optical crystals. Grejzdelsky advances the hypothesis that the “golden” ellipse is the optimal model for demonstration of the thermodynamic equilibrium in the optical crystals. The “golden” ellipse is formed with the help of the two “golden” rhombi ACBD and ICJD inscribed into the ellipse (Graphic. 2).

The “golden” rhombi ACBD and ICJD consist of 4 right “golden” triangles of the kind OCB or OCJ. Note that the isosceles “golden” triangles ACB and CJD are similar to the triangle forming cross-section of the Cheops Pyramid.

[image]

Let's consider the basic geometrical relations of the “golden” ellipse. Let's suppose that the focus distance of the ellipse is equal to AB=2. In accordance with the ellipse definition there exists the following correlation:
AC+CB=AG+CB.

Besides, there exist the following relations connecting the sides of the right “golden” triangles OCB and OCJ:
OB: BC=1: □; OB: OC=1:\sqrt{τ};
OC: CJ=1: □; OC: OJ=1: \sqrt{τ};

It follows the next proportion from the similarity of the triangles OCB and OCJ:
CB: CJ=OB: OC=OC: OJ=1: \sqrt{τ},

where □ is the Golden Section. In Grejzdelsky's opinion, the latter correlation expresses the proportion of thermodynamic equilibrium in the optical crystals and creates optimal conditions for the photon arriving to the focus with minimal energetic losses.

Below is a discussion of how to construct Golden Conics. Conic sections in the form of an ellipse, a hyperbola, or a parabola are obtained by slicing a right circular cone by a plane, or, as the locus of a point which moves so its distance from a fixed point (the focus) is a constant ratio to the distance from a fixed line (the directrix).

The shape of the curve is determined by this ratio, which is called the eccentricity and is denoted by e. For the ellipse, e<1; for the parabola, e=1; for the hyperbola, e>1. Since the parabola has a single value for e, it always has the same shape. However, if the eccentricities of the ellipse and hyperbola are the golden section (1.61803), interesting results are obtained. In the Graphic below, you will see the following graphs:

the parabola:
y²=4×

the ellipse:

$$\frac{{x}^{2}}{{( \frac{( 1 + sqrt ( 5 ) )}{2} )}^{2}} + \frac{{y}^{2}}{1} = 1$$

the hyperbola:

$$\frac{{x}^{2}}{( \frac{1 + sqrt ( 5 )}{2} )} - \frac{{y}^{2}}{1} = 1$$

and the asymptotes (positive and negative):

$$y = \frac{x}{sqrt ( \frac{1 + sqrt ( 5 )}{2} )}$$

$$where$$

$$\frac{1 + sqrt ( 5 )}{2}$$

is the formula for the golden ratio; for purposes of this essay we will use P to represent the golden ratio.

[image]

So, in the graph above where each of the equations are represented, we get the following results:

1. The latus rectum of the parabola is the directrix of the hyperbola.

2. The directrix of the parabola is the image in the y-axis of the directrix of the hyperbola.

3. The hyperbola asymptotes intersect the parabola in the points

(4P, 4[[radical]]P) and (−4P, −4[[radical]]P).

While the inventor does not anticipate wild deviations from mathematical phi he cannot guarantee that identical modifications to clubs of differing shaft and or clubhead characteristics will produce identical fractal phase coherence dynamics with identical modifications. (some current embodiments reduced to practice actually fall on or very near mathematical phi [but such ratios were worked out in relation to the inventor's own clubhead designs]). The inventor recognizes the inherent complexity and inevitable trade-offs of combining his shafts with other clubhead designs but by no means expects such minor variations to alter the essential theme and thrust of his invention, namely the exploitation of fractal coherence of golf club vibration using phi ratios and other fractal geometries and ratios as a means to promote fractally coherent principles of vibration.

The principle exploited in the invention primarily employs a stiffening means to promote fractal coherence alone or in conjunction with substantially increased or reduced mass on or near the same nodal position of the stiffening means. Thus, the stiffening means will fall longitudinally somewhere near, but not necessarily precisely on, mathematical phi and serve to exploit fractal coherence by balancing the various factors that contribute to the overall vibrational spectrum of the club influenced by factors such as shaft geometry, grip material, clubhead weight, shape and dimensionality, as well as the attachment point of the shaft to the clubhead itself.

The stiffening means serves the purpose of adding enough stiffness, or combination of stiffness and mass, at or near the point of the phi ratio to effectively divide the shaft into two or more relatively distinct sections that flex and twist about the stiffened section or sections, serving as a kind of rigid (neutral) node that promotes phi fractal coherence.

The musical analogy would be the division of a vibrating string at the interval of a perfect 5th roughly measured at ⅔ the way down the string. So, for a shaft of 33 inches, the exact phi ratio would be located at 20.395 inches. In order to maximize fractal coherence however, the inventor may find it necessary to calculate phi using different end points such as the overall shaft length (without factoring the clubhead into the equation), top of shaft to the sweet spot of putterhead or clubhead at the other end or even from the top of the shaft to the bottom of the putterhead or clubhead depending on the unique vibrational spectrum (resonant frequency characteristics) of the individual club configuration. He may also calculate phi ratios between a plurality of stiffening means relative to each other's longitudinal position, independent of their relationship to the shaft's endpoints. The stiffening means will also not exceed 25% of the overall length of any shaft in which it is employed.

Its shape will be determined largely by its effect on vibrational spectra and may take the form, of ellipse, cylinder, pyramid, cone, polygon or any other shape that achieves desired effects. Further, the shape of the stiffening means may also take the shape of the above mentioned geometric shapes that themselves exploit phi geometries, e.g., phi ellipses, phi cylinders, Schauberger whirlpipes, phi egg shapes, phi pyramids, phi cones, phi polygons Romanesque broccoli shapes, torsion generators or amalgamation of the aforementioned shapes to further enhance fractally coherent vibrations and their impact on health, learning, memory, movement entrainment, mental states, and any and all other factors considered to benefit the accuracy and consistency of golf skill execution.

Further, the modified shaft may be affixed to any number or type of traditional putterhead or clubhead, including, but not limited to, specially designed heads and or striking surfaces of such heads that are specially modified to improve impact dynamics, ball spin, and the like, for enhancing their effects beyond that which they would enjoy affixed to traditional shafts.

The study commissioned by the inventor definitively demonstrated, an enlargement of the sweet spot (the area on the striking surface of a putter that transfers more energy to a golf ball than any other area as measured by said golf ball's peak velocity with a given impact velocity) of the test putterhead by reducing the impact ratio of the sweet spot to a greater degree relative to the impact ratios of the toe and heel of the putterhead after strategically increased shaft stiffness with or without added mass.

Three studies were conducted, one by Dr. Paul Hurrion of Quintic Consultancy, and the other two by the inventor (who commissioned the Hurrion study), that conclusively demonstrated an enlarged sweet spot as well as theoretical and empirical improvements in feel for distance owing to the comparative non-linearity of increased force requirements necessary to increase putt lengths incrementally the same distances when compared to conventional putters as well as reduced putt skid length.

Although certain preferred embodiments and methods have been disclosed herein, it will be apparent from the foregoing disclosure to those skilled in the art that variations and modifications of such embodiments and methods may be made without departing from the true spirit and scope of the invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1-27. (canceled)

28. An apparatus comprising one or a plurality of metallic or non-metallic members or amalgamations of metallic and non-metallic members exploiting mechanical or acoustical vibrations to function as a bi-directional holographic transducer between the mechanical, acoustic, and electromagnetic domains of carbon based life forms and said apparatus; said members themselves being comprised of geometries or geometric ratios or resonant frequencies or combinations therein which promote piezoelectric or biophotonic communication between said life forms and said apparatus.

29. The apparatus of claim 28, wherein any of the said geometries, or geometric ratios or resonant frequencies of said members are of a fractal, recursive or self similar nature.

30. The apparatus as in claim 28, wherein said geometries, geometric ratios or resonant frequencies of said members are based on, or derived from, or substantially comprise, phi, Lucas, Fibonacci, philotaxic or related self similar structures.

31. The apparatus of claim 28, employing the rigidification or elastification or mass distribution, or any combination of rigidification, elastification or mass distribution of said members.

32. The apparatus as in claim 28 wherein said member or members are human or animal powered.

33. The apparatus of claim 28 wherein said member or members are not human or animal powered.

34. The apparatus of claim 28 wherein said member or members are selected from the group consisting of:
i. tetrahedron,
ii. hexahedron,
iii. octahedron,
iv. dodecahedron,
v. icosahedron,
vi. ellipses,
vii. cylinders,
viii. pyramids,
ix. Pinecone shapes,
x. phi ellipses,
xi. phi conic shapes,
xii. phi cylinders,
xiii. Schauberger whirlpipes,
xiv. egg shapes,
xv. vortices,
xvi. phi pyramids,
xvii. quasicrystals,
xviii. Cassini ovals,
xix. super ellipses,
xx. perfect fullerene shapes, and
xxi. simple fullerene shapes.

35. The apparatus of claim 28 wherein said member or members comprise or form a functional part or parts of everyday items coming into in direct or indirect contact with humans, plants or animals such as plant pots, plant baskets, clothing, helmets, pads, fishing rods, fishing tackle, insect traps, insect repellers, animal shelters, animal traps, saunas, incubators, full spectrum lights, infra red lights, fluorescent lights, argon and other gas lights, neon lights, plasma tubes, poles, oars, sticks, grips, rackets, clubs, bats, balls, pucks, shuttlecocks, cookware, eating utensils, kitchen appliances such as refrigerators, ovens, stoves, coffee makers and blenders; flying disks, seats, shoes, boat hulls, exercise equipment, machinery, power tools, hammers, saws, rakes, shovels, hoes, lawnmowers, edgers, canes, walkers and other related assistive devices; toothbrushes both mechanical, sonic and manual; leaf blowers, drills, jackhammers, pneumatic or hydraulic tools, steering wheels, automobiles, saddles, leashes, ballistic vests, gun stocks, archery equipment, bowling balls, musical instruments, light and sound entrainment devices, biofeedback devices, heartrate variability feedback devices, pace makers, defibrillators, pipe organs, public address systems, horns, magnetomechanical transducers, mattresses, pillows, massage tables, multimedia equipment such as home, car and theater audio devices, acoustic resonators, amusement rides, surf boards, skateboards, roller skates, inline skates, bicycles, motorcycles, shock absorbers, suspension systems, massage wands, marital aids, whirlpool jets, ultrasonic medical equipment, mining equipment, snow skis, water skis, snowboards, snowmobiles, swim fins, impact restraints such as seatbelts and airbags; orthotics, prosthetics, dentures, mouth guards, pacifiers, contact lenses; substrates such as running track surfaces, wrestling or play mats, carpets, flooring, floor padding; acoustical dampening materials, trampolines, punching bags, parachutes, ropes, climbing equipment, structural components of bridges, buildings, trains, elevators, moving sidewalks, airplanes, boats, submarines, and escalators; tactile speakers and vibrating feedback devices such as game controllers; dwellings such as aquariums, cages, tents, camping trailers, bomb shelters, mobile homes, mobile offices and mobile classrooms and similar modular dwellings.

36. The apparatus of claims 28 wherein said member structurally comprises a golf shaft or golf club or golf clubhead.

37. The apparatus of claim 28 wherein said member is a golf shaft comprising:
a. a butt or grip end of relatively larger cross sectional diameter tapering to a tip end of relatively smaller cross sectional diameter with intentional geometric or mass or modulus of elasticity discontinuities or combinations thereof including one or a plurality of distinct, structural means employed either internally, externally or by employing a combination of internal and external means or by replacing a shaft section or sections of comparable length and longitudinal position, or by employing any combination of the above modifications to independently increase or decrease the stiffness or modulus of elasticity, or mass, or both by at least 50 percent beyond that which those skilled in the art would regard as the stiffness or modulus of elasticity or mass or combination of stiffness or modulus of elasticity and mass of a conventionally tapering shaft section or sections of comparable length and longitudinal position, by altering shaft diameters, materials or geometries or any combination therein; further, said distinct structural means is:
i. to occupy between 1 and 25 percent of overall shaft length,
ii. to have its average longitudinal midpoint located between said ends, and set in at least 1 inch in from each end, the placement of said means conforming to certain mathematical ratios serving to uniquely alter the vibrational characteristics of comparison conventional shaft sections of comparable length and longitudinal position wherein the average midpoint of the first of the means employed resides longitudinally near the mathematical ratio of 1.00 in relation to phi, 1.618, plus or minus 10 percent of overall shaft length measured from said tip end toward said butt or grip end or from the butt end to a point on a clubhead to which the shaft tip is attached, the butt end being located at 1.618, the means being located at 1.00 and the tip end or a point on the clubhead to which the tip is attached being located at 0.00 respectively, or alternatively, wherein the average midpoint of the first of the means employed resides longitudinally near the mathematical ratio of 1.00 in relation to phi, 1.618, plus or minus 10 percent of overall shaft length measured from said tip end toward said butt or grip end or from the butt end to a point on a subhead to which the shaft tip is attached, the butt end being located at 0.00, the means being located at 1.00 and the tip end or a point on the subhead to which the tip is attached being located at 1.618 respectively, and wherein the allowable 10 percent variation in the placement of any additional means is calculated according to the actual distance formed by the formation of additional phi triads when involving 3 or more structural means or a combination of two means and one endpoint, where the endpoint forming the phi triad can be measured in either direction where each endpoint can serve as 0.00 or 1.618 depending on the direction of calculation, thus scaling the 10 percent margin to the critical distance between any three phi triad points and not just to the overall shaft length as would be the case with the first means placement, such that:
1. improved impact dynamics of golf shots, including improved vibrational feedback to the golfer before or during or after impacting a golf ball or training device or improved positional awareness of club or body or their relationship to each other during practice or actual strokes;
2. reduced skid length of putts as compared to putts traveling the same distance struck by traditional putters resulting in less variation in putt line, and hence, more consistency reflected in a reduced tendency of putts to deviate from the target line;
3. further relative skid length reductions beyond direct comparisons between conventional putter heads combined with shafts modified by said means, and said modified shafts combined with specialized heads that are themselves, designed to reduce skid length;
4 an enlargement of the sweet spot of both putters and full club heads defined as the tendency of said heads, to which said shafts are attached, to resist twisting in relation to both the hands and grip, when said heads are impacted off their respective centers of gravity or sweet spots resulting in improved accuracy,
5. improved timing, reflected in increased body position or club position awareness or their relationship to each other,
6. improved piezoelectric transduction, insofar as the fractal geometries and ratios employed in the present invention facilitate the body's efficiency at dissipating excess vibration by transduction, wherein the body more efficiently transforms the strain energy of shaft vibration into electricity, and then dissipates the electricity as heat,
7. improved acoustic or vibrational feedback and any and all other effects or combinations of affects associated with improved golf skills that could be, or already have been, demonstrated by employing said and or means.

38. The apparatus of claim 37, wherein said distinct structural means do not exceed 10 in number.

39. The apparatus of claim 37 wherein an increase in the mass of said means by 10 to 2,000 percent beyond that of said longitudinal conventional section or sections said means replaces or modifies or alternatively, a golf shaft as in claim 37 with a reduction of the mass or masses of said means between 25 and 75 percent beyond what those skilled in the art would characterize as the conventional mass or masses of a conventional shaft section or sections of comparable length and position.

40. A subhead or putterhead that when struck, has a resonant frequency near 432 hertz ; musical note A, plus or minus 5 hertz or any of the other harmonics, multiples, inversions or scale intervals formed from the resonance of the fundamental of 432 plus or minus 5 hertz, such as 57.29578, 240.17358, 272, 288, 152.89924, 324, 42.85742, 48.034717, 101.93282 or 324; musical note E, plus or minus 5 hertz, or alternatively, a subhead or putterhead with a head having a resonant frequency of 7.83 hertz, plus or minus 0.5 hertz, also known as the Schumann resonance, or any of the harmonics, multiples, inversions or harmonics formed from the fundamental of 7.83 within a margin of 0.5 hertz.

41. The apparatus of claim 36 such that that when struck, the subhead or putterhead has a resonant frequency near 432 hertz plus or minus 5 hertz or any of the other harmonics, multiples or scale intervals formed from the resonance of the fundamental of 432 plus or minus 5 hertz, such as 57.29578, 240.17358, 272, 288, 152.89924, 324, 42.85742, 48.034717, 101.93282 or any of their harmonics, multiples plus or minus 5 hertz, or alternatively, a clubhead or putterhead with a head having a resonant frequency of 7.83 hertz, plus or minus 0.5 hertz, also known as the Schumann resonance, or any of the multiples or harmonics formed from the fundamental of 7.83 and its margin of 0.5 hertz.

42. The apparatus of claim 37:
wherein said shaft is structurally comprised of at least two of the shapes are selected from the group consisting of:
i. tetrahedron,
ii. hexahedron,
iii. octahedron,
iv. dodecahedron,
v. icosahedron,
vi. ellipses,
vii. cylinders,
viii. pyramids,
ix. Pinecone shapes,
x. phi ellipses,
xi. phi conic shapes,
xii. phi cylinders,
xiii. Schauberger whirlpipes,
xiv. egg shapes,
xv. vortices,
xvi. phi pyramids,
xvii. quasicrystals,
xviii. Cassini ovals,
xix. super ellipses,
xx. perfect fullerene shapes, and
xxi. simple fullerene shapes.

43. The apparatus of claim 37 wherein the structural means of the golf putter is an elliptical or ovaloid shape and further comprises a head attached to said shaft with one or a plurality of projections off the back or non striking portion of the putter face taking the form of any shapes selected from the group consisting of:
i. tetrahedron,
ii. hexahedron,
iii. octahedron,
iv. dodecahedron,
v. icosahedron,
vi. ellipses,
vii. cylinders,
viii. pyramids,
ix. Pinecone shapes,
x. phi ellipses,
xi. phi conic shapes,
xii. phi cylinders,
xiii. Schauberger whirlpipes,
xiv. egg shapes,
xv. vortices,
xvi. phi pyramids,
xvii. quasicrystals,
xviii. Cassini ovals,
xix. super ellipses,
xx. perfect fullerene shapes, and
xxi. simple fullerene shapes,
such that peripheral weighting of the putterhead is increased while simultaneously exploiting the unique vibrational characteristics of fractal shapes as resonating bodies.

44. The apparatus of claim 37 wherein the structural means of the golf putter is of an elliptical or ovaloid shape and further comprises a head attached to said shaft with between one and five distinct structural projections off any non striking portion of the putter taking the form of any combination of shapes selected from the group consisting of:
i. tetrahedron,
ii. hexahedron,
iii. octahedron,
iv. dodecahedron,
v. icosahedron,
vi. ellipses,
vii. cylinders,
viii. pyramids,
ix. Pinecone shapes,
x. phi ellipses,
xi. phi conic shapes,
xii. phi cylinders,
xiii. Schauberger whirlpipes,
xiv. egg shapes,
xv. vortices,
xvi. phi pyramids,
xvii. quasicrystals,
xviii. Cassini ovals,
xix. super ellipses,
xx. perfect fullerene shapes, and
xxi. simple fullerene shapes,
such that peripheral weighting of the putterhead is increased while simultaneously exploiting the unique vibrational characteristics of fractal shapes and or ratios as resonators.

45. A sports implement such as skis, rackets, balls, javelins, poles, shoes, trampolines, track surfaces, wrestling or gymnastic mats, helmets, pads and the like structurally comprising fractal geometric shapes or for the promotion of vibrational dampening via piezoelectric transduction, insofar as the fractal geometries and ratios employed to facilitate the dissipation of unwanted vibration through the body of the golfer, whereby the body transforms the strain energy of vibrational shock into electricity, and then dissipates said electricity as heat; further, any other everyday items coming into contact with humans or animals such as, shoes, ballistic vests, body armor, gloves, helmets, saddles, seats, tools, such as saws, hammers, drills, or any other item for which vibration dampening via piezoelectric induction for humans or animals is desirable utilizing fractal geometries and ratios.

46. The sports implement of claim 45 wherein the geometry utilized is a perfect fullerene at both a nano and a macro scale.

47. Any item as in claim 45 wherein the geometry of the material utilized is a simple fullerene at a nano scale.

48. The sports implement of claim 45 wherein the geometry of the material utilized is a simple fullerene at a nano and a macro scale.

49. The sports implement of claim 45 wherein the geometry of the material utilized is geometrically fractal both the same at a nano and a macro scale.

50. The sports implement of claim 45 wherein the geometry of the material utilized is geometrically fractal both at a nano and a macro scale with the fractal geometries between said scales differing such as, by way of example, a golf putterhead in the shape of a fibonacci sequence constructed of fullerene molecules.

51. The apparatus of claim 37 further comprising a head attached to said shaft with one or a plurality of projections off the non striking portion of the putter face taking the form of any of shape selected from the group consisting of:
i. tetrahedron,
ii. hexahedron,
iii. octahedron,
iv. dodecahedron,
v. icosahedron,
vi. ellipses,
vii. cylinders,
viii. pyramids,
ix. Pinecone shapes,
x. phi ellipses,
xi. phi conic shapes,
xii. phi cylinders,
xiii. Schauberger whirlpipes,
xiv. egg shapes,
xv. vortices,
xvi. phi pyramids,
xvii. quasicrystals,
xviii. Cassini ovals,
xix. super ellipses,
xx. perfect fullerene shapes, and
xxi. simple fullerene shapes.
